(19) United States
(12) Patent Application Publication
(10) Pub. No.: US 2025/0267296 A1
(43) Pub. Date: Aug. 21, 2025

(54) ADAPTIVE INTELLIGENT MULTI-MODAL MEDIA PROCESSING AND DELIVERY SYSTEM

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 18/900,460

(22) Filed: Sep. 27, 2024

Related U.S. Application Data
(63) Continuation-in-part of application No. 18/636,264, filed on Apr. 16, 2024.
(60) Provisional application No. 63/553,966, filed on Feb. 15, 2024.

(51) Int. Cl. H04N 19/189; H04N 19/136; H04N 19/162; H04N 19/164; H04N 19/42

(52) U.S. Cl. CPC H04N 19/189; H04N 19/136; H04N 19/162; H04N 19/164; H04N 19/42

(57) ABSTRACT

This invention introduces an adaptive system for multi-modal media processing and delivery, addressing challenges in modern digital content distribution. The technology dynamically analyzes and processes media content in real-time, optimizing delivery across diverse devices, networks, and content types. Key features include adaptive processing that adjusts compression, encoding, and delivery protocols based on content characteristics and delivery constraints. The system incorporates artificial intelligence for continuous improvement, learning from historical data and user feedback. It addresses network variability and device diversity, adapting to changing conditions and optimizing content for different platforms. Security and personalization features enable protected content distribution and tailored user experiences. The invention's cross-media optimization approach allows efficient handling of various media formats within a unified framework. Its scalable, modular design suits applications from consumer streaming to enterprise-level distribution. This comprehensive solution aims to enhance content distribution efficiency and user experience in the complex, evolving digital media landscape.

### CROSS-REFERENCE TO RELATED APPLICATIONS

Priority is claimed in the application data sheet to the following patents or patent applications, each of which is expressly incorporated herein by reference in its entirety:
Ser. No. 18/636,264
63/553,966

### BACKGROUND OF THE INVENTION

### Field of the Art

The present invention is in the field of digital media processing and delivery, encompassing advanced techniques for adaptive compression, encoding, and transmission of multi-modal content across various platforms and networks. It particularly relates to integrated systems that optimize the processing and distribution of video, audio, sensory feedback, telematics, and textual content while incorporating intelligent adaptation, content protection, and monetization strategies.

### Discussion of the State of the Art

The field of multi-modal media processing and delivery has seen significant advancements in recent years, driven by increasing demand for high-quality, personalized content across various platforms and devices. Traditional video codecs and hardware/software architectures have struggled to efficiently handle complex video data, leading to suboptimal compression and increased processing loads.

Current content-adaptive encoding systems attempt to address these challenges by dynamically adjusting encoding settings. However, these systems often fail to fully leverage the potential of AI-driven optimizations, resulting in less efficient compression and lower visual fidelity than theoretically possible. Similarly, existing 3D video compression techniques and 2D to 3D transformation methods have not kept pace with the growing demand for immersive content, often producing subpar results in terms of quality and efficiency. Additionally current compression techniques largely focus on video, audio and text and do not account sufficiently for expansion to smell, haptics, motion, or additional forms of content enrichment.

The integration of advanced compression techniques with existing streaming architectures, such as those employed by major platforms like Netflix, Max, Prime, Paramount+, continues to present ongoing opportunities for significant improvement via enhancement. Current systems struggle to optimally balance the need for high-quality content delivery with the constraints of varied network conditions, diverse user devices, and emerging changes in advertising vs subscription monetization/remuneration processes for streamers, content producers, licensors, advertisers and ultimate consumers.

Emerging devices with integrated AI-capable or specialized chips offer new possibilities for content-specific, genre-specific, and quality-specific processing and refinements to advertising. However, current media processing systems have not fully adapted to leverage these capabilities, often resulting in missed opportunities for optimization at the device level or in specialized incorporation of generative content (e.g. for product placement) inside licensed content. Additional shortcomings exist when practical challenges like limited downloads for situations like airplane travel or other periods of intermittent communications exist.

In the realm of content protection, existing codec systems offer limited capabilities for partial or full encryption. This shortcoming becomes particularly apparent in scenarios requiring dynamic content filtering and augmentation or secure transmission of mixed-classification data streams.

While information theory concepts have shown promise in enhancing compression efficiency, their practical application in real-world media processing systems remains limited. Current approaches often fail to fully exploit the potential of semantic compression and network pruning techniques. Moreover, the application of 4D symmetries and diffeomorphisms for optimized compression across different content types is inadequately unexplored or leveraged in cross-media applications.

Existing model hierarchy approaches aimed at reducing data transmission have shown some success. However, they often lack the sophistication needed to significantly decrease bandwidth requirements and grapple with variable network performance and availability without compromising content quality, particularly in the context of large-scale telecommunications and content delivery networks to increasingly mobile devices or multi device elements (e.g. phone, laptop, headsets and other wearables with direct network interaction potential). The concept of loadable GenAI codec enhancers, while promising, has not been fully realized or commercialized in dramatically improving compression efficiency for specific content pieces or categories.

Current AI-driven analysis systems face significant challenges in performing complex 4D symmetry and diffeomorphic analyses on input media, limiting their ability to fully optimize compression across various content types and time periods. Additionally, the continuous learning and refinement of content-specific models based on new content and user feedback remain underdeveloped, hindering the potential for ongoing improvement in compression efficiency and content delivery-even more so for emerging dynamic content replacement or licensing (including name-image-likeness) elements.

In the realm of content monetization, current systems lack the sophistication to create truly dynamic, granular consumption, ad sponsored or subscription models that can adapt in real-time to user preferences, content quality, and viewing habits and content preference elections.

What is needed is an integrated, intelligent system that can adaptively process and deliver multi-modal media content. Such a system should optimize compression and encoding based on content characteristics, user preferences, monetization scheme and network conditions, while fully leveraging the capabilities of AI-driven optimizations and emerging hardware architectures for pre-existing and dynamically generated content. It should seamlessly handle various media types, including 2D, 3D and 4D video, audio, haptics, AR/VR datastreams, and text, while providing robust content protection and flexible adaptation to diverse viewing contexts and devices. Furthermore, this system should incorporate advanced mathematical techniques like 4D symmetries and diffeomorphisms, information theoretic representation/scoring and knowledge augmentation to enable continuous learning and refinement of content-specific or device specific models, and offer sophisticated, adaptive content and advertising monetization and sharing capabilities.

### SUMMARY OF THE INVENTION

The present invention provides a system for adaptive multi-modal media processing and delivery and creation. In one embodiment, the system comprises a content-adaptive encoding subsystem configured to dynamically adjust encoding settings based on content characteristics and types; an AI-driven optimization subsystem configured to analyze and compress media content (including but not limited to video, audio, text and currently nonstandard emerging content like haptics, spatial, telematics/motion, smell); a specialized hardware component configured to process complex video data; a network interface configured to receive network condition data; and a processor. The processor is configured to receive media content and user preference data; select encoding parameters based on the content characteristics, user preferences, and network conditions; apply AI-driven compression techniques to the media content; and output the compressed media content for delivery.

In another embodiment, the system further comprises a model hierarchy subsystem configured to store parent models representing content types and transmit customized models for at least one specific content segment or user or group.

In yet another embodiment, the specialized hardware component includes at least one of: a Tensor Processing Unit (TPU), a Field-Programmable Gate Array (FPGA), a Digital Signal Processor (DSP), Computer Processing Unit (CPU), Graphics Processing Unit (GPU), and an Application-Specific Integrated Circuit (ASIC) or other similar emergent category of silicon or graphene based processor.

In a further embodiment, the system comprises a 3D video processing subsystem configured to compress Side-by-Side (SBS) and Frame-Sequential 3D or spatial video formats with optional additional motion or haptic enhancements.

In still another embodiment, the system comprises a content encryption subsystem configured to selectively encrypt portions of the media content based on user credentials or device identifiers.

The present invention also provides a method for adaptive multi-modal media processing and delivery. In one embodiment, the method comprises receiving media content and user preference data; analyzing content characteristics of the media content; determining network conditions; selecting encoding parameters based on the content characteristics, user preferences, and network conditions; applying AI-driven compression techniques to the media content using specialized hardware; dynamically adjusting the compression parameters or algorithms for at least one content element (e.g. video vs telematics/kinematics vs audio data) based on accumulated or real-time feedback or models thereof; and outputting the compressed media content for downstream delivery-noting that such processes may occur entirely or in part at the original streamer/distributor as well as incrementally at content distribution networks, network edge devices, personal devices (e.g. laptops or televisions) or mobile/wearables. Feedback and performance data from such processes may also be optionally returned to streamer for analysis and training of additional compression and optimization schemes that may improve customer experience or system efficiency for future configurations.

In another embodiment, the method further comprises storing parent models representing content types on a user device; and transmitting only customized models for specific content to the user device or user device cluster (e.g. split workloads across a user phone, laptop, headset and wearable device set where at least some communication directly between such devices occurs related to the content being presented, selected, or interacted with by the user).

In yet another embodiment, applying AI-driven compression techniques includes performing 4D symmetry analysis on the media content.

In a further embodiment, the method comprises transforming 2D video content into 3D video content using AI-driven depth estimation and reconstruction techniques alongside temporal enhancements and smoothing or continuity measurements, scoring or enhancements.

In still another embodiment, the method comprises dynamically filtering or modifying the media content based on user-specific criteria.

The present invention also provides a method for dynamic compression based on subordinate (e.g. a particular movie scene) specifics. This allows action scenes to be compressed in a way that prioritizes framerate and image quality above bandwidth reduction, whereas other scenes may prioritize the opposite.

### BRIEF DESCRIPTION OF THE DRAWING FIGURES

FIG. 1 is a block diagram illustrating a system overview of adaptive intelligent multi-modal media processing and delivery system

FIG. 2 is a block diagram illustrating exemplary system architecture for intelligent adaptive compression system.

FIG. 3 is a method diagram illustrating the use of intelligent adaptive compression system.

FIG. 4 is a block diagram illustrating an exemplary architecture for streaming platform integration system.

FIG. 5 is a method diagram illustrating the use of streaming platform integration system.

FIG. 6 is a block diagram illustrating an exemplary architecture for adaptive 3D video processing system.

FIG. 7 is a method diagram illustrating the use of adaptive 3D video processing system.

FIG. 8 is a block diagram illustrating an exemplary architecture for device specific adaptive content optimizer.

FIG. 9 is a method diagram illustrating the use of device specific adaptive content optimizer.

FIG. 10 is a block diagram illustrating an exemplary architecture for dynamic context encryption and filtering engine.

FIG. 11 is a method diagram illustrating the use of dynamic context encryption and filtering engine.

FIG. 12 is a block diagram illustrating an exemplary architecture for information theory enhanced compression system.

FIG. 13 is a method diagram illustrating the use of information theory enhanced compression system.

FIG. 14 is a block diagram illustrating an exemplary architecture for hierarchical model transmission optimizer system.

FIG. 15 is a method diagram illustrating the use of hierarchical model transmission optimizer system.

FIG. 16 is a block diagram illustrating an exemplary architecture for multi-dimensional mathematical compression framework.

FIG. 17 is a method diagram illustrating the use of multi-dimensional mathematical compression framework.

FIG. 18 is a block diagram illustrating an exemplary architecture for cross media GenAI codec enhancement suite.

FIG. 19 is a method diagram illustrating the use of cross media GenAI codec enhancement suite.

FIG. 20 is a block diagram illustrating an exemplary architecture for continuous learning AI analysis engine.

FIG. 21 is a method diagram illustrating the use of continuous learning AI analysis engine.

FIG. 22 is a block diagram illustrating an exemplary architecture for adaptive context monetization system.

FIG. 23 is a method diagram illustrating the use of adaptive context monetization system.

FIG. 24 illustrates an exemplary computing environment.

### DETAILED DESCRIPTION OF THE INVENTION

The inventor has conceived, and reduced to practice, a system and methods for adaptive multi-modal media processing and delivery using advanced artificial intelligence and specialized hardware architectures. This system integrates content-adaptive encoding, AI-driven optimizations, and specialized hardware components to create a highly efficient and responsive video, gaming, and content compression and delivery system that significantly improves performance while reducing the overall load of processing, data transport, storage, and energy consumption.

At its core, the adaptive multi-modal media processing and delivery system comprises several key components: a content-adaptive encoding subsystem, an AI-driven optimization subsystem, specialized hardware components, and a network interface. These components work in concert to analyze, compress, and deliver media content with unprecedented efficiency and quality.

The content-adaptive encoding subsystem is designed to dynamically adjust encoding settings based on content characteristics, user preferences, and network conditions. Unlike traditional codecs that rely on fixed encoding parameters, this subsystem employs a dynamic approach, analyzing content type, complexity, scene characteristics, and viewer preferences in real-time. This ensures an optimal balance between bitrate and quality for each video segment.

The AI-driven optimization subsystem leverages advanced artificial intelligence or machine learning models to analyze and compress media content or to generate alternative content or approximate content or augmented content intelligently. These models are trained to recognize and prioritize essential elements in games, songs, imagery, or video (e.g. video frames with supplemental motion, smell, haptic, audio, translated audio, text, braille or other accessibility specific representations of content), enabling efficient transmission and compression by focusing on transmission of ultimately presented relevant data and discarding redundant information or generating replacement information along the distribution and presentation network of devices. The subsystem employs techniques such as neural network-based encoding, which uses machine learning to estimate optimal encoding parameters based on video features, improving efficiency and quality.

Specialized hardware components can play a crucial role in enhancing the system's performance, although the system is designed to be adaptable to various hardware configurations. The system can utilize a wide range of processing units, depending on the specific implementation and available resources. For example, the system may leverage hardware such as Tensor Processing Units (TPUs) for initial video/frame generation and deep learning-based compression tasks, Field-Programmable Gate Arrays (FPGAs) for context sequencing and continuity management, Digital Signal Processors (DSPs) for audio processing, and Application-Specific Integrated Circuits (ASICs) for specialized tasks such as final content integration. These examples illustrate potential hardware configurations that could optimize performance in processing complex video data and enhance the overall compression process. However, it is important to note that the system is not limited to or dependent on these specific hardware components. The invention is designed to be flexible and can adapt to a wide range of hardware environments, from general-purpose processors to various types of specialized computing units, based on availability and specific deployment requirements. This adaptability ensures that the system can be implemented effectively across diverse computing platforms while maintaining its core functionality and performance benefits.

The system incorporates a sophisticated network interface that continuously monitors network conditions and adapts the delivery strategy accordingly. This component works in tandem with the content-adaptive encoding and AI-driven optimization subsystem to ensure smooth playback and optimal quality across various network environments.

A key innovation of the system is its ability to process and compress multi-dimensional data, including 4D video content. The multi-dimensional mathematical compression framework utilizes advanced concepts such as 4D symmetry analysis and diffeomorphic transformations. This approach enables the system to identify and exploit complex patterns and relationships within content across both spatial and temporal dimensions, leading to more efficient compression and higher quality output. It also enables a higher degree of model generalization and learning efficiency by taking into account commutative transform data symmetry.

The system also implements a model hierarchy approach, utilizing superset parent models that represent broad content types or families, and more specialized child models for specific content pieces. This method significantly reduces data transmission requirements, as parent models can be stored on local devices, requiring only the transmission of customized child models for content.

Another notable feature is the integration of goal-oriented quantization methods. This technique optimizes the digital representation of video and audio data, reducing data size without impacting perceived quality. The system employs specialized hardware, adaptable to various situations and use case necessities, such as TPUs and FPGAs to apply scalar quantizers efficiently, followed by digital processing to ensure high-quality output.

The adaptive multi-modal media processing and delivery system supports various video formats, including Side-by-Side (SBS) and Frame-Sequential 3D video. It can efficiently compress these formats using content-adaptive encoding and AI-driven optimizations. Additionally, the system can transform 2D video content into 3D using AI-driven depth estimation and reconstruction techniques, either on end devices or at intermediate points like Content Delivery Networks (CDNs) or cloud resources.

A unique aspect of the system is its ability to apply partial or full encryption to the data stream. This feature enables content protection, dynamic content filtering based on user credentials, and the creation of multi-level secure streams where different portions of the content can be accessible based on varying security clearance levels.

The system's integration with streaming platforms is facilitated through a comprehensive framework that interfaces with existing microservices architectures, CDNs, and data processing tools. This integration allows for efficient management and delivery of high-quality content on a global scale while providing an unparalleled level of customization and optimization tailored to individual user needs and preferences.

To further enhance efficiency and adaptability, the system incorporates a continuous learning AI analysis engine. This component constantly refines and improves content processing, compression, and delivery strategies based on ongoing analysis of new content, user interactions, and feedback. It employs online learning approaches, federated learning techniques, and adaptive learning rate algorithms to handle concept drift and evolving content trends.

The adaptive content monetization system within the larger framework creates dynamic, granular subscription models based on content quality or type, user preferences, and viewing habits. This AI-driven system optimizes pricing strategies, creates personalized content packages, and enables real-time adjustments based on network conditions and device capabilities.

Streamed data can involve a generative AI component that will modify content according to user preferences. Examples of this include filtering mature content, substituting one person for another in a movie, or adjusting dialog to avoid particular topics.

When a generative AI component is used it may also insert or modify objects, phrases, or other aspects of the content to produce advertisements of products and companies. This can be done based on the user profile, ongoing marketing campaigns, or a live ad market.

In summary, the adaptive multi-modal media processing and delivery system represents a significant advancement in video compression and delivery technology. By leveraging AI-driven optimizations, specialized hardware components, and advanced mathematical concepts, the system achieves highly efficient compression across various media types while maintaining high quality and significantly reducing data transmission requirements. This innovative approach enables the delivery of personalized, high-quality content tailored to individual viewer needs across a wide range of devices and network conditions, revolutionizing the landscape of digital media distribution.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to use in one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing subsystems, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “content-adaptive encoding” refers to a process of dynamically adjusting encoding parameters based on the characteristics of the input content, such as complexity, motion, and texture, to optimize compression efficiency and output quality.

The term “AI-driven optimization” refers to the use of artificial intelligence techniques, such as machine learning and neural networks, to analyze and compress media content by identifying patterns, predicting optimal encoding settings, and making intelligent decisions to maximize compression efficiency while maintaining perceptual quality.

The term “specialized hardware component” refers to purpose-built electronic devices or integrated circuits designed to perform specific computational tasks more efficiently than general-purpose processors, such as Tensor Processing Units (TPUs), Field-Programmable Gate Arrays (FPGAs), Digital Signal Processors (DSPs), and Application-Specific Integrated Circuits (ASICs).

The term “model hierarchy” refers to a structured approach to organizing machine learning models, typically consisting of parent models that represent broad content categories or types, and child models that are more specialized and tailored to specific content pieces or characteristics.

The term “4D symmetry analysis” refers to a technique for identifying patterns and redundancies in video content across three spatial dimensions and one temporal dimension, enabling more efficient compression by exploiting these symmetries.

The term “diffeomorphic transformation” refers to a smooth, invertible mapping between mathematical spaces that preserves their topological structure, used in this context to model complex relationships between different media types for enhanced compression.

The term “federated learning” refers to a machine learning technique where a model is trained across multiple decentralized devices or servers holding local data samples, without exchanging the data itself, thereby maintaining privacy and enabling collaborative learning.

The term “adaptive bitrate streaming” refers to a technique used in video streaming that adjusts the quality of the video stream in real-time based on the user's available bandwidth and device capabilities, ensuring smooth playback and optimal viewing experience.

The term “neural network ensemble” refers to a machine learning technique that combines multiple neural networks to improve overall prediction performance and robustness compared to a single neural network.

The term “goal-oriented quantization” refers to a process of discretizing continuous values in a way that optimizes for specific objectives, such as minimizing distortion or maximizing perceptual quality, in the context of data compression.

The term “latent space manipulation” refers to the process of modifying or transforming data representations in the compressed, abstract space learned by machine learning models, allowing for efficient content modifications without full decompression.

The term “multi-armed bandit approach” refers to a problem-solving framework where a fixed limited set of resources must be allocated between competing choices to maximize their expected gain, often used in this context for optimizing content delivery and user experience.

The term “multi-modal media” refers to content that combines multiple forms of communication or data types, such as text, audio, images, and video, often integrated into a single cohesive experience.

The term “Side-by-Side (SBS) 3D video” refers to a 3D video format where left and right eye views are compressed side by side into a single frame, typically doubling the width of the video while maintaining the original height.

The term “Frame-Sequential 3D video” refers to a 3D video format where left and right eye views are displayed in alternating frames, requiring active shutter glasses or other methods to separate the views for 3D perception.

The term “content-specific processing” refers to tailoring compression and optimization techniques based on the unique characteristics of different types of content, such as action movies, documentaries, or animated content.

The term “loadable GenAI codec enhancers” refers to lightweight, content-specific AI models that can be dynamically loaded to augment or fine-tune existing compression algorithms for improved performance on specific types of content.

The term “cross-media compression optimization” refers to techniques that leverage relationships and similarities between different media types (e.g., audio and video) to achieve more efficient overall compression.

The term “adaptive fidelity” refers to the dynamic adjustment of content quality or detail level based on factors such as network conditions, device capabilities, and user preferences.

The term “semantic compression” refers to a compression technique that focuses on preserving the meaningful content and context of the data rather than just reducing its size, often using AI to understand and prioritize important elements.

The term “continuous learning AI” refers to artificial intelligence systems that can update and improve their performance over time based on new data and experiences, without requiring complete retraining.

The term “dynamic content filtering” refers to the real-time modification or restriction of content based on user credentials, viewing context, or other specified criteria.

The term “adaptive content monetization” refers to flexible, AI-driven strategies for pricing and offering content based on factors such as user behavior, content popularity, and market conditions.

The term “perceptual quality” refers to the subjective assessment of content quality as perceived by human viewers, often used as a metric for optimizing compression algorithms.

The term “entropy coding” refers to a lossless data compression technique that assigns shorter codes to more frequent symbols or values in the data, thereby reducing the overall size of the encoded information.

The term “transform coding” refers to a type of data compression where the original data is transformed into a different domain (e.g., frequency domain) before encoding, often allowing for more efficient compression.

The term “inter-frame coding” refers to a video compression technique that exploits temporal redundancy by encoding differences between video frames rather than encoding each frame independently.

The term “intra-frame coding” refers to a video compression technique that compresses each frame independently, without reference to other frames, typically used for random access points in a video stream.

The term “motion estimation” refers to the process of determining motion vectors that describe the transformation from one 2D image to another, usually from adjacent frames in a video sequence.

The term “motion compensation” refers to a technique used in video compression that uses the motion vectors from motion estimation to predict frames based on previous or future frames.

The term “variable bitrate (VBR) encoding” refers to a method of encoding where the bitrate varies based on the complexity of the content, allowing for more efficient use of bandwidth while maintaining quality.

The term “constant bitrate (CBR) encoding” refers to a method of encoding where the bitrate remains constant regardless of content complexity, often used in streaming scenarios where consistent bandwidth usage is required.

The term “chunked transfer encoding” refers to a streaming data transfer mechanism in which data is sent in a series of chunks, allowing for efficient, real-time data transmission without knowing the total size of the content in advance.

The term “adaptive streaming” refers to a technique used in video streaming where the quality and bitrate of the video are dynamically adjusted based on the viewer's network conditions and device capabilities.

The term “buffer” in streaming context refers to a region of memory used to temporarily hold data while it is being moved from one place to another, often used to smooth out variations in data transfer rates.

The term “codec” refers to a device or computer program capable of encoding or decoding a digital data stream or signal, often used in the context of audio or video compression.

The term “transcoding” refers to the direct digital-to-digital conversion of one encoding to another, often used to convert incompatible or obsolete data to a better-supported, newer format.

The term “Quality of Service (QOS)” in streaming refers to the overall performance of a network or service as experienced by the users, often measured in terms of error rates, bitrates, throughput, transmission delay, availability, or jitter.

The term “predictive analytics” refers to the use of statistical algorithms, machine learning techniques, and historical data to identify the likelihood of future outcomes.

The term “synchronized content delivery” refers to the simultaneous or coordinated distribution of media content to multiple devices, ensuring consistency in playback timing and user experience.

The term “AI-powered content creation” refers to the use of artificial intelligence algorithms to generate, modify, augment or enhance digital content autonomously or semi-autonomously.

The term “immersive media” refers to content formats that create a surrounding, multi-sensory experience for the user, typically including virtual reality (VR), augmented reality (AR), and mixed reality (MR) content.

The term “haptics” refers to the use of technology that stimulates the sense of touch and motion in a user, typically through vibrations, forces, or movements, to provide tactile feedback and enhance the immersive experience in digital environments.

The term “kinematics” refers to the branch of mechanics that describes the motion of points, bodies, and systems without consideration of the forces that cause the motion, often applied in analyzing user movements or the motion of interactive devices in media consumption scenarios.

The term “telematics” refers to the interdisciplinary field encompassing telecommunications, vehicular technologies, electrical engineering, and computer science, used to capture, transmit, and analyze data related to the movement and state of remote objects or users interacting with media content.

The term “olfactory feedback” refers to the use of scent-producing technology to enhance the immersive experience of media content by stimulating the user's sense of smell in coordination with visual and auditory elements.

The term “dynamic language translation” refers to the real-time process of converting spoken or written content from one language to another within a media stream, allowing users to experience content in their preferred language regardless of the original language of the content.

The term “subtitle localization” refers to the process of adapting and translating on-screen text or captions from the original language of a media content to the viewer's preferred language, while considering cultural context and linguistic nuances.

The term “blockchain” refers to a decentralized, distributed ledger technology that records transactions across multiple computers in a way that ensures the records cannot be altered retroactively without altering all subsequent blocks.

The term “edge computing” refers to a distributed computing paradigm that brings computation and data storage closer to the location where it is needed, improving response times and saving bandwidth.

The term “quantum computing” refers to a type of computation that utilizes the principles of quantum mechanics to perform complex computations, potentially offering exponential speedups for certain types of problems compared to classical computing.

The term “personalized advertising” refers to the practice of tailoring promotional content to individual users based on their characteristics, behaviors, preferences, and contextual data which may also be informed by broader demographic, market or advertiser data sets or elements.

The term “cross-platform content adaptation” refers to the process of modifying digital content to suit the specific requirements and capabilities of different devices or operating systems.

The term “Quality of Experience (QoE)” refers to a measure of the overall level of customer satisfaction with a service, taking into account both objective and subjective factors of the end-user's perception of the service.

The term “Adaptive Neural Network Architecture” refers to a machine learning system that can automatically modify its structure, complexity, or parameters in response to changes in input data or processing requirements.

The term “biometric data” refers to physical or behavioral human characteristics that can be used to digitally identify a person to grant access to systems, devices, or data.

The term “distributed ledger technology” refers to a digital system for recording the transaction of assets in which the transactions and their details are recorded in multiple places at the same time, without a central data store or administration functionality.

The term “energy-efficient media processing” refers to techniques and algorithms designed to minimize power consumption in the computation, storage, and transmission of digital media content while maintaining acceptable quality and performance levels.

### Adaptive Intelligent Multi-Modal Media Processing and Delivery System Overview

The adaptive intelligent multi-modal media processing and delivery system comprises several interconnected subsystems that work together to optimize content processing, compression, and delivery.

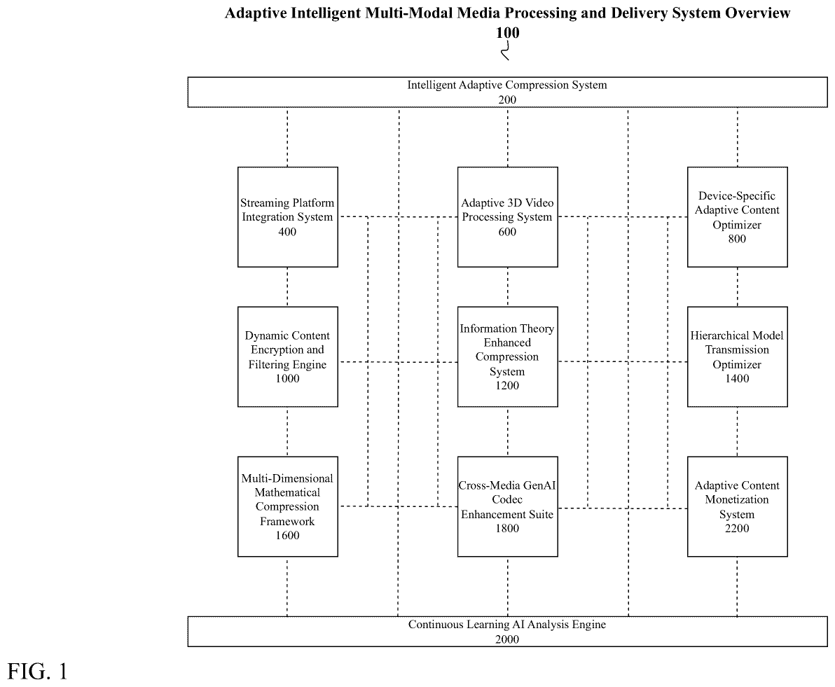

FIG. 1 is a block diagram illustrating a system overview of adaptive intelligent multi-modal media processing and delivery system. At the core of the system is the intelligent adaptive compression system 200, which dynamically adjusts encoding settings based on content characteristics and viewer preferences. This architecture integrates content-adaptive encoding, AI-driven optimizations, and specialized hardware components adaptable to the specific implementation needs of the system such as Tensor Processing Units, Field-Programmable Gate Arrays, Digital Signal Processors, and Application-Specific Integrated Circuits.

The streaming platform integration system 400 enables seamless incorporation of these advanced compression techniques into existing streaming architectures. It utilizes a microservices architecture, custom content delivery network, and stream processing components to facilitate efficient content distribution and real-time data analysis.

The adaptive 3D video processing system 600 handles multiple 3D video formats and provides 2D to 3D transformation capabilities. It leverages specialized hardware components and AI-driven optimizations from the intelligent adaptive compression architecture to process and compress 3D content effectively.

The device-specific adaptive content optimizer 800 enhances content processing and delivery on devices with integrated AI chips. It employs content-specific, genre-specific, and quality-specific processing approaches to optimize performance and resource usage based on various factors including content type, network conditions, and device state.

The dynamic content encryption and filtering engine 1000 applies encryption algorithms and content filtering techniques to digital media streams. It can selectively encrypt parts of the data stream and dynamically modify or restrict access to certain content based on user credentials or viewing context.

The information theory enhanced compression system 1200 leverages principles from information theory to optimize compression efficiency. It incorporates semantic compression techniques, Bayesian network modeling, and network pruning strategies to achieve high compression ratios while maintaining content quality.

The hierarchical model transmission optimizer 1400 reduces data transmission requirements by utilizing a model hierarchy approach with superset parent models and customized child models. This system efficiently represents and transmits content, significantly reducing the amount of data that needs to be sent.

The multi-dimensional mathematical compression framework 1600 utilizes advanced mathematical concepts, particularly 4D symmetry analysis and diffeomorphic transformations, to achieve highly efficient compression across various media types. It extends traditional compression techniques by considering spatial, temporal, and abstract mathematical dimensions.

The cross-media GenAI codec enhancement suite 1800 optimizes compression and processing across various media types using advanced generative AI techniques. It implements a model hierarchy approach and leverages 4D symmetries and diffeomorphic transformations for cross-media compression optimization.

The continuous learning AI analysis engine 2000 constantly refines and improves content processing, compression, and delivery strategies based on ongoing analysis of new content, user interactions, and feedback. It implements online learning, federated learning, and adaptive learning rate algorithms to handle evolving content trends and user preferences.

The adaptive content monetization system 2200 creates dynamic, granular subscription models based on content quality, user preferences, and viewing habits. It integrates with the content delivery infrastructure to provide flexible, personalized monetization strategies for digital media content.

These subsystems work together, sharing data and leveraging each other's capabilities to create a comprehensive, efficient, and adaptive media processing and delivery system. The intelligent adaptive compression system 200 forms the foundation, with other subsystems building upon its capabilities and extending functionality for specific use cases and media types. The continuous learning AI analysis engine 2000 and adaptive content monetization system 2200 provide overarching optimization and monetization strategies that benefit from and inform the operations of the other subsystems.

For example, if a user is streaming a high-definition movie on a smartphone with an integrated AI chip, as the user initiates the stream, the device-specific adaptive content optimizer 800 begins monitoring network conditions and device state. The intelligent adaptive compression system 200 selects optimal encoding parameters based on the movie's content characteristics, the user's preferences, and current network conditions. The streaming platform integration system 400 manages content delivery, utilizing its custom CDN to minimize latency. The hierarchical model transmission optimizer 1400 checks if the appropriate parent model for the movie's genre is already on the user's device. If so, only the smaller, customized child model for this specific movie is transmitted, reducing data transfer. As the movie plays, the multi-dimensional mathematical compression framework 1600 and cross-media GenAI codec enhancement suite 1800 work together to apply advanced compression techniques, leveraging 4D symmetries and diffeomorphic transformations to maintain high quality at lower bitrates. The dynamic content encryption and filtering engine 1000 ensures that the content is properly encrypted during transmission and applies any necessary content filtering based on the user's profile. If the user is watching on a smart TV with multiple viewers, the system might use computer vision to detect viewer ages and adjust content filtering accordingly. During the viewing session, the continuous learning AI analysis engine 2000 monitors the user's engagement and quality of experience, making real-time adjustments to optimize performance. It also aggregates this data to inform future improvements to the system. Throughout the use of the system by the user, the adaptive content monetization system 2200 dynamically adjusts pricing and subscription options based on the user's viewing habits and preferences, potentially offering personalized upgrade options for higher quality or additional content.

### Intelligent Adaptive Compression System Architecture

The intelligent adaptive compression system is a sophisticated system that revolutionizes video encoding and compression by dynamically adjusting based on content characteristics and viewer preferences. This system builds upon existing video codecs and hardware/software infrastructures to significantly enhance performance while concurrently reducing the overall load of processing, data transport, storage, and energy consumption.

At its core, intelligent adaptive compression system integrates content-adaptive encoding, AI-driven optimizations, and specialized hardware components to create a highly efficient and responsive video compression and delivery system. Unlike traditional codecs that rely on fixed encoding parameters, this architecture employs a dynamic approach, adjusting encoding settings in real-time based on content type, complexity, scene analysis, and viewer preferences. This ensures an optimal balance between bitrate and quality for each video segment.

Implementation of content-adaptive encoding leverages neural networks and closed-loop feedback mechanisms. Video quality is evaluated on a frame-by-frame basis, allowing for the application of optimal compression levels without compromising perceptual quality. This process is further enhanced by AI-driven optimizations, which employ machine learning models to understand and reconstruct video content. These models are trained to recognize and prioritize essential elements in video frames such as people, places, dialog, objects, scenes, qualitative aspects including feel and tone. This enables efficient compression by focusing on relevant data and discarding redundant information.

To achieve superior compression results, intelligent adaptive compression architecture utilizes an ensemble of AI models capable of transposing content into a unique latent compression space. A partner model is then used to expand this compressed representation back into the original content or a high-similarity version. This approach transcends traditional methods of compressing individual frames or storing deltas from keyframes, as these AI models consider a piece of content's context as an integral part of compression and encoding.

Specialized hardware components play a crucial role in intelligent adaptive compression system. The system can utilize a wide range of processing units, depending on the specific implementation and available resources. For example, Tensor Processing Units (TPUs) may be employed for initial video/frame generation and deep learning-based compression tasks, ensuring high performance in processing complex video data. Field-Programmable Gate Arrays (FPGAs) could handle context sequencing and continuity, maintaining temporal and spatial consistency across frames. Digital Signal Processors (DSPs) could manage audio elements, including voice and sound effects, ensuring synchronization with video. Application-Specific Integrated Circuits (ASICs) can perform specialized tasks such as context sequencing and final content integration, optimizing overall compression processes. These examples illustrate potential hardware configurations that could optimize performance in processing complex video data and enhance the overall compression process. However, it is important to note that the system is not limited to or dependent on these specific hardware components. The invention is designed to be flexible and can adapt to a wide range of hardware environments, from general-purpose processors to various types of specialized computing units, based on availability and specific deployment requirements. This adaptability ensures that the system can be implemented effectively across diverse computing platforms while maintaining its core functionality and performance benefits.

The hardware sequence for content generation and compression begins with initial video/frame generation using TPUs. These units efficiently handle large-scale matrix operations and are well-suited for deep learning tasks required for video frame generation and initial compression. AI subsystems for pixel shift tracking and redundancy removal are implemented on TPUs to identify and remove redundant pixel data, optimizing initial compression processes.

Context sequencing and continuity are managed using FPGAs or ASICs or GPUs. These highly customizable devices are optimized for specific tasks, such as ensuring temporal and spatial consistency across video frames. Characteristic Trackers and Central AI Coordinators often run on FPGAs or ASICs, ensuring key elements remain consistent and coherent across frames. A Combiner mechanism is implemented to manage joint feature representation learning for video and audio.

Audio processing is handled by a separate sequence dedicated to managing audio elements, including voice, sound effects, and background music. This is accomplished using specialized DSPs or dedicated audio processing units. Audio generative AI subsystems process and encode different audio elements, while techniques such as pixel-to-feature motion prediction enhance audio compression. Integration of audio features with video features is managed using Combiner mechanisms to ensure synchronization.

Movement processing is managed by a dedicated subsystem designed to handle various user scenarios and device configurations. This subsystem utilizes specialized movement processing units or motion co-processors to analyze and respond to user movement and orientation data. Kinematics and telematics algorithms process input from various sources such as VR headsets, motion-sensing chairs, and room-scale tracking systems. The system dynamically adjusts content delivery based on whether the user is sitting on a couch with a VR headset, watching content on a laptop or phone, or experiencing media on a 6 Degrees of Freedom (DOF) motion platform with vibration enhancements. Motion prediction and compensation techniques are employed to optimize content rendering and reduce motion sickness in VR environments. Integration of movement data with video and audio features is managed using Synchronization mechanisms to ensure a cohesive, immersive experience across different viewing scenarios.

Final content harmonization is achieved through an integration stage processor, which combines all processed elements-video, audio, and contextual data-into a cohesive output. This stage is managed by a central integration processor, which is for example a powerful GPU or another specialized ASIC designed for multimodal content integration. Central AI coordinator oversees integration processes, combining video frames processed by TPUs and FPGAs/ASICS with audio elements processed by DSPs while ensuring continuity and coherence using consistency AI components.

Intelligent adaptive compression system incorporates goal-oriented quantization methods to optimize digital representation of video and audio data. This technique reduces data size without impacting perceived quality. Specialized hardware such as TPUs and FPGAs apply scalar quantizers to efficiently compress analog signals, followed by digital processing to ensure high-quality output. DSPs are used for analog combining, enhancing input signals before quantization. Scalar quantizers are implemented on FPGAs/ASICs to quantize combined analog signals, optimizing digital representation. GPUs or specialized ASICs process quantized data, ensuring task-specific goals such as minimizing distortion.

Advancements in adaptive quantization strategies, advanced non-uniform quantization methods, and integration of quantization with Neural Architecture Search (NAS) further enhance performance and applicability of quantization techniques. Additionally, optimizations are run for specific content elements (e.g., ads vs. shows), devices (e.g., phones vs. projectors), and content types (e.g., news vs. movies) to further refine compression processes.

Content analysis subsystem may incorporate predictive analytics capabilities to forecast content trends and user preferences, enabling proactive content preparation and delivery optimization. Adaptive processing subsystem may include AI-powered content creation and real-time modification capabilities, allowing for dynamic content adaptation based on user interactions and preferences. Adaptive processing subsystem may include capabilities for dynamic, personalized advertising insertion, optimizing monetization strategies based on user preferences, viewing habits, and content context. Continuous learning subsystem may incorporate real-time quality of experience optimization using AI techniques, dynamically adjusting delivery parameters to maximize user satisfaction across varying network conditions and device capabilities. AI-driven optimization component may include a system for dynamically adjusting its neural network architecture based on content type and processing requirements, optimizing performance and resource utilization for diverse media processing tasks.

In a use case example of personalized advertising and content replacement, the adaptive multi-modal media processing and delivery system demonstrates its capability to dynamically modify content based on user profiles and licensing agreements. For instance, consider a user streaming a popular NBC show through the system. The show originally features the main character driving a GMC Sierra truck. However, the system's AI-driven content analysis subsystem, in conjunction with the user preference integrator, identifies that the viewer is a Toyota enthusiast or a prospective Toyota buyer.

In real-time, the system's content modification engine, part of the dynamic content encryption and filtering engine, replaces the GMC Sierra in the video with a Toyota Tundra. This replacement is seamlessly integrated, maintaining the scene's context and visual quality. The replacement is not just a simple overlay but involves sophisticated 3D model substitution, ensuring that the new vehicle appears natural from all angles and in all lighting conditions throughout the scene.

Similarly, the system can handle Name, Image, and Likeness (NIL) scenarios in sports content. For example, in a classic football game replay where Joe Montana is the quarterback, the system can dynamically replace him with a current player like Brock Purdy, assuming the appropriate licensing agreements are in place. This replacement goes beyond simple image substitution; it involves adapting player movements, jersey numbers, and even commentator narratives to match the replaced player.

These content replacements are executed by the cross-media GenAI codec enhancement suite, which utilizes advanced AI models to ensure that the substituted content blends seamlessly with the original footage. The continuous learning AI analysis engine constantly refines these replacement techniques based on user engagement metrics and feedback.

This level of personalization and dynamic content modification not only enhances the viewer's experience by presenting more relevant content but also opens up new revenue streams for content providers through highly targeted advertising and flexible content licensing models. The system's ability to perform these modifications in real-time, while maintaining high visual quality and contextual relevance, showcases its advanced capabilities in adaptive content delivery and monetization.

By leveraging these advanced technologies and specialized components, intelligent adaptive compression system significantly improves performance, reduces processing load, and optimizes data transport, storage, and energy consumption, surpassing traditional video compression and delivery systems. The system may be configured to provide seamless content adaptation across diverse platforms, including mobile devices, smart TVs, gaming consoles, and emerging technologies, ensuring optimal viewing experiences regardless of the target device. The user preference integrator may be extended to incorporate biometric data, such as heart rate or eye tracking information, enabling ultra-personalized content delivery and interaction based on the user's physiological responses.

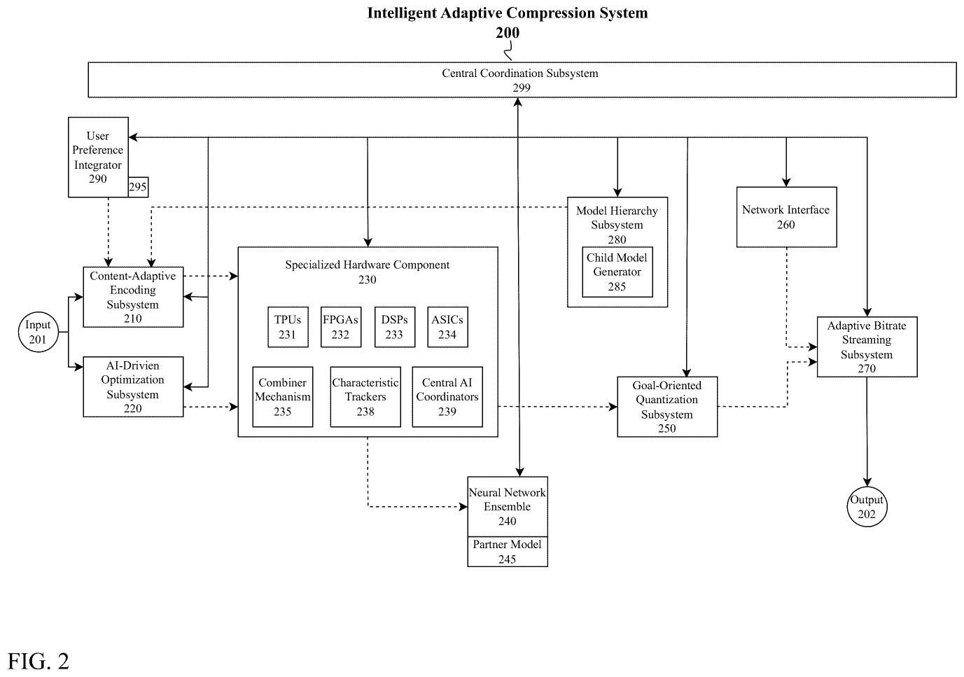

FIG. 2 is a block diagram illustrating exemplary architecture of intelligent adaptive compression system 200. The system comprises several interconnected components that work together to provide efficient and adaptive compression of multimedia content.

At the core of the system is the content-adaptive encoding subsystem 210, which dynamically adjusts encoding settings based on content characteristics and viewer preferences. This subsystem analyzes incoming video and audio data to determine optimal compression parameters for each segment of content. Content-adaptive encoding subsystem 210 dynamically adjusts encoding settings based on content type, complexity, scene analysis, and viewer preferences. Subsystem 210 employs neural networks and closed-loop feedback mechanisms to evaluate video quality on a frame-by-frame basis. This allows for the application of optimal compression levels without compromising perceptual quality. Adaptive processing subsystem 210 may incorporate techniques for optimizing energy consumption in media processing and delivery, dynamically adjusting computational resources and delivery parameters to balance performance and power efficiency across various devices and network conditions.

Subsystem 210 analyzes incoming video content to identify key characteristics such as motion, texture, and color complexity. For example, it might detect high-motion scenes in action sequences or static scenes in dialogue-heavy portions of a movie. Based on this analysis, it can allocate more bits to complex, high-motion scenes while applying stronger compression to simpler, static scenes.

Content-adaptive encoding subsystem 210 also considers viewer preferences and historical viewing data. This includes, for example, preferred resolution, device capabilities, or typically watched content types. By considering these factors, subsystem 210 can further optimize the encoding process to deliver the best possible viewing experience for each individual user.

Subsystem 210 works in tandem with the AI-driven optimization subsystem 220, leveraging machine learning models to understand and reconstruct video content. These models are trained to recognize and prioritize essential elements in video frames, enabling efficient compression by focusing on relevant data and discarding redundant information.

Through this adaptive approach, the content-adaptive encoding subsystem ensures an optimal balance between bitrate and quality for each video segment, significantly enhancing the overall efficiency of the compression process while maintaining high perceptual quality.

Connected to the content-adaptive encoding subsystem 210 is AI-driven optimization subsystem 220. This subsystem employs machine learning models to recognize and prioritize essential elements in video frames and audio streams. It focuses on relevant data and discards redundant information, enhancing compression efficiency AI-driven optimization subsystem 220 employs machine learning models to analyze and compress video content intelligently. This subsystem is designed to understand and reconstruct video content, focusing on recognizing and prioritizing essential elements in video frames.

The subsystem utilizes an ensemble of AI models capable of transposing content into a unique latent compression space. These models are trained on large datasets of video content to recognize patterns, textures, and objects commonly found in different types of video. By understanding the content at a semantic level, the system can make intelligent decisions about what information is most important to preserve during compression. AI-driven optimization subsystem 220 utilizes a sophisticated ensemble of machine learning models, including convolutional neural networks (CNNs) for spatial analysis of video frames, and recurrent neural networks (RNNs) or transformer models for capturing temporal dependencies. This ensemble incorporates variational autoencoders (VAEs) and generative adversarial networks (GANs) to transpose content into a latent compression space, while a separate deep neural network serves as the partner model for reconstructing the compressed representation. These models are trained through a multi-stage process involving pre-training on diverse video datasets, fine-tuning for specific content types, and adversarial training to enhance reconstruction quality. The training regimen employs supervised learning with paired original and compressed videos, unsupervised learning to capture underlying patterns, and reinforcement learning to optimize for specific quality metrics. Transfer learning techniques enable rapid adaptation to new content types, while continuous learning approaches allow the system to evolve based on real-world usage. This comprehensive AI framework enables the subsystem to deliver highly efficient, context-aware compression that maintains high visual quality across various content types and viewing conditions.

A key feature of subsystem 220 is its ability to identify and focus on relevant data while discarding redundant information. For example, in a scene with a moving object against a static background, the AI models might prioritize the accurate representation of the moving object while applying stronger compression to the unchanging background elements.

AI-driven optimization subsystem 220 works in conjunction with a partner model that is responsible for expanding the compressed representation back into the original content or a high-similarity version. This approach transcends traditional methods of compressing individual frames or storing deltas from keyframes, as these AI models consider a piece of content's context as an integral part of compression and encoding. Subsystem 220 also adapts its strategies based on the type of content being processed. For instance, it might employ different optimization techniques for sports content versus animated content, recognizing the unique characteristics and requirements of each genre.

By leveraging these advanced AI techniques, AI-driven optimization subsystem 220 enables more efficient compression by focusing on perceptually important elements of the video, resulting in lower bitrates while maintaining high visual quality. This intelligent approach to compression forms a core part of the system's ability to deliver optimized content across various network conditions and devices.

Intelligent adaptive compression system 200 incorporates a comprehensive feedback mechanism 225 that operates across multiple subsystems. This closed-loop feedback system continuously evaluates the quality of the compressed output on a frame-by-frame basis, comparing it to the original input and desired quality parameters. The feedback mechanism 225 interfaces primarily with content-adaptive encoding subsystem 210 and AI-driven optimization subsystem 220, providing real-time data on compression performance and perceptual quality. This information is used to dynamically adjust encoding parameters, AI model weights, and optimization strategies. For instance, if feedback mechanism 225 detects a decrease in perceptual quality in fast-moving scenes, it can signal content-adaptive encoding subsystem 210 to allocate more bits to these segments. Similarly, it can guide AI-driven optimization subsystem 220 in refining its prioritization of visual elements. This continuous feedback loop ensures that the system maintains optimal compression levels without compromising visual quality, adapting in real-time to changes in content complexity, network conditions, and user preferences. Feedback mechanism 225 also integrates with the goal-oriented quantization subsystem 250, fine-tuning quantization parameters to balance compression efficiency with perceptual quality.

The system incorporates a specialized hardware component 230, which includes various processing units optimized for specific tasks. This component comprises, for example, Tensor Processing Units (TPUs) 231 for initial video frame generation and deep learning-based compression tasks, Field-Programmable Gate Arrays (FPGAs) 232 for context sequencing and continuity management, Digital Signal Processors (DSPs) 233 for audio processing, and Application-Specific Integrated Circuits (ASICs) 234 for final content integration.

TPUs 231 are employed for initial video frame generation and deep learning-based compression tasks. These units excel at handling the large-scale matrix operations common in neural network computations, making them ideal for the AI-driven aspects of the compression process. FPGAs 232 are utilized for context sequencing and continuity management. Their reconfigurable nature allows them to be optimized for specific video processing tasks, particularly in maintaining temporal and spatial consistency across frames. DSPs 233 are dedicated to audio processing. They handle tasks such as audio compression, synchronization with video frames, and real-time audio effect processing, ensuring high-quality audio output that remains in sync with the video content. ASICs 234 are employed for specialized tasks such as final content integration. These custom-designed chips are optimized for specific functions within the compression workflow, offering high performance and energy efficiency for their designated tasks.

Tensor Processing Units 231 are equipped with a sophisticated pixel shift tracking and redundancy removal subsystem 235. This AI-driven subsystem 235 is specifically designed to optimize initial compression processes by identifying and eliminating redundant pixel data across video frames. The pixel shift tracking component utilizes advanced computer vision algorithms to accurately detect and quantify the movement of pixels between consecutive frames. It creates detailed motion vectors that describe how each pixel or block of pixels shifts from one frame to the next. Simultaneously, the redundancy removal component analyzes these motion vectors along with the raw frame data to identify areas of visual consistency or repetition. By recognizing redundant information, whether it's stationary background elements or predictable motion patterns, the subsystem can significantly reduce the amount of data needed to represent the video sequence. This process is particularly effective for scenes with subtle movements or large static areas. The implementation of these functions on TPUs 231 allows for rapid, parallel processing of multiple video streams or high-resolution content, ensuring that this computationally intensive task doesn't become a bottleneck in the overall compression pipeline. By efficiently eliminating redundancies at this early stage, the subsystem lays the groundwork for more aggressive and effective compression in subsequent stages of processing.

Content-adaptive encoding subsystem 210 leverages the initial redundancy removal performed by the pixel shift tracking and redundancy removal subsystem in the TPUs 231, allowing it to focus on higher-level content characteristics for encoding optimization. AI-driven optimization subsystem 220 builds upon the foundational work of the pixel shift tracking and redundancy removal subsystem 235, using the identified motion vectors and redundancy patterns to inform its more advanced compression strategies. Neural network ensemble 240 incorporates information from the pixel shift tracking and redundancy removal subsystem to enhance its understanding of temporal relationships in the video content, improving the efficiency of its latent space representations. Goal-oriented quantization subsystem 250 adjusts its quantization parameters based on the redundancy patterns identified by the pixel shift tracking and redundancy removal subsystem, applying coarser quantization to areas of high redundancy. Adaptive bitrate streaming subsystem 270 uses insights from the pixel shift tracking and redundancy removal subsystem to optimize chunk sizes and keyframe placement in the compressed bitstream. Central coordination subsystem 299 coordinates the flow of information from the pixel shift tracking and redundancy removal subsystem to other components, ensuring that the redundancy insights are leveraged throughout the compression pipeline.

The specialized hardware component 230 is a key element of the intelligent adaptive compression system 200, designed to efficiently process complex video data. This component comprises a suite of purpose-built processing units that work in concert to optimize the compression pipeline. The system can utilize a wide range of processing units, depending on the specific implementation and available resources. The process begins with TPUs 231, which handle the initial video frame generation and deep learning-based compression tasks. TPUs 231 excel at parallel processing of large matrices, making them ideal for running the neural network models that analyze incoming video frames. They implement algorithms for feature extraction, object recognition, and motion estimation, providing a foundation for content-aware compression. The invention is designed to be flexible and can adapt to a wide range of hardware environments, from general-purpose processors to various types of specialized computing units, based on availability and specific deployment requirements. This adaptability ensures that the system can be implemented effectively across diverse computing platforms while maintaining its core functionality and performance benefits.

The output from the TPUs 232 is then passed to FPGAs 232. These reconfigurable chips are programmed to manage context sequencing and continuity. They implement custom logic for temporal and spatial analysis, ensuring smooth transitions between frames and maintaining visual coherence throughout the video. FPGAs 232 are particularly effective at real-time adaptive processing, allowing them to adjust their operations based on changing video content and compression requirements.

Simultaneously, DSPs 233 focus on audio processing. They employ specialized algorithms for audio compression, such as perceptual coding techniques that remove imperceptible audio data. DSPs 233 also handle the critical task of audio-video synchronization, ensuring that sound remains perfectly aligned with the visual content throughout the compression and streaming process.

ASICs 234 serve as the final integration point in the hardware pipeline. These custom-designed chips are optimized for specific high-performance tasks such as entropy coding, quantization, and bitstream formation. ASICs implement proprietary algorithms that bring together the processed video and audio streams, applying final compression optimizations before the content is ready for transmission.

The specialized hardware component 230 operates in close coordination with the AI-driven optimization subsystem 220. For example, the TPUs 231 may run reduced versions of the AI models for real-time processing, while the full models run on more powerful cloud hardware. The FPGAs 232 can be dynamically reconfigured based on AI-derived insights about the content being processed, allowing for on-the-fly optimization of the hardware pipeline.

This hardware ensemble enables the system to process and compress video content with high efficiency and quality. By distributing tasks across specialized processors, the system can handle multiple aspects of compression simultaneously, significantly reducing overall processing time while maintaining the ability to adapt to different content types and compression requirements.

Within specialized hardware component 230, a combiner mechanism 235 is implemented to manage joint feature representation learning for video and audio. This mechanism 235, primarily executed on the ASICs 234, works in close coordination with the TPUs 231 processing video data and the DSPs 233 handling audio elements. Combiner mechanism 235 analyzes the extracted features from both audio and video streams, identifying correlations and synchronization points between the two modalities. It creates a unified representation that captures the intricate relationships between visual and auditory elements, such as matching lip movements with speech or aligning sound effects with on-screen actions. This joint representation allows for more efficient compression by exploiting cross-modal redundancies and preserving the semantic coherence between audio and video. Combiner mechanism 235 also facilitates advanced audio-visual analysis, enabling the system to make more informed decisions about compression priorities based on the combined audio-visual context. For example, it prioritizes the preservation of audio quality during dialogue-heavy scenes or enhances visual detail during moments of significant audio impact. This integrated approach to audio-visual processing contributes significantly to the system's ability to maintain high perceptual quality while achieving superior compression ratios.

Within the specialized hardware component 230, FPGAs 232 and ASICs 234 host AI-driven characteristic trackers 238 and central AI coordinators 239. The characteristic trackers 238 are sophisticated algorithms implemented on FPGAs 232, designed to identify and monitor key visual and auditory elements across video frames. These trackers maintain a continuous awareness of important features such as main characters, significant objects, or recurring audio signatures throughout the content. Working in tandem with characteristic trackers 238, central AI coordinators 239, primarily running on ASICs 234, oversee the global coherence of the compressed content. These coordinators 239 ensure that the key elements identified by characteristic trackers 238 remain consistent and coherent across frames, even as the content undergoes various compression and optimization processes. Central AI coordinators 238 make real-time decisions on how to maintain the integrity of these key elements while allowing for efficient compression of less critical components. This synergy between characteristic trackers 238 and central AI coordinators 239 enables the system to preserve the perceptual quality and narrative coherence of the content, even at high compression ratios. Their implementation on FPGAs and ASICs allows for the rapid, parallel processing necessary to handle these complex tasks in real-time, contributing significantly to the overall efficiency and effectiveness of the intelligent adaptive compression system.

Characteristic trackers 238 and central AI coordinators 239, implemented on FPGAs 232 and ASICs 234 respectively, are integrated throughout the intelligent adaptive compression system 200, providing crucial input to various subsystems to identify, prioritize, and maintain consistency of key visual and auditory elements across the entire compression and delivery pipeline. For example, characteristic trackers 238 provide input to content-adaptive encoding subsystem 210, helping it identify key visual and auditory elements that should be prioritized during encoding. central AI coordinators 239 can guide the encoding process to maintain consistency of these elements across frames. AI-driven optimization subsystem 220 leverages the information from characteristic trackers 238 to focus its optimization efforts on essential elements identified across video frames. Central AI coordinators 239 can help ensure that the optimizations maintain global coherence of the content. characteristic trackers 238 informs neural network ensemble 240 about which features are most important to preserve when transposing content into the latent compression space. central AI coordinators 239 guides the partner model 245 in reconstructing content while maintaining consistency of key elements. Goal-oriented quantization subsystem 250 uses input from the characteristic trackers 238 to adjust quantization parameters, allocating more bits to key visual and auditory elements. central AI coordinators 239 oversees this process to ensure global quality is maintained. characteristic trackers 238 help identify which elements are crucial to maintain quality during bitrate adjustments in adaptive bitrate streaming subsystem 270. Central AI coordinators 239 guide decisions on how to adapt streaming parameters while preserving content coherence. Characteristic trackers 238 inform the creation of content-specific child models 285 by identifying key elements that need special attention. Central AI coordinators 239 ensures that these models maintain consistency with parent models 280. User preference integrator 290 uses information from characteristic trackers 238 to identify user preferences related to specific visual or auditory elements. Central AI coordinators 239 help ensure these preferences are consistently applied across the content. Central coordination subsystem 299 uses input from both the characteristic trackers 238 and central AI coordinators 239 to make high-level decisions about resource allocation and processing priorities across all subsystems.

The neural network ensemble 240 is designed to transpose content into a unique latent compression space. This ensemble consists of multiple AI models working in concert to analyze and compress video content efficiently. The models in this ensemble are trained to recognize and prioritize essential elements in video frames, enabling the system to focus on relevant data and discard redundant information. This subsystem works in conjunction with a partner model 245 that expands the compressed representation back into the original content or a high-similarity version.

Ensemble 240 employs advanced machine learning techniques to understand the content at a semantic level. This allows for intelligent decisions about what information is most important to preserve during compression. For example, in a scene with a moving object against a static background, the ensemble might prioritize the accurate representation of the moving object while applying stronger compression to the unchanging background elements. Working in conjunction with the neural network ensemble 240 is the partner model 245. This model is responsible for expanding the compressed representation back into the original content or a high-similarity version. The partner model 245 is trained to interpret the latent space representation created by the ensemble and reconstruct it into full video frames.

At its core, ensemble 240 utilizes Convolutional Neural Networks (CNNs) for spatial analysis of video frames, capturing important visual elements and patterns. These are complemented by Recurrent Neural Networks (RNNs) or Long Short-Term Memory (LSTM) networks to model temporal dependencies across frame sequences. The ensemble also incorporates Variational Autoencoders (VAEs) to learn compact latent representations of the video content, crucial for transposing the content into a unique latent compression space. The partner model 245, responsible for reconstructing the compressed content, is implemented as a deep neural network with an architecture similar to Generative Adversarial Networks (GANs). This model is trained to expand the latent representation back into high-quality video frames. The training process for these models involves a multi-stage approach, beginning with pre-training on large, diverse video datasets to learn general features and patterns. This is followed by fine-tuning on specific content types to specialize the models for particular use cases. Adversarial training techniques are employed to improve the quality of reconstructed video, with the GAN's discriminator network trained to distinguish between original and reconstructed frames, thereby pushing the partner model to produce higher quality output.

This approach transcends traditional methods of compressing individual frames or storing deltas from keyframes. Instead, neural network ensemble 240 and partner model 245 consider a piece of content's context as an integral part of compression and encoding. This context-aware approach allows for more efficient compression while maintaining high visual fidelity.

The neural network ensemble 240 and partner model 245 are designed to work across various content types and genres. They can adapt their compression strategies based on the specific characteristics of the content being processed, whether it's a fast-paced action sequence, a dialogue-heavy scene, or a visually complex animated segment.

By leveraging these advanced AI techniques, neural network ensemble 240 and partner model 245 enable the intelligent adaptive compression system 200 to achieve high compression ratios while preserving the perceptual quality of the video content. This results in efficient data transmission and storage without compromising the viewer's experience.

Goal-oriented quantization subsystem 250 optimizes the digital representation of video and audio data. It applies scalar quantizers to efficiently compress analog signals, followed by digital processing to ensure high-quality output. subsystem 250 focuses on reducing data size without impacting perceived quality, striking a balance between compression efficiency and output fidelity.

Subsystem 250 employs advanced quantization methods to efficiently compress analog signals into digital representations. It utilizes scalar quantizers, which are implemented on specialized hardware components such as TPUs and FPGAs, to discretize continuous signal values into a finite set of levels. This process is crucial for reducing the amount of data required to represent the video and audio content.

A key feature of goal-oriented quantization subsystem 250 is its adaptive nature. It dynamically adjusts quantization parameters based on the content characteristics, user preferences, and network conditions. For instance, it might apply finer quantization to regions of high visual importance or complexity, while using coarser quantization for less critical areas.

Subsystem 250 incorporates perceptual models that take into account human visual and auditory systems. These models guide the quantization process to prioritize preserving details that are most noticeable to human perception, allowing for more aggressive compression in areas where quality reduction is less detectable. Following the quantization process, the subsystem employs digital processing techniques to ensure high-quality output. This may involve post-processing filters to reduce quantization artifacts and enhance the overall perceived quality of the compressed content.

Goal-oriented quantization subsystem 250 works in close coordination with other components of the intelligent adaptive compression system 200. It receives input from content-adaptive encoding subsystem 210 and AI-driven optimization subsystem 220 to inform its quantization decisions. The output of this subsystem feeds into adaptive bitrate streaming subsystem 270, ensuring that the quantized data is optimally prepared for transmission across varying network conditions.

By implementing these advanced quantization techniques, goal-oriented quantization subsystem 250 plays a crucial role in achieving high compression ratios while maintaining the perceptual quality of the video and audio content. This results in efficient data transmission and storage without compromising the viewer's experience.

Network interface 260 is included to receive real-time data on network conditions. This information is used by the adaptive bitrate streaming subsystem 270 to dynamically adjust video quality based on network conditions and user preferences. interface 260 continuously monitors various network parameters such as bandwidth, latency, and packet loss rates. It provides a vital link between the compression system and the external network environment, enabling the system to adapt its compression and streaming strategies based on current network performance.

Network interface 260 employs advanced networking protocols and technologies to accurately measure and report network conditions. It may utilize techniques such as active probing, passive monitoring, and historical data analysis to provide a comprehensive view of the network state. This real-time information is crucial for making informed decisions about content delivery and compression settings.

Working in close conjunction with network interface 260 is the adaptive bitrate streaming subsystem 270. This subsystem is responsible for dynamically adjusting video quality based on network conditions and user preferences. It leverages the real-time network data provided by network interface 260 to make intelligent decisions about content delivery.

Adaptive bitrate streaming subsystem 270 implements adaptive streaming techniques, allowing it to switch between different quality levels of the same content in real-time. This is achieved by maintaining multiple versions of the content at various bitrates and resolutions. As network conditions fluctuate, the subsystem can seamlessly switch between these versions to ensure smooth playback and optimal viewing experience.

Subsystem 270 employs sophisticated algorithms to predict short-term network performance and preemptively adjust streaming parameters. This proactive approach helps to minimize buffering events and maintain consistent video quality. It may also implement techniques such as dynamic chunk sizing, where the size of video segments is adjusted based on network conditions to optimize delivery efficiency.

Furthermore, adaptive bitrate streaming subsystem 270 considers user preferences and device capabilities. It can adjust its streaming strategy based on factors such as the user's preferred quality settings, device screen resolution, and available processing power. This ensures that the delivered content is not only optimized for network conditions but also for the specific viewing context of each user.

Subsystem 270 also incorporates error resilience techniques to handle network disruptions gracefully. This includes, for example, implementing robust error correction codes, intelligent packet retransmission strategies, and adaptive buffering mechanisms.

By working together, network interface 260 and adaptive bitrate streaming subsystem 270 enable the intelligent adaptive compression system 200 to deliver high-quality content efficiently across a wide range of network conditions. This results in a smoother, more consistent viewing experience for users, while optimizing bandwidth usage and adapting to the constraints of various network environments.

System 200 also features model hierarchy subsystem 280, which stores parent models representing broad content types or families. This subsystem works with customized child model generator 285 to create specific models for individual content pieces.

The parent models stored in model hierarchy subsystem 280 encapsulate general characteristics and patterns common to specific genres or content categories. For example, there are parent models for action movies, documentaries, or animated content. These models contain neural network architectures and weights that capture high-level features and stylistic elements typical of their respective content categories.

Working in tandem with model hierarchy subsystem 280 is customized child model generator 285. This component is responsible for creating specific models for individual content pieces. When a particular movie or TV show is processed, customized child model generator 285 analyzes its unique characteristics and generates a compact model that, when combined with the appropriate parent model, can accurately reproduce the content. Child models focus on encoding content-specific details, such as unique characters, plot elements, or visual styles that deviate from the general patterns captured by the parent model. This approach allows for highly efficient content representation, as only the differences and specific features need to be encoded in the child model.

Model hierarchy subsystem 280 and customized child model generator 285 work together to significantly reduce data transmission requirements. For example, when a user requests specific content, the system checks if the appropriate parent model is already present on the user's device. If so, only the customized child model for the requested content needs to be transmitted, which is typically much smaller than the full content or a complete standalone model. This hierarchical approach also enables efficient updates and improvements to the compression system. Parent models can be periodically updated to reflect evolving content trends, while child models can be quickly generated or modified to account for new content or changing user preferences.

The model hierarchy subsystem 280 includes sophisticated management tools for versioning, storage, and retrieval of models. It ensures that the appropriate models are available when needed and manages the lifecycle of models from creation to retirement. By leveraging this hierarchical model approach, the intelligent adaptive compression system 200 achieves highly efficient content representation and transmission, adapting to specific content characteristics while minimizing data transfer requirements. This results in faster content delivery, reduced bandwidth usage, and improved overall system performance.

The user preference integrator 290 analyzes user behavior, viewing history, and explicit preferences to create a comprehensive understanding of each user's content consumption patterns. It considers factors such as preferred resolution, device capabilities, commonly watched content types, and specific quality preferences for different genres or viewing contexts.

Working in conjunction with user preference integrator 290, user profile database 295 serves as a centralized repository for storing and managing user-specific information. This database contains detailed profiles for each user, including their viewing history, device information, quality preferences, and any explicitly set preferences or settings.

User profile database 295 is designed with scalability and security in mind. It employs advanced data encryption techniques to protect user privacy and implements efficient data structures for quick retrieval and update of user profiles. The database is regularly updated to reflect changes in user behavior and preferences over time.

When a user initiates a content streaming session, user preference integrator 290 queries user profile database 295 to retrieve the relevant user profile. It then uses this information to customize various aspects of the content delivery process. For example, it adjusts the target bitrate for video streaming based on the user's typical quality preferences or prioritizes certain audio characteristics based on the user's historical viewing patterns.

User preference integrator 290 also works closely with other subsystems of intelligent adaptive compression system 200. It provides input to content-adaptive encoding subsystem 210 to tailor the encoding process to user preferences. It interacts with adaptive bitrate streaming subsystem 270 to ensure that the delivered content meets the user's quality expectations while adapting to network conditions.

User preference integrator 290 employs machine learning techniques to continuously refine and update user profiles based on ongoing interactions. It detects changes in user preferences over time and adjust its personalization strategies accordingly. This adaptive approach ensures that the system remains responsive to evolving user needs and preferences. This includes collaborative and content-based filtering to predict preferences and analyze content characteristics, matrix factorization to discover latent features in user tastes, and deep neural networks to model complex relationships between user behaviors and content features. Reinforcement learning optimizes content delivery strategies over time, while time series analysis captures temporal patterns in viewing habits. Clustering algorithms group similar users for shared insights, and online learning algorithms enable real-time profile updates. Multi-armed bandit approaches balance exploration of new content types with exploitation of known preferences. This diverse set of techniques allows the system to adapt to evolving user preferences, detect nuanced patterns in viewing behavior, and provide increasingly personalized content delivery. User preference integrator 290 processes various user interactions, including content selection, viewing duration, quality setting adjustments, and explicit feedback, to continuously enhance its understanding of each user's preferences. This adaptive approach ensures that the intelligent adaptive compression system 200 remains responsive to individual user needs while also leveraging aggregated insights across its user base, resulting in a highly personalized and optimized viewing experience.

By leveraging user preference integrator 290 and user profile database 295, intelligent adaptive compression system 200 delivers a highly personalized viewing experience. This not only enhances user satisfaction but also optimizes system resources by focusing on delivering content in a manner that best aligns with each user's individual preferences and viewing habits.

Central coordination subsystem 299 serves as the core orchestrator of intelligent adaptive compression system 200, coordinating the operations of all subsystems and managing the overall data flow and decision-making processes. This powerful processing unit is designed to handle the complex computational tasks required for adaptive compression and content delivery.

Central coordination subsystem 299 is responsible for integrating inputs from various subsystems, processing this information, and making real-time decisions to optimize compression and streaming process. It receives data from content-adaptive encoding subsystem 210, AI-driven optimization subsystem 220, and network interface 260, among others. By analyzing this diverse set of inputs, central coordination subsystem 299 can make informed decisions about how to best compress and deliver content for each unique situation.

In its role as system coordinator, central coordination subsystem 299 manages the workflow between different hardware components. It delegates specific tasks to specialized hardware such as the TPUs 231, FPGAs 232, DSPs 233, and ASICs 234, ensuring that each component is utilized efficiently based on its strengths. This intelligent task distribution maximizes the overall system performance and energy efficiency.

Central coordination subsystem 299 also plays a crucial role in implementing the adaptive strategies of the system. It processes the output from neural network ensemble 240 and partner model 241, applies the quantization determined by the goal-oriented quantization subsystem 250, and adjusts the streaming parameters based on input from the adaptive bitrate streaming subsystem 270. This adaptive processing ensures that the system can respond in real-time to changes in content, network conditions, and user preferences.

Furthermore, central coordination subsystem 299 manages the model hierarchy, working with model hierarchy subsystem 280 and customized child model generator 285 to ensure that the appropriate models are used for each piece of content. It coordinates the loading and application of parent and child models, optimizing the compression process for different content types.

Central coordination subsystem 299 also interfaces with user preference integrator 290, incorporating user-specific data from the user profile database 295 into its decision-making processes. This allows for personalized content delivery tailored to individual user preferences and viewing habits.

By serving as the central coordinator for all these complex processes, central coordination subsystem 299 enables intelligent adaptive compression system 200 to deliver highly efficient, personalized, and high-quality content across various network conditions and devices. Its ability to process and integrate information from multiple subsystems in real-time is key to the system's adaptive and responsive nature.

In intelligent adaptive compression system 200, incoming content is first analyzed by the content-adaptive encoding subsystem 210 and the AI-driven optimization subsystem 220, with input from characteristic trackers 238 to identify key visual and auditory elements. The processed data is then handled by the specialized hardware component 230 for various computational tasks, including the operation of characteristic trackers 238 on FPGAs 232 and central AI coordinators 239 on ASICs 234. The neural network ensemble 240 and partner model 245 further compress the content, guided by the central AI coordinators 239 to maintain content coherence. The compressed content is then quantized by subsystem 250. The adaptive bitrate streaming subsystem 270 adjusts the output based on network conditions from interface 260, while preserving key elements identified by the characteristic trackers 238. Throughout this process, the model hierarchy subsystem 280 and user preference integrator 290 provide content-specific and user-specific optimizations. Central coordination subsystem 299 oversees this entire process, ensuring efficient data flow and processing, while leveraging input from both characteristic trackers 238 and central AI coordinators 239 for high-level decision making.

This architecture enables the intelligent adaptive compression system 200 to provide highly efficient, content-aware, and user-tailored compression for multimedia content.

For example, in an embodiment a user is streaming a high-definition action movie on their smartphone while commuting on a train. As the content enters intelligent adaptive compression system 200, content-adaptive encoding subsystem 210 analyzes the movie, recognizing it as an action film with fast-paced scenes and complex visual effects. Simultaneously, characteristic trackers 238 identify and begin monitoring key visual elements such as main characters and significant objects.

This information is shared with the streaming platform integration system 400, which prepares the content delivery network for high-bandwidth, low-latency transmission. AI-driven optimization subsystem 220 then identifies key elements in each frame, prioritizing important visual information like character movements and explosions while reducing emphasis on less critical background details, guided by input from characteristic trackers 238.

This optimized content is processed by the specialized hardware component 230, where TPUs handle initial video frame generation and compression, FPGAs ensure smooth transitions between scenes and run the characteristic trackers 238, DSPs process the audio to maintain clarity of dialogue and sound effects, and ASICs integrate the processed video and audio while running the central AI coordinators 239. Within this component, combiner mechanism 235, primarily executed on the ASICs 234, manages joint feature representation learning for video and audio, creating a unified representation that captures the intricate relationships between visual and auditory elements.

Neural network ensemble 240 compresses the content into a latent space, with partner model 245 ready to reconstruct it on the user's device, a process that is optimized by cross-media GenAI codec enhancement suite 1800 for efficient delivery across the network. Throughout this process, central AI coordinators 239 ensure that the key elements identified by characteristic trackers 238 remain consistent and coherent, while combiner mechanism 235 ensures that audio-visual synchronization and semantic coherence are maintained.

As the content is being processed, network interface 260 detects that the user's cellular connection fluctuates as the train moves. This information is relayed to device-specific adaptive content optimizer 800, which works in conjunction with adaptive bitrate streaming subsystem 270 to dynamically adjust the video quality, maintaining smooth playback despite the changing network conditions. Central AI coordinators 239 guide this process to ensure that key visual and auditory elements identified by characteristic trackers 238 are preserved even as quality is adjusted, with combiner mechanism 235 ensuring that audio-visual relationships are maintained during these adjustments.

Goal-oriented quantization subsystem 250 optimizes the digital representation of the movie, balancing file size and visual quality based on these real-time conditions, allocating more bits to the key elements identified by characteristic trackers 238 and preserving the audio-visual relationships established by combiner mechanism 235. Meanwhile, model hierarchy subsystem 280 utilizes a parent model for action movies stored on the user's phone, while child model generator 285 creates a specific model for this film, incorporating the key elements identified by characteristic trackers 238 and audio-visual relationships established by combiner mechanism 235. This process is further enhanced by hierarchical model transmission optimizer 1400 to reduce data transmission requirements, with the central AI coordinators 239 ensuring that the generated models maintain global coherence of the content.

It should be noted that the intelligent adaptive compression system 200 is designed with modularity in mind. The various subsystems and hardware components described, such as the specialized hardware component 230 with its TPUs, FPGAs, DSPs, and ASICs, are present in various embodiments of the invention. This modular approach allows for flexible implementation across a wide range of devices and use cases. For instance, a high-end streaming device might incorporate all described components for maximum performance, while a mobile device might utilize a subset of these components optimized for energy efficiency. This modularity ensures that the system can be adapted to different hardware capabilities, performance requirements, and energy constraints, making it versatile and future-proof.

Intelligent adaptive compression system 200 forms the core of a comprehensive multimedia processing and delivery ecosystem, interacting seamlessly with several other systems to enhance overall performance. It shares content characteristics and optimization strategies with the streaming platform integration system 400, enabling efficient content delivery network preparation. System 200 works in tandem with device-specific adaptive content optimizer 800 to dynamically adjust video quality based on device capabilities and network conditions. It leverages hierarchical model transmission optimizer 1400 to reduce data transmission requirements through efficient model management. Cross-media genAI codec enhancement suite 1800 optimizes the system's compression and reconstruction processes for various media types. continuous learning AI analysis engine 2000 provides ongoing refinement of the system's strategies based on new content and user feedback. Finally, adaptive content monetization system 2200 utilizes insights from the compression system to create dynamic subscription models and personalized content offerings. Through these interactions, the intelligent adaptive compression system enables a highly efficient, adaptive, and personalized content delivery experience across diverse network conditions and devices.

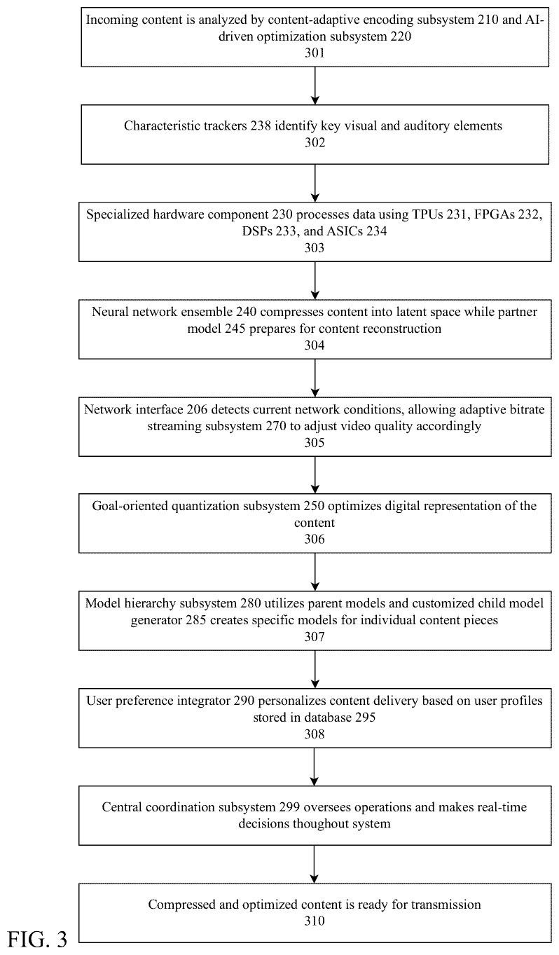

FIG. 3 is a method diagram illustrating the use of intelligent adaptive compression system. The process begins when incoming content is analyzed by content-adaptive encoding subsystem 210 and AI-driven optimization subsystem 220 301. Characteristic trackers 238 then identify key visual and auditory elements 302. Next, specialized hardware component 230 processes data using hardware such as TPUs 231, FPGAs 232, DSPs 233, and ASICs 234 303. Neural network ensemble 240 compresses content into latent space, while partner model 245 prepares for content reconstruction 304. Network interface 260 detects current network conditions, allowing adaptive bitrate streaming subsystem 270 to adjust video quality accordingly 305. Goal-oriented quantization subsystem 250 optimizes digital representation of the content 306. Model hierarchy subsystem 280 utilizes parent models and customized child model generator 285 creates specific models for individual content pieces 307. User preference integrator 290 personalizes content delivery based on user profiles stored in database 295 308. Throughout the entire process, central coordination subsystem 299 oversees operations and makes real-time decisions 309, for example managing workflow by delegating specific tasks to specialized hardware components such as TPUs 231, FPGAs 232, DSPs 233, and ASICs 234, ensuring efficient utilization of each component based on its strengths. Finally, the compressed and optimized content is ready for transmission 310.

### Streaming Platform Integration System Architecture

Streaming platform integration system 400 enables seamless incorporation of advanced AI-driven video compression techniques into existing streaming architectures, significantly enhancing video compression and delivery processes. System 400 leverages content-adaptive encoding, AI-driven optimizations, and specialized hardware components to revolutionize streaming services. Streaming platform integration system may be enhanced to include a decentralized content distribution network utilizing distributed ledger technology, improving efficiency, security, and transparency in content delivery.

At the core of system 400 lies microservices architecture, which forms the backbone of the backend system. Data storage is distributed across databases such as, for example, MySQL, Gluster, and Cassandra. An application server, for example Apache Tomcat, hosts the architecture while large data processing and analysis is directed by a data ecosystem, for example Hadoop ecosystem, Hive and/or Chukwa. Content delivery network (CDN) manages efficient content distribution. Streaming platform integration system 400 incorporates a custom CDN solution optimized for high-performance content delivery. CDN nodes are strategically placed to minimize latency and maximize throughput, ensuring smooth playback experience for users across diverse geographical locations.

Stream processing is handled by an event streaming platform, for example Kafka and/or Apache Chukwa, enabling real-time data ingestion and processing. This allows for rapid analysis of user behavior, content popularity, and network conditions, facilitating dynamic adjustments to content delivery strategies. Integration of specialized processing architectures forms key component of streaming platform integration system 400. Tensor Processing Units (TPUs) are deployed in backend to handle initial video frame generation and compression. These TPUs integrate seamlessly with existing transcoding services, for example Netflix's TransCoder Service, enhancing format adaptation and video processing capabilities.

For context sequencing and continuity, system 400 employs semiconductor devices, for example Field-Programmable Gate Arrays (FPGAs) and/or Application-Specific Integrated Circuits (ASICs) in backend. These specialized chips ensure video and audio continuity, working in tandem with existing video services and global search functionalities to enable efficient content retrieval and sequencing.

Audio processing is managed by microprocessor chips, for example Digital Signal Processors (DSPs), which are utilized to ensure precise synchronization with video frames. DSPs integrate with subscription management and user authentication services, enabling delivery of personalized audio experiences tailored to individual user preferences and subscription tiers.

Central to system 400 is integration stage processor implemented using, for example, a high-performance GPU or specialized ASIC. This processor harmonizes video, audio, and contextual data, ensuring cohesive and seamless viewing experience. It interfaces with API gateway (for example, Netflix's ZUUL) to facilitate dynamic routing, monitoring, and security features.

System 400 incorporates advanced content-adaptive encoding techniques that dynamically adjust encoding settings based on content type, complexity, and user preferences. This approach enables delivery of high-quality video content at significantly lower bitrates, reducing bandwidth usage and improving overall streaming efficiency.

AI-driven optimizations are core component of system 400, employing machine learning models to analyze and compress video content intelligently. These models are trained to recognize and prioritize essential elements in video frames, enabling efficient compression by focusing on relevant data and discarding redundant information.

To further enhance efficiency, streaming platform integration system 400 implements model hierarchy approach. Parent models representing content types or families are stored on local devices, while only customized models for specific content are transmitted. This significantly reduces data transmission requirements and enables faster content delivery.

System 400 also incorporates goal-oriented quantization methods to optimize digital representation of video and audio data. This technique reduces data size without impacting perceived quality, utilizing specialized hardware such as TPUs and FPGAs to apply scalar quantizers and perform efficient digital processing.

Adaptive bitrate streaming is implemented to dynamically adjust video quality based on network conditions and user preferences. This ensures seamless viewing experience across various devices and network environments, automatically optimizing quality-to-bandwidth ratio in real-time.

For personalization, system 400 leverages AI-driven recommendation systems and user profiling techniques. These systems analyze user behavior, viewing history, and preferences to deliver tailored content recommendations and personalized viewing experiences. The AI-driven optimization component includes advanced generative AI capabilities that can modify content in real-time according to user preferences and contextual factors. This generative AI subsystem can perform a wide range of content modifications, enhancing the viewing experience and content relevance. It can automatically detect and modify mature content to suit viewer preferences or parental control settings, ensuring appropriate content delivery across diverse audience segments. The system can replace one person with another in video content, which can be used for personalization or to update older content with current personalities, thereby extending the relevance and appeal of existing media libraries. Furthermore, generative AI can modify spoken dialog to avoid topics, change the tone of conversations, or localize content for different cultural contexts, broadening the global accessibility of content.

In addition to these capabilities, the generative AI subsystem can add, remove, or alter objects within scenes to enhance storytelling, avoid obsolescence, or integrate product placements seamlessly. It can also generate additional background elements or extend scenes to create more immersive experiences or to adapt content for different aspect ratios and display formats, ensuring optimal viewing across various devices and platforms. These modifications are performed using state-of-the-art machine learning models trained on diverse datasets, ensuring high-quality, seamless alterations that maintain the overall coherence and quality of the content. The generative AI subsystem works in concert with other components of the adaptive processing system to ensure that modified content is properly compressed, encoded, and delivered to end-users with minimal latency, providing a seamless and enhanced viewing experience. Security and content protection are integral aspects of streaming platform integration system 400. It implements robust encryption mechanisms to protect content during transmission and storage. Additionally, system 400 supports dynamic content filtering based on user credentials, enabling features such as parental controls and region-specific content restrictions.

To optimize storage and processing resources, streaming platform integration system 400 employs intelligent caching mechanisms and distributed computing techniques. This approach reduces operational costs and energy consumption while maintaining high performance and scalability.

Streaming platform integration system 400 incorporates a user interface component that serves as the primary point of interaction for end-users. This UI provides intuitive access to content browsing, playback controls, and account management features. It dynamically adapts its display based on device capabilities and user preferences, ensuring optimal viewing experiences across various platforms such as smartphones, tablets, smart TVs, and web browsers. The UI component integrates seamlessly with other subsystems, displaying personalized content recommendations, subscription options, and quality settings. It also facilitates user feedback and preference inputs, which are crucial for the continuous learning AI analysis engine and the adaptive content monetization system. The UI's design prioritizes responsiveness and accessibility, adjusting in real-time to network conditions and device states as reported by the device-specific adaptive content optimizer.

Streaming platform integration system may be configured to synchronize content delivery across multiple devices associated with a single user, enabling seamless transition and consistent viewing experiences across different platforms.”

By integrating these advanced technologies and techniques, streaming platform integration system 400 enables delivery of high-quality, personalized content on global scale while providing unparalleled level of customization and optimization tailored to individual user needs and preferences.

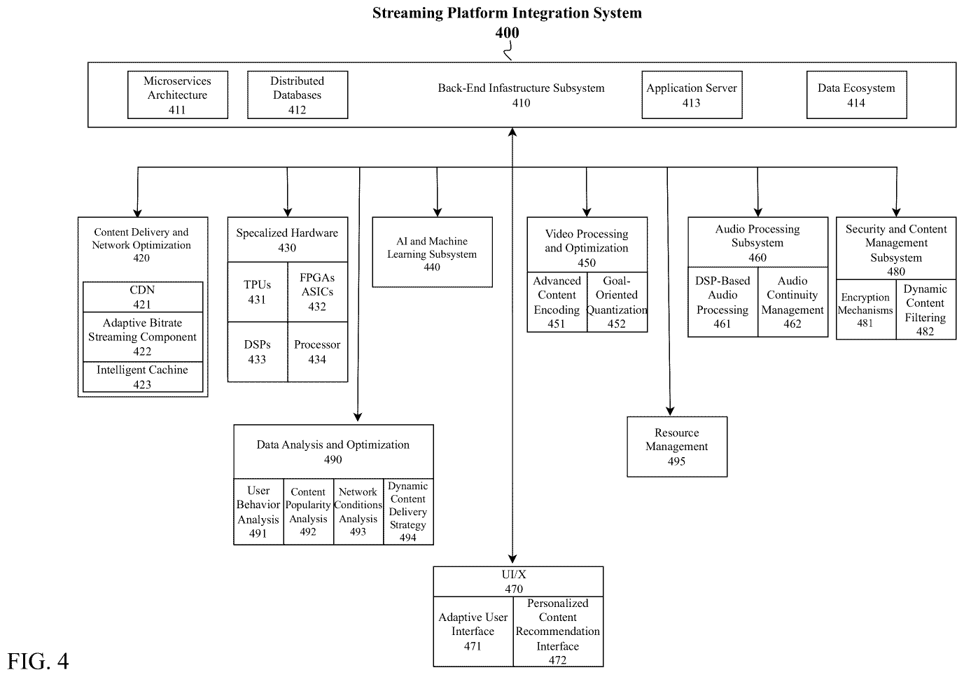

FIG. 4 is a block diagram illustrating exemplary architecture of streaming platform integration system 400. System 400 comprises several interconnected subsystems that work together to provide an efficient and adaptive streaming platform.

At the core of system 400 is the backend infrastructure subsystem 410. This subsystem includes microservices architecture 411 which interacts with distributed databases 412 (for example, MySQL, Gluster, and Cassandra) for data storage. The microservices architecture 411 may include, but is not limited to, microservices such as user authentication, content delivery optimization, and recommendation engines. These examples are illustrative and not exhaustive, as the system is designed to flexibly incorporate various microservices to handle specific functions within the streaming platform. An application server 413, for example Apache Tomcat, hosts the architecture. For large data processing and analysis, the backend infrastructure subsystem 410 utilizes a data ecosystem 414, which includes components such as, for example, Hadoop, Hive, and Chukwa.

Connected to the backend infrastructure subsystem 410 is the content delivery and network optimization subsystem 420. This subsystem includes custom-optimized content delivery network (CDN) 421 with strategically placed nodes to minimize latency and maximize throughput. Adaptive bitrate streaming component 422 works in conjunction with CDN 421 to dynamically adjust video quality based on network conditions and user preferences. Intelligent caching mechanism 423 optimizes storage and processing resources within this subsystem. Mechanism 423 comprises a content popularity analyzer that tracks and predicts which content is likely to be requested frequently, a cache allocation system that decides what content to store in the cache based on the popularity analysis, and/or a performance monitor that tracks cache hit rates and adjusts caching strategies accordingly.

The specialized hardware integration subsystem 430 is a key component of system 400. It includes a wide range of processing units, depending on the specific implementation and available resources. For example, in an embodiment tensor processing units (TPUs) 431 are present for initial video frame generation and compression. Field-programmable gate arrays (FPGAs) or application-specific integrated circuits (ASICs) 432 are employed for context sequencing and continuity. Digital signal processors (DSPs) 433 manage audio processing and synchronization. An integration stage processor 434, which may be a high-performance GPU or specialized ASIC, harmonizes video, audio, and contextual data.

AI and machine learning subsystem 440 is central to system's 400 advanced capabilities. It includes content-adaptive encoding component 441, which dynamically adjusts encoding settings based on content type and complexity. This component utilizes a convolutional neural network (CNN) model trained on a diverse dataset of video content to classify video scenes and determine optimal encoding parameters. The model is trained using supervised learning techniques with human-labeled data for various content types and their ideal encoding settings.

AI-driven video compression optimization component 442 employs deep learning models, specifically a combination of CNNs and recurrent neural networks (RNNs), to analyze and compress video content intelligently. These models are trained on pairs of high-quality and compressed video frames, learning to identify and preserve the most important visual information while minimizing file size. The training process involves a generative adversarial network (GAN) approach, where the compression model competes against a discriminator model to produce high-quality compressed frames.

A model hierarchy approach 443 is implemented to efficiently store and transmit models. This approach uses a tree-based structure of neural networks, with a base model capturing general video characteristics and specialized child models for specific content types. The base model is trained on a broad dataset of video content, while child models are fine-tuned on more specific datasets relevant to their content category.

AI-driven recommendation system 444 utilizes collaborative filtering techniques combined with deep learning models, specifically matrix factorization enhanced with neural networks. This hybrid model is trained on user interaction data, including viewing history, ratings, and implicit feedback. The training process involves both supervised learning on explicit user ratings and unsupervised learning on implicit user behaviors.

User profiling component 445 employs a combination of clustering algorithms (such as k-means) and neural networks to categorize users and predict their preferences. This component is trained using semi-supervised learning techniques on anonymized user data, including demographics, viewing history, and interaction patterns.

Video processing and optimization subsystem 450 works closely with AI and machine learning subsystem 440. It includes the advanced content-adaptive encoding component 451, which uses reinforcement learning models to optimize encoding decisions in real-time. These models are trained using deep Q-learning techniques, where the model learns to make encoding decisions that maximize video quality while minimizing bandwidth usage.

Goal-oriented quantization component 452 employs deep learning models, specifically autoencoders, to perform intelligent quantization of video data. These models are trained on a large dataset of video frames, learning to compress and decompress frames with minimal loss of perceptual quality. The training process involves minimizing a loss function that balances reconstruction quality and compression ratio.

Audio processing subsystem 460 manages all audio-related tasks. It includes the DSP-based audio processing and synchronization component 461 and the audio continuity management component 462.

User interface and experience subsystem 470 serves as the primary point of interaction for end-users. It includes an adaptive user interface component 471 that dynamically adapts its display based on device capabilities and user preferences. The personalized content recommendation interface 472 presents tailored content suggestions to users.

Security and content management subsystem 480 ensures the protection and proper distribution of content. It includes encryption mechanisms 481 for protecting content during transmission and storage. The dynamic content filtering component 482 supports features such as parental controls and region-specific content restrictions.

Data analysis and optimization subsystem 490 enables real-time analysis and system improvements. It includes components for analyzing user behavior 491, content popularity 492, and network conditions 493. These components feed into the dynamic content delivery strategy adjustment component 494.

Lastly, resource management subsystem 495 oversees the efficient use of system resources. It includes distributed computing techniques, such as load balancing across multiple processors or devices, parallel processing, and cloud computing integration. The subsystem also implements storage optimization components, which may include data compression algorithms, deduplication techniques, and intelligent caching mechanisms to maximize storage efficiency and minimize data retrieval times. and storage optimization components.

All these subsystems are interconnected and work in concert to create an efficient, adaptive, and personalized streaming experience while optimizing resource usage and maintaining high security standards. Data flows between these subsystems to enable real-time adjustments and optimizations based on user behavior, network conditions, and content characteristics. The AI models within these subsystems are continuously fine-tuned using federated learning techniques, allowing the system to improve its performance over time while maintaining user privacy. backend infrastructure subsystem 410 provides content data to the content delivery and network optimization subsystem 420. This content data includes raw video and audio files, metadata, and other relevant information needed for streaming.

Content delivery and network optimization subsystem 420 then sends optimized content to the specialized hardware integration subsystem 430. This optimized content is prepared for efficient processing and delivery based on current network conditions and user requirements.

AI and machine learning subsystem 440 exchanges user data with user interface and experience subsystem 470. It receives user interaction data and viewing history, which it uses to generate personalized recommendations that are then sent back to the user interface. Content delivery and network optimization subsystem 420 provides network metrics to the video processing and optimization subsystem 450. These metrics inform the video processing algorithms about current network conditions, allowing for adaptive encoding and compression. Video processing and optimization subsystem 450 sends encoded content back to the content delivery and network optimization subsystem 420 for distribution to users. Specialized hardware integration subsystem 430 provides processing metrics to both the video processing and optimization subsystem 450 and the audio processing subsystem 460. These metrics help optimize the use of specialized hardware for video and audio processing tasks. Security and content management subsystem 480 shares security policies with the data analysis and optimization subsystem 490, ensuring that data analysis and optimization processes adhere to content protection and user privacy requirements. Data analysis and optimization subsystem 490 sends resource allocation information to resource management subsystem 495, which uses this information to optimize system resources across all subsystems.

In an embodiment, there is a bidirectional flow of user feedback between user interface and experience subsystem 470 and resource management subsystem 495. This allows for real-time adjustments to resource allocation based on user experience. Similarly, in another embodiment there is a bidirectional exchange of optimization data between data analysis and optimization subsystem 490 and resource management subsystem 495, enabling continuous refinement of resource allocation strategies.

All these subsystems work in concert, with data flowing between them to enable real-time adjustments and optimizations based on user behavior, network conditions, and content characteristics. This intricate interplay of subsystems allows streaming platform integration system 400 to deliver an efficient, adaptive, and personalized streaming experience while optimizing resource usage and maintaining high security standards.

The system's generative AI capabilities extend beyond content modification to enable highly sophisticated, personalized advertising integrations. The adaptive content monetization system leverages these capabilities to dynamically insert or modify objects, phrases, or other aspects of the content to produce seamless, contextually relevant advertisements for products and companies. This process is driven by a complex interplay of factors, creating a highly targeted and effective advertising ecosystem. The system analyzes individual user profiles, including preferences, viewing history, and demographic information, to determine the most relevant and engaging ad content for each viewer. Simultaneously, it considers ongoing marketing campaigns, allowing it to prioritize and integrate current marketing initiatives from various advertisers, ensuring that ad placements align with broader campaign goals.

Furthermore, the system interfaces with live ad bidding platforms, enabling real-time decisions on ad placements based on current market rates and advertiser demand. This dynamic approach allows for optimal monetization of content while maintaining relevance to the viewer. Crucially, the generative AI ensures that these ad integrations are seamlessly woven into the content, maintaining narrative coherence and visual consistency. This advanced approach to advertising allows for a non-disruptive viewing experience while maximizing the effectiveness of ad placements. By doing so, it creates new revenue streams for content providers and more engaging, personalized experiences for viewers, striking a balance between commercial interests and user satisfaction.

In a non-limiting example, in an embodiment of streaming platform integration system 400 a user selects “Galactic Odyssey,” a newly released 4K sci-fi movie, on their smart TV. User interface and experience subsystem 470 sends the user's request to the backend infrastructure subsystem 410, which retrieves the movie data and forwards it to the content delivery and network optimization subsystem 420. Concurrently, AI and machine learning subsystem 440 analyzes the user's viewing history to predict the optimal starting quality. Security and content management subsystem 480 verifies the user's subscription status and applies appropriate DRM. The video processing and optimization subsystem 450 prepares multiple quality versions of the movie using AI-driven compression techniques, while the audio processing subsystem 460 optimizes various audio tracks. As the content delivery and network optimization subsystem 420 initiates streaming of the 4K version, it continuously monitors network conditions. The specialized hardware integration subsystem 430 utilizes hardware encoding to efficiently process the 4K stream. Twenty minutes into the movie, when the user's network experiences congestion, data analysis and optimization subsystem 490 detects this change, prompting content delivery subsystem 420 to seamlessly switch to a 1080p version, gradually increasing quality as conditions improve. When the user pauses the movie and enables subtitles, the user interface subsystem 470 immediately applies this change, and AI and ML subsystem 440 updates the user's preference profile. Throughout the session, resource management subsystem 495 continuously allocates system resources to maintain optimal performance. Post-viewing, the data analysis and optimization subsystem 490 logs the user's session to refine recommendations and improve system performance. This use case demonstrates how system 400's subsystems work in concert to provide a seamless, high-quality, and personalized viewing experience, adapting to both user preferences and external factors.

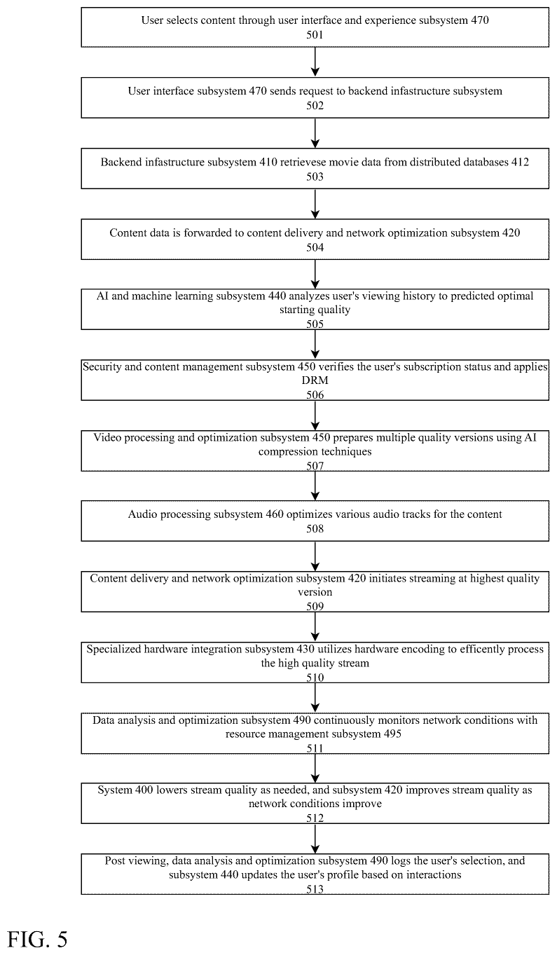

FIG. 5 is a method diagram illustrating the use of streaming platform integration system 400. The user selects content through user interface and experience subsystem 470 501. User interface subsystem 470 sends the request to backend infrastructure subsystem 410 502. Backend infrastructure subsystem 410 retrieves movie data from distributed databases 412 503. Content data is forwarded to content delivery and network optimization subsystem 420 504. AI and machine learning subsystem 440 analyzes the user's viewing history to predict optimal starting quality 505. Security and content management subsystem 480 verifies the user's subscription status and applies appropriate DRM 506. Video processing and optimization subsystem 450 prepares multiple quality versions using AI-driven compression techniques 507. Audio processing subsystem 460 optimizes various audio tracks for content 508. Content delivery and network optimization subsystem 420 initiates streaming of the highest quality version 509. Specialized hardware integration subsystem 430 utilizes hardware encoding to efficiently process the high-quality stream 510. Data analysis and optimization subsystem 490 continuously monitors network conditions with resource management subsystem 495 511. If network congestion is detected, system 400 switches to a lower quality version, and content delivery subsystem 420 gradually increases quality as network conditions improve 512. Post-viewing, data analysis and optimization subsystem 490 logs the user's session, and subsystem 440 updates the user's profile based on interactions during the streaming session 513.

The streaming platform integration system 400 enables seamless incorporation of advanced compression techniques from the intelligent adaptive compression system 200 into existing streaming architectures. It utilizes a microservices architecture, custom content delivery network, and stream processing components to facilitate efficient content distribution and real-time data analysis. System 400 interacts with the adaptive 3D video processing system 600 to handle multiple 3D video formats and 2D to 3D transformation. It works with the device-specific adaptive content optimizer 800 to enhance content processing on devices with integrated AI chips. The system also interfaces with the dynamic content encryption and filtering engine 1000 for content protection and filtering. Additionally, it leverages the hierarchical model transmission optimizer 1400, cross-media GenAI codec enhancement suite 1800, continuous learning AI analysis engine 2000, and adaptive content monetization system 2200 to optimize various aspects of content delivery, compression, analysis, and monetization. These interactions enable system 400 to provide a comprehensive, efficient, and adaptive media processing and delivery experience across diverse network conditions and devices.

### Adaptive 3D Video Processing System Architecture

Adaptive 3D video processing system efficiently handles multiple 3D video formats, including Side-by-Side (SBS) and Frame-Sequential 3D, while also providing capability to transform 2D video into 3D. This system leverages AI-driven optimizations, specialized hardware components, and content-adaptive encoding techniques to process and compress 3D video content effectively. system may be extended to handle advanced immersive media formats, including virtual reality (VR) and augmented reality (AR) content, optimizing processing and delivery for these complex data types.

For SBS 3D video compression, adaptive 3D video processing system begins with initial frame processing using Tensor Processing Units (TPUs). These TPUs preprocess SBS 3D frames by identifying redundant data across left and right images. Pixel shift tracking, implemented through Redundancy Removal using Shift (R2S) method, is applied to eliminate redundancies. Field-Programmable Gate Arrays (FPGAs) are then utilized for context sequencing, ensuring left and right frames maintain temporal and spatial consistency. This synchronization is crucial for accurate content representation.

Compression and encoding of SBS 3D content is achieved through AI-driven models. These models learn common patterns between left and right frames, allowing for efficient encoding by focusing on differences and reusing shared information. Content-adaptive encoding is implemented to dynamically adjust bitrate and encoding parameters based on 3D scene complexity. This approach ensures high visual quality at lower bitrates, optimizing storage and transmission requirements.

For Frame-Sequential 3D video compression, adaptive 3D video processing system employs FPGAs to manage frame synchronization. These FPGAs control sequence and timing of left and right eye frames, ensuring proper order and display timing. AI models running on FPGAs detect and correct temporal inconsistencies, providing smooth viewing experience. Compression of Frame-Sequential 3D content utilizes AI-driven optimizations to predict differences between consecutive frames for each eye. This allows adaptive 3D video processing system to focus on encoding only variations, significantly reducing data size. Dynamic bitrate adjustment is implemented to adapt bitrate based on scene complexity and movement, ensuring high-quality output without unnecessary data overhead.

Adaptive 3D video processing system also incorporates capability to transform 2D video into 3D, which can be performed either on end devices or at intermediate points such as Content Delivery Networks (CDNs) or cloud resources. For on-device transformation, integrated AI chips in specialized phones perform real-time depth estimation and 3D reconstruction. These chips analyze 2D frames, estimate depth information, and generate corresponding 3D views for left and right eyes. Content-adaptive techniques are applied to dynamically adjust processing based on scene complexity, ensuring smooth and efficient 3D transformation.

When 2D to 3D transformation is performed at intermediate points, AI models deployed on cloud servers handle computationally intensive tasks. These models use deep learning techniques for depth estimation and 3D frame generation. CDNs equipped with specialized processing capabilities can preprocess 2D content into 3D before delivery to end users, reducing computational load on end devices and ensuring consistent 3D quality.

Detailed process for 2D to 3D transformation begins with depth estimation. Deep learning models trained on large datasets estimate depth map of each frame, understanding spatial relationships to predict depth accurately. AI algorithms detect edges and contours in 2D frames, aiding depth estimation by identifying foreground and background elements.

3D frame generation follows depth estimation. Using derived depth map, adaptive 3D video processing system generates two slightly different views (left and right) to create 3D effect. AI chips or cloud-based AI models render 3D frames, ensuring generated views are synchronized and provide natural 3D experience.

The final stage involves optimization and delivery of 3D content. Content-adaptive encoding techniques are applied to 3D frames, ensuring efficient compression and high-quality delivery. System continuously monitors network conditions, device capabilities, and user preferences to dynamically adjust 3D video quality and bitrate, optimizing viewing experience across various devices and network environments.

Throughout all processes, adaptive 3D video processing system utilizes specialized hardware components to enhance performance. The system can utilize a wide range of processing units, depending on the specific implementation and available resources. For example, the system may leverage hardware such as TPUs handle initial video frame generation and deep learning-based compression tasks. FPGAs manage context sequencing and ensure temporal and spatial consistency across frames. Digital Signal Processors (DSPs) are employed for audio processing, ensuring synchronization with video frames. Application-Specific Integrated Circuits (ASICs) perform specialized tasks such as final content integration, optimizing overall compression process.

By combining these advanced techniques and hardware components, adaptive 3D video processing system provides efficient and high-quality processing and compression of various 3D video formats, as well as capability to transform 2D content into immersive 3D experiences.

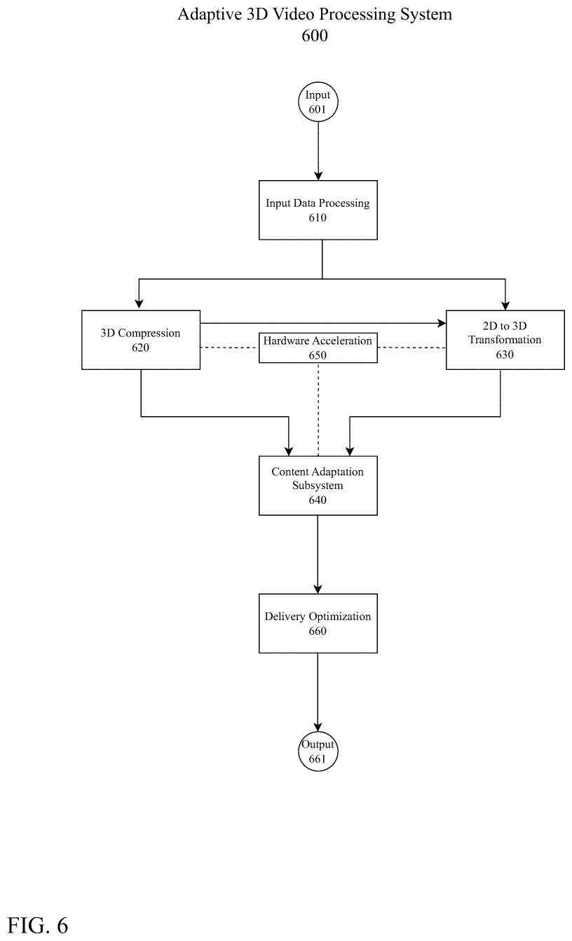

FIG. 6 is a block diagram illustrating exemplary architecture of adaptive 3D video processing system 600. Adaptive 3D video processing system 600 comprises several interconnected subsystems that work together to process, compress, and deliver 3D video content efficiently.

Input processing subsystem 610 serves as the entry point for various video formats. It includes a format detection component 611 that identifies the incoming video type. initial frame processing component 612 utilizes tensor processing units to preprocess the frames. For SBS 3D content, redundancy analysis component 613 employs a simplified frame analysis model to identify redundant data across left and right images. This model uses a lightweight convolutional neural network that takes an SBS 3D frame as input and outputs a low-resolution redundancy map. The network consists of convolutional layers followed by a global average pooling layer and a fully connected layer. This approach provides a balance between redundancy detection and computational efficiency, suitable for real-time processing.

3D compression subsystem 620 handles the compression of 3D content. For SBS 3D, it includes redundancy removal using shift component 621 that eliminates redundancies based on pixel shift tracking. context sequencing component 622 utilizes field-programmable gate arrays to ensure temporal and spatial consistency between left and right frames. AI-driven encoding component 623 employs a pattern learning model for efficient encoding of shared information and differences between left and right frames. This component uses a single-stream convolutional neural network that takes both left and right frames as input channels. The network learns a compact representation of the differences between the two frames, guiding the encoding process to focus on these areas. The model outputs encoding parameters for each macroblock, indicating whether to use shared or separate encoding.

2D to 3D transformation subsystem 630 is responsible for converting 2D content into 3D. It includes a depth estimation component 631 that uses a deep learning model trained on paired 2D images and corresponding depth maps to generate accurate depth information. An edge detection component 632 employs the canny edge detection algorithm for identifying edges and contours, aiding in depth estimation. This approach provides reliable edge information for the depth estimation process while maintaining computational efficiency.

Content adaptation and optimization subsystem 640 ensures efficient delivery of the processed content. It includes dynamic bitrate adjustment component 641 that adapts the bitrate based on scene complexity. content-adaptive encoding component 642 utilizes a decision tree-based model, for example random forest or gradient boosting machine. This model takes aggregated features from video segments as input and predicts optimal encoding parameters. This approach provides good performance with lower computational requirements and interpretability.

The hardware acceleration subsystem 650 manages the specialized hardware components. The system can utilize a wide range of processing units, depending on the specific implementation and available resources. In an embodiment, this includes a TPU management component 651 for coordinating deep learning tasks, an FPGA coordination component 652 for managing context sequencing and frame synchronization, a DSP allocation component 653 for audio processing, and an ASIC utilization component 654 for specialized tasks like final content integration. The invention is designed to be flexible and can adapt to a wide range of hardware environments, from general-purpose processors to various types of specialized computing units, based on availability and specific deployment requirements. This adaptability ensures that the system can be implemented effectively across diverse computing platforms while maintaining its core functionality and performance benefits.

Delivery optimization subsystem 660 ensures optimal content delivery across various devices and network conditions. adaptive optimization component 664 uses a combination of predefined rules and a neural network. The rules handle common scenarios based on network conditions and device capabilities, while the neural network fine-tunes decisions for more nuanced situations. This hybrid approach provides adaptability to various delivery scenarios while maintaining system efficiency.

These components work together to maintain the core functionality of the adaptive 3D video processing system 600, balancing computational efficiency with performance. This design makes the system suitable for real-time processing across a wide range of devices while facilitating maintenance and updates over time.

Data flows through the system as follows: Input video 601 is processed by input processing subsystem 610, then passed to either 3D compression subsystem 620 or 2D to 3D transformation subsystem 630, depending on the input format. The processed and compressed content then moves through content adaptation and optimization subsystem 640, utilizing hardware acceleration subsystem 650 as needed. Finally, delivery optimization subsystem 660 manages the delivery of the content to the end-user 661.

The adaptive 3D video processing system 600 is designed with a high degree of modularity and flexibility, allowing for efficient adaptation to various use cases and deployment scenarios. Each subsystem (610, 620, 630, 640, 660) operates as a distinct module, enabling selective activation based on specific processing requirements. For instance, in scenarios where only 3D content is processed, the 2D to 3D transformation subsystem 630 can remain inactive, streamlining operations. Similarly, the system's hardware acceleration components can be selectively utilized or substituted with software-based alternatives depending on the available resources and performance requirements. This modular approach extends to the AI models employed throughout the system, which can be individually updated, replaced, or fine-tuned without necessitating changes to the entire system architecture. Furthermore, the system's flexibility allows for scalability across different deployment environments, from edge devices with limited resources to powerful cloud infrastructures. In resource-constrained scenarios, lighter versions of AI models can be employed, or certain processing steps can be offloaded to cloud services when available. This adaptability ensures that the system can be optimized for various performance, cost, and efficiency trade-offs, making it suitable for a wide range of applications from consumer devices to professional broadcast environments. The hardware acceleration component may be designed to incorporate quantum computing techniques for advanced content analysis and compression, potentially achieving unprecedented levels of processing efficiency for complex media tasks.

Throughout system 600, AI models are continuously refined using federated learning techniques, allowing them to adapt to new content types and delivery scenarios while maintaining user privacy. This adaptive 3D video processing system 600 provides an efficient and flexible solution for handling various 3D video formats and delivering high-quality content across diverse viewing conditions.

In a non-limiting example of an embodiment of system 600, a user accesses a streaming platform on their smartphone, which supports 3D display capabilities. The user selects a movie that is available in both 2D and 3D formats. The adaptive 3D video processing system 600 activates to manage the content delivery. Initially, the input processing subsystem 610 receives the video stream. The format detection component 611 identifies that the source content is in 2D format. This information is passed to the 2D to 3D transformation subsystem 630. Within subsystem 630, the depth estimation component 631 analyzes the 2D frames to generate depth maps. The edge detection component 632 identifies object boundaries to refine the depth estimation. These processes work together to create a 3D representation of the originally 2D content. The newly generated 3D content then moves to the 3D compression subsystem 620. Here, the redundancy removal component 621 identifies and eliminates duplicate information between the left and right eye views. The context sequencing component 622 ensures proper alignment of the 3D frames. AI-driven encoding component 623 then compresses the 3D content, optimizing for both quality and bandwidth efficiency. Throughout these processes, the hardware acceleration subsystem 650 is actively engaged, with TPUs handling the complex depth estimation calculations, FPGAs managing the real-time frame synchronization for 3D content, and ASICs accelerating the encoding and compression tasks, ensuring efficient processing despite the varying demands of different viewing scenarios and network conditions. As the movie streams to the user's device, the content adaptation and optimization subsystem 640 continuously monitors playback conditions. The dynamic bitrate adjustment component 641 detects that the user has moved from a Wi-Fi connection to a cellular network with lower bandwidth. In response, it signals the content-adaptive encoding component 642 to adjust the encoding parameters, reducing the bitrate while maintaining the best possible 3D quality for the available bandwidth. Throughout the streaming session, the delivery optimization subsystem 660 works to ensure smooth playback. The adaptive optimization component 664 considers factors such as the user's device capabilities, current network conditions, and historical performance data. It dynamically adjusts buffering strategies and quality levels to prevent interruptions and maintain the best possible viewing experience. When the user later switches to viewing the same content on a large-screen 3D TV, the system 600 adapts again. It detects the change in display capabilities and available bandwidth. The 3D compression subsystem 620 adjusts to deliver higher quality 3D content suitable for the larger display, while the delivery optimization subsystem 660 modifies its strategies to take advantage of the more stable home network connection. This use case demonstrates how the adaptive 3D video processing system 600 flexibly handles different input formats, transforms content as needed, and continuously optimizes delivery based on changing conditions, all while maintaining a seamless experience for the user.

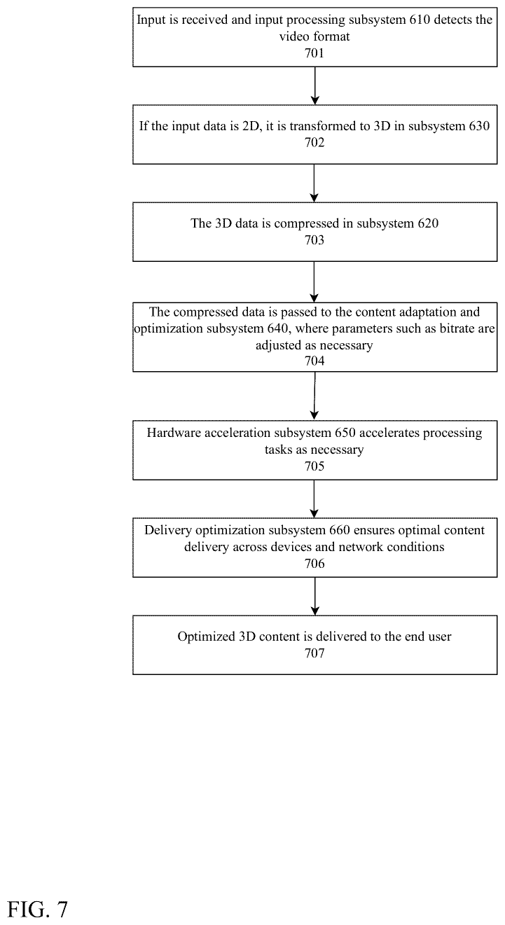

FIG. 7 is a method diagram illustrating the use of adaptive 3D video processing system 600. The process begins when the input processing subsystem 610 receives and analyzes the input video, detecting its format and performing initial frame processing 701. If the input is 2D, the 2D to 3D transformation subsystem 630 converts it to 3D format using depth estimation and edge detection techniques 702. The 3D compression subsystem 620 then compresses the 3D content, removing redundancies, ensuring frame consistency, and applying AI-driven encoding to optimize for both quality and bandwidth efficiency 703. Next, the content adaptation and optimization subsystem 640 further refines the content, dynamically adjusting bitrate and encoding parameters based on scene complexity and network conditions 704. The hardware acceleration subsystem 650 manages specialized hardware components like TPUs, FPGAs, DSPs, and ASICs to accelerate processing tasks throughout the pipeline 705. The delivery optimization subsystem 660 then ensures optimal content delivery across various devices and network conditions, using adaptive optimization techniques 706. Finally, the system delivers optimized 3D content to the end-user, providing a high-quality, efficient 3D viewing experience 707.

### Device-Specific Adaptive Content Optimizer

Device-specific adaptive content optimizer is a system designed to enhance content processing and delivery on specialized phones equipped with integrated AI chips. This system employs content-specific, genre-specific, and quality-specific processing approaches to optimize performance, quality, and resource usage based on various factors including content type, network conditions, and device state. The system may leverage edge computing technologies to optimize content processing and delivery, reducing latency and improving performance by bringing computational resources closer to the end-user.

At the core of device-specific adaptive content optimizer system is content-specific processing capability. This feature adapts processing techniques to different types of content such as video, audio, and images. AI chips integrated into devices dynamically adjust processing pipeline for each content type. For instance, when processing video content, AI chips may prioritize frame rate and motion smoothness, while for audio content, it may focus on frequency response and noise reduction. This dynamic adjustment ensures optimal resource utilization and enhanced user experience tailored to specific content requirements.

Genre-specific processing is another key component of device-specific adaptive content optimizer system. It recognizes that different genres of content, such as action movies, documentaries, or music videos, have unique characteristics and requirements. AI chips are programmed to recognize the genre of content being processed and apply specific compression and enhancement algorithms accordingly. For example, when processing an action movie, AI chip may prioritize preserving fast motion and high contrast scenes, while for a documentary, it may focus on maintaining detail in static scenes and enhancing clarity of spoken dialogue.

Quality-specific processing allows content to be processed at various quality levels, ranging from standard definition to ultra-high definition. AI chips in device-specific adaptive content optimizer system assess device's current state, including battery life, storage availability, and network conditions, to determine appropriate quality level for content processing. This scalability ensures that the device can deliver optimal viewing experience while managing system resources efficiently.

Adaptive fidelity based on network conditions is a crucial feature of device-specific adaptive content optimizer system. AI chips continuously monitor network quality, including bandwidth, latency, and packet loss rates. Based on these real-time measurements, device-specific adaptive content optimizer system dynamically adjusts fidelity of data being transmitted and received. For instance, if network conditions degrade, device-specific adaptive content optimizer system may reduce video resolution or audio bitrate to maintain smooth playback and prevent buffering.

To handle drop rates and latency issues, device-specific adaptive content optimizer system employs AI-driven error correction and predictive algorithms. These algorithms can mitigate impact of packet loss and high latency by anticipating and compensating for network irregularities. Additionally, device-specific adaptive content optimizer system implements adaptive bitrate streaming techniques, allowing it to adjust quality of video and audio streams in real-time to match network performance. This approach significantly reduces buffering and interruptions, ensuring a smooth user experience even in challenging network environments.

Battery and storage management are integral components of device-specific adaptive content optimizer system. AI chips are programmed to manage processing tasks in a way that balances performance and power consumption. During content playback or other intensive tasks, device-specific adaptive content optimizer system may dynamically adjust clock speeds, core usage, and background processes to extend battery life without significantly impacting user experience. For storage efficiency, AI algorithms compress and decompress data on the fly, optimizing storage use without compromising content quality.

In practical implementation, device-specific adaptive content optimizer system operates as follows: When user initiates streaming of high-definition movie on device with integrated AI chip, system immediately begins monitoring network conditions. AI chip analyzes current network state and predicts potential disruptions based on historical data and machine learning models. If network quality degrades, device-specific adaptive content optimizer system promptly reduces stream's bitrate and resolution to prevent buffering. Concurrently, AI chip optimizes power usage by adjusting processor performance and screen brightness, balancing performance requirements with the need to extend battery life for duration of movie. If device's storage space is low, system dynamically manages downloaded content, potentially offloading less critical data to cloud storage to ensure sufficient space for high-priority content.

Through this comprehensive approach to content optimization, device-specific adaptive content optimizer enables devices to deliver high-quality, uninterrupted content experiences while efficiently managing device resources and adapting to varying network conditions.

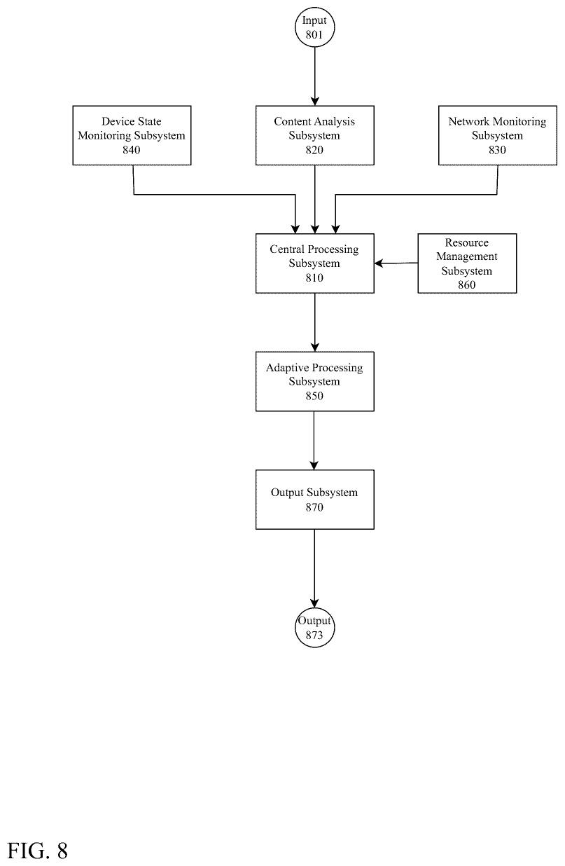

FIG. 8 is a block diagram illustrating exemplary architecture of device specific adaptive content optimizer 800. System 800 comprises several interconnected subsystems designed to optimize content delivery and processing on devices with integrated AI chips.

At the core of system 800 is central processing subsystem 810, which coordinates the activities of other subsystems and manages the overall optimization process. This subsystem uses a rule-based decision engine to determine the optimal processing strategy based on inputs from other subsystems.

Connected to central processing subsystem 810 is content analysis subsystem 820. This subsystem is responsible for analyzing incoming content 801 and determining its type, genre, and quality requirements. Content analysis subsystem 820 includes content type classifier 821, which uses machine learning algorithms to categorize content as video, audio, or image based on file headers and data patterns. Genre recognition engine 822 employs natural language processing techniques to analyze metadata and content features for genre classification. Quality assessment tool 823 evaluates content resolution, bitrate, and encoding parameters to determine quality level. As an example, in an embodiment when a user starts streaming a 4K action movie, the content type classifier 821 identifies it as video content, the genre recognition engine 822 categorizes it as an action movie, and the quality assessment tool 823 recognizes it as high-definition content.

Network monitoring subsystem 830 continuously assesses network conditions and provides this information to central processing subsystem 810. It includes bandwidth monitor 831 that uses packet timing analysis to estimate available bandwidth, latency detector 832 that measures round-trip time of small probe packets, and packet loss analyzer 833 that tracks the rate of lost or corrupted packets. As an example, in an embodiment when the network monitoring subsystem 830 detects that available bandwidth has dropped from 20 Mbps to 5 Mbps, it immediately reports this to the central processing subsystem 810.

Device state monitoring subsystem 840 tracks the device's current conditions. It comprises battery monitor 841 that estimates remaining battery life based on current charge and usage patterns, storage analyzer 842 that tracks available storage space and read/write speeds, and performance tracker 843 that monitors CPU and GPU utilization. As an example, in an embodiment battery monitor 841 detects that the device's battery level has dropped below 20%, it alerts the central processing subsystem 810.

Adaptive processing subsystem 850 receives instructions from central processing subsystem 810 and applies appropriate processing techniques. It includes video processing engine 851 capable of real-time transcoding and resolution adjustment, audio processing engine 852 that can dynamically adjust audio bitrates and apply compression algorithms and image processing engine 853 that can resize and compress images on the fly. As an example, in an embodiment, based on the reduced bandwidth and low battery level video processing engine 851 reduces the streaming quality from 4K to 1080p and lowers the frame rate from 60 fps to 30 fps.

Resource management subsystem 860 optimizes the use of device resources. It includes power management component 861 that can adjust CPU clock speeds and core usage, storage optimization component 862 that uses adaptive compression algorithms to balance storage usage and access speed, and processing allocation component 863 that prioritizes tasks based on user activity and system requirements. As an example, in an embodiment, to conserve battery, the power management component 861 reduces the CPU clock speed and limits background processes. Resource management subsystem 860 continuously reports the status of device resources to central processing subsystem 810, enabling real-time adjustments to the overall optimization strategy based on current resource availability and usage patterns.

Output subsystem 870 is responsible for delivering the optimized content 873 to the device's display and audio systems. It includes display interface 871 that manages screen refresh rates and color depth, and an audio output interface 872 that handles audio routing and equalization. As an example, in an embodiment display interface 871 adjusts the screen brightness to further conserve battery life, while the audio output interface 872 ensures the audio remains synchronized with the lower frame rate video.

In operation, when content is received by system 800, it first passes through content analysis subsystem 820, which determines the content type, genre, and quality requirements. This information is sent to the central processing subsystem 810. Simultaneously, network monitoring subsystem 830 provides current network conditions, and device state monitoring subsystem 840 reports on the device's current state. Central processing subsystem 810 uses this information to determine the optimal processing strategy. It then instructs adaptive processing subsystem 850 on how to process the content. Adaptive processing subsystem 850 applies the appropriate processing techniques, which may include adjusting video resolution, modifying audio bitrates, or compressing images. Throughout this process, resource management subsystem 860 ensures that device resources are used efficiently. It may adjust processor clock speeds, manage power consumption, or optimize storage usage based on the current task and device state. Finally, the processed and optimized content is sent to output subsystem 870 for presentation to the user. This entire process occurs in real-time, with the system continuously adapting to changes in content, network conditions, and device state to provide the best possible user experience.

In a use case example of an embodiment of device-specific adaptive content optimizer 800, a user is watching a high-definition streaming video on their smartphone while commuting on a train. As the video begins, content analysis subsystem 820 processes the incoming stream. Content type classifier 821 identifies it as 4K video content, while genre recognition engine 822 categorizes it as an action movie. Quality assessment tool 823 recognizes its high-definition quality level. Simultaneously, network monitoring subsystem 830 begins assessing the network conditions. As the train moves through areas with varying signal strength, bandwidth monitor 831 detects fluctuating available bandwidth, immediately reporting these changes to central processing subsystem 810. Meanwhile, device state monitoring subsystem 840 is actively monitoring the smartphone's status. Battery monitor 841 notes that the device's remaining charge is at 30%, while storage analyzer 842 reports limited available storage space. Performance tracker 843 keeps tabs on the CPU and GPU utilization as the video plays.

Central processing subsystem 810 takes in all this information and, using its rule-based decision engine, determines the optimal processing strategy. It then instructs adaptive processing subsystem 850 on how to handle the content. Based on the fluctuating network conditions and low battery level, video processing engine 851 dynamically adjusts the video quality, switching between 1080p and 720p as needed, and reduces the frame rate from 60 fps to 30 fps. Audio processing engine 852 applies more aggressive compression algorithms to the audio stream to further reduce data usage.

Throughout this process, resource management subsystem 860 works to optimize the use of device resources. Power management component 861 lowers the CPU clock speed to conserve battery life, while storage optimization component 862 implements adaptive compression algorithms for temporary content caching, balancing storage usage and access speed. Processing allocation component 863 ensures that the video playback task is prioritized over less critical background processes.

Output subsystem 870 manages the presentation of the optimized content. Display interface 871 adjusts the screen brightness to further conserve battery life, while audio output interface 872 ensures that the audio remains perfectly synchronized with the lower frame rate video.

As the train journey continues, system 800 continuously adapts to changing conditions. When the train enters an area with better network coverage, bandwidth monitor 831 detects the improved conditions, and the system adjusts the video quality accordingly. If the battery level drops further, more aggressive power-saving measures are applied by power management component 861. This continuous adaptation ensures that the user enjoys the best possible viewing experience throughout their commute, balancing content quality with the constraints of network conditions, battery life, and device capabilities.

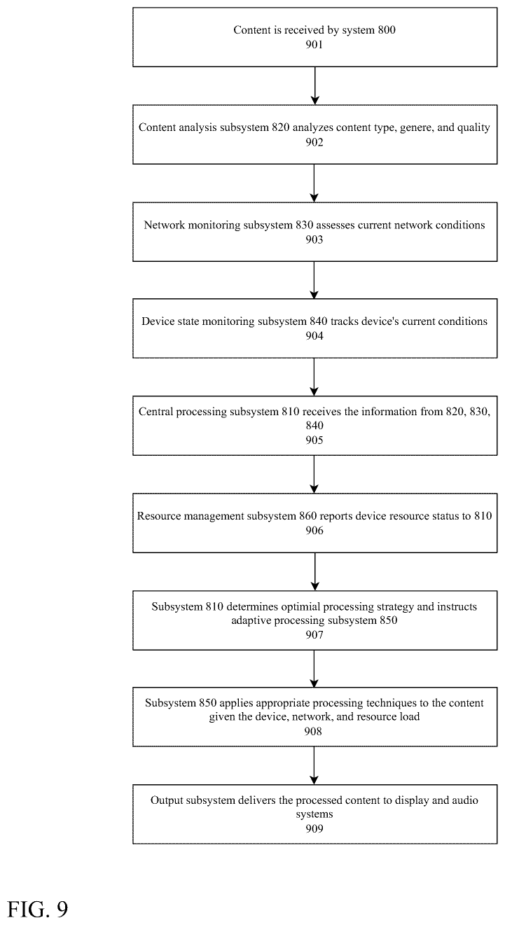

FIG. 9 is a method diagram illustrating the use of device-specific adaptive content optimizer 800. The process begins when content is received by system 800 901. Content analysis subsystem 820 then analyzes the content type, genre, and quality requirements 902. Simultaneously, network monitoring subsystem 830 assesses current network conditions 903, while device state monitoring subsystem 840 tracks the device's current conditions, including battery life, storage space, and processing utilization 904. Central processing subsystem 810 receives this comprehensive information from subsystems 820, 830, and 840 905. Resource management subsystem 860 reports the status of device resources to central processing subsystem 810, providing crucial data on resource availability and usage patterns 906. Using this wealth of information, central processing subsystem 810 determines the optimal processing strategy and instructs adaptive processing subsystem 850 accordingly 907. Adaptive processing subsystem 850 then applies the appropriate processing techniques, which may include adjusting video resolution, modifying audio bitrates, or compressing images 908. Finally, output subsystem 870 delivers the processed and optimized content to the device's display and audio systems 909. Throughout this entire process, system 800 continuously adapts to changes in content, network conditions, and device state, ensuring the best possible user experience in real-time.

### Dynamic Content Encryption and Filtering Engine

Dynamic content encryption and filtering engine is a sophisticated system that applies encryption algorithms and content filtering techniques to digital media streams. This engine can encrypt all, some, or none of data in a signal for various purposes, ranging from intellectual property protection to access control based on user credentials or preferences.

At the core of dynamic content encryption and filtering engine is an AI-powered codec capable of selectively applying encryption to different parts of data stream. This codec analyzes content in real-time, identifying segments that require encryption based on predefined rules or dynamic conditions. Encryption can be applied at various levels, from full stream encryption to selective encryption of specific frames, audio segments, or even individual objects within video frames.

For implementation of partial encryption, dynamic content encryption and filtering engine employs a content segmentation subsystem that divides incoming data stream into discrete units. These units can be video frames, audio segments, or data packets. Each unit is then analyzed by AI algorithm to determine its sensitivity level or classification. Based on this analysis, an appropriate encryption algorithm is applied to units requiring protection.

Dynamic content encryption and filtering engine supports multiple encryption algorithms, including symmetric key algorithms like AES (Advanced Encryption Standard) and asymmetric key algorithms like RSA. Selection of encryption algorithm is based on security requirements, computational resources available, and real-time performance needs. For scenarios requiring the highest level of security, such as government applications dealing with classified information, engine can implement multi-layer encryption, where different parts of content are encrypted using different algorithms or keys. Key management system is an integral part of the encryption process. It generates, distributes, and manages encryption keys securely. For applications involving multiple security levels, key management systems implement hierarchical key structure, where higher-level keys can decrypt a broader range of content.

Content filtering functionality of dynamic content encryption and filtering engine is designed to dynamically modify or restrict access to certain parts of content based on user credentials or viewing context. This is achieved through real-time content analysis subsystem that identifies and tags content elements based on predefined categories such as violence, language, or age-appropriateness. It may incorporate blockchain technology for secure content distribution and rights management, ensuring transparent and immutable tracking of content usage and ownership.

For government applications, dynamic content encryption and filtering engines integrate with existing identity verification systems to authenticate user credentials such as security clearances. It can then filter content in real-time, ensuring that each viewer only accesses information they are cleared to see. In scenario where multiple viewers with different clearance levels are present, engine calculates highest common denominator of access rights and filters content accordingly.

In commercial applications, dynamic content encryption and filtering engine can interface with various user identification systems, including facial recognition technology in smart TVs, to determine viewer demographics. Based on this information, it can automatically apply age-appropriate content filtering. For instance, when dynamic content encryption and filtering engine detects presence of minors, it can automatically filter out inappropriate language, replacing it with dubbed audio or applying audio bleeping effect.

Dynamic content encryption and filtering engine also supports granular content access based on subscription levels. It can encrypt different quality levels of the same content (e.g., standard definition vs. ultra-high definition) and only decrypt appropriate versions based on user's subscription tier. This allows for flexible pricing models and efficient use of bandwidth.

To enable dynamic content modification, dynamic content encryption and filtering engine incorporates AI-driven content understanding subsystem. This subsystem can recognize context and meaning of content, allowing for intelligent modifications. For example, it can identify specific words or phrases for audio dubbing or recognize and blur specific objects or actions in video stream.

Performance optimization is a crucial aspect of dynamic content encryption and filtering engine design. It employs parallel processing techniques to handle encryption and filtering operations simultaneously, minimizing latency. Hardware acceleration, leveraging specialized chips like TPUs or FPGAs, is used for computationally intensive tasks such as real-time video analysis and encryption.

Dynamic content encryption and filtering engine also includes adaptive bitrate subsystem that works in conjunction with encryption and filtering processes. This ensures that any modifications to content do not adversely affect streaming performance, dynamically adjusting quality and bitrate to maintain smooth playback under varying network conditions.

Logging and auditing functionality is built into dynamic content encryption and filtering engine to maintain records of all encryption and filtering actions. This is particularly important for compliance with regulatory requirements in both government and commercial sectors.

Through combination of these components and techniques, dynamic content encryption and filtering engine provides flexible, secure, and efficient solution for managing access to digital content across various applications and use cases.

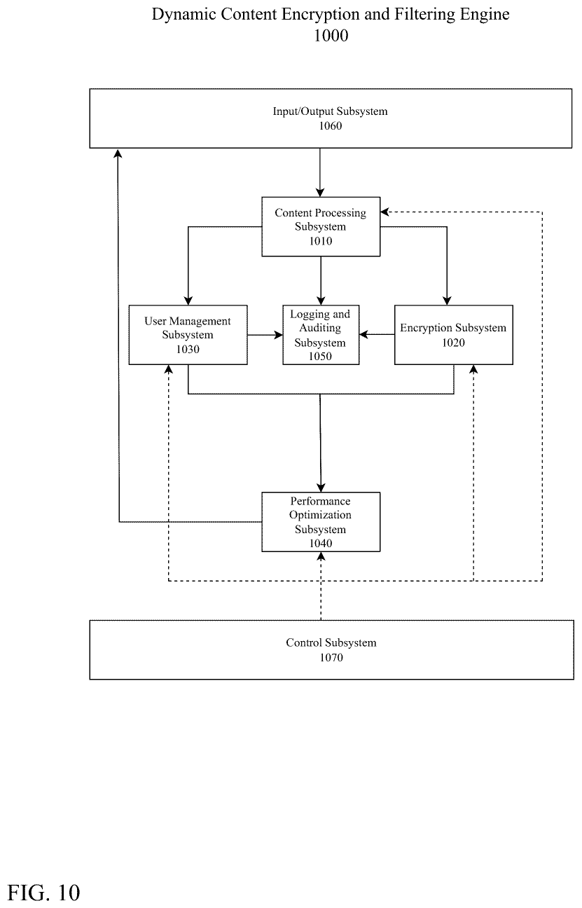

FIG. 10 is a block diagram illustrating exemplary architecture of dynamic content encryption and filtering engine 1000. Engine 1000 comprises several interconnected subsystems that work together to process, encrypt, and filter digital content streams.

At the core of engine 1000 is content processing subsystem 1010. Content processing subsystem 1010 includes AI-powered codec 1011, which analyzes incoming content streams in real-time. Codec 1011 utilizes a convolutional neural network (CNN) architecture, enabling efficient processing of both visual and audio data. This CNN-based model is trained on a diverse dataset of digital content, encompassing various categories and sensitivity levels. The training process involves supervised learning techniques, allowing codec 1011 to identify patterns and features associated with different content types and sensitivity levels.

Codec 1011 interfaces with content segmentation component 1012, which divides incoming data streams into discrete units such as video frames, audio segments, or data packets. This segmentation process facilitates granular analysis and processing of content. These components work in conjunction with real-time content analysis component 1013, which identifies and tags content elements based on predefined categories. Component 1013 leverages the trained CNN model to classify content and identify regions of interest that may require encryption or filtering.

AI-driven content understanding component 1014 is designed to recognize the context and meaning of content, enabling intelligent modifications. This component uses machine learning algorithms to process and analyze the content that has been segmented and initially classified by the earlier components in the subsystem. Component 1014 is trained on a diverse dataset of digital content, allowing it to understand various types of media including text, audio, and visual data. It uses this training to identify important elements within the content, such as specific topics, sentiment, or sensitive information. The primary functions of component 1014 include contextual analysis, semantic understanding, and relation identification. Through contextual analysis, it understands the overall context of the content beyond simple keyword matching. Its semantic understanding capabilities allow it to grasp the meaning and implications of the content. Additionally, it recognizes relationships between different elements within the content. Component 1014 works in conjunction with the other elements of subsystem 1010, taking input from codec 1011 and content analysis component 1013, and providing more in-depth analysis to guide encryption and filtering decisions. To maintain its effectiveness, component 1014 is periodically updated with new training data to keep pace with evolving content patterns and sensitivity criteria.

The integration of these AI-powered components within subsystem 1010 allows for sophisticated, real-time analysis of content streams, providing crucial information to guide the encryption and filtering processes in other subsystems of engine 1000.

Encryption subsystem 1020 is responsible for applying various encryption algorithms to content as determined by content processing subsystem 1010. Encryption subsystem 1020 includes encryption algorithm library 1021, which supports multiple encryption methods including symmetric key algorithms such as, for example, AES and asymmetric key algorithms such as, for example, RSA. Key management component 1022 generates, distributes, and securely manages encryption keys, implementing hierarchical key structures for applications with multiple security levels.

User management subsystem 1030 handles user authentication and access control. It comprises user authentication component 1031, which integrates with external identity verification systems, and access control component 1032, which determines content accessibility based on user credentials or viewing context.

Performance optimization subsystem 1040 ensures efficient operation of engine 1000. It includes parallel processing component 1041 for handling multiple operations simultaneously, hardware acceleration interface 1042 for leveraging specialized chips like TPUs or FPGAs, and adaptive bitrate component 1043 for maintaining smooth playback under varying network conditions.

Logging and auditing subsystem 1050 maintains records of all encryption and filtering actions performed by engine 1000. It consists of logging component 1051 for recording system activities and auditing component 1052 for ensuring compliance with regulatory requirements.

Input/output subsystem 1060 manages data flow in and out of engine 1000. It includes input interface 1061 for receiving content streams and user data, and output interface 1062 for delivering processed, encrypted, and filtered content.

Control subsystem 1070 oversees overall operation of engine 1000. It includes central processing unit 1071 for coordinating activities of all subsystems, memory 1072 for storing temporary data and system states, and system configuration interface 1073 for adjusting engine parameters.

In operation, incoming content enters engine 1000 through input interface 1061. Content processing subsystem 1010 analyzes and segments the content, determining which portions require encryption or filtering. This information is passed to encryption subsystem 1020, which applies appropriate encryption algorithms based on instructions from content processing subsystem 1010 and user management subsystem 1030. Performance optimization subsystem 1040 ensures these processes occur efficiently and without interruption. Processed and encrypted content is then output through output interface 1062. Throughout this process, logging and auditing subsystem 1050 records all significant actions for later review or compliance checks. Control subsystem 1070 coordinates these activities, ensuring smooth operation of engine 1000.

In a use case example of an embodiment of dynamic content encryption and filtering engine 1000, the system is deployed in a multi-user digital content distribution platform. The platform streams various types of content, including videos, audio, and text, to users with different access levels and age restrictions. As a content creator uploads a new video to the platform, the video stream enters engine 1000 through input interface 1061 of input/output subsystem 1060. Content processing subsystem 1010 immediately begins analyzing the incoming stream. AI-powered codec 1011 processes the video frames and audio track in real-time, while content segmentation component 1012 divides the stream into manageable segments. Real-time content analysis component 1013 then identifies and tags elements within the content. For instance, it might detect scenes containing mature themes, recognize specific objects or individuals, or identify topics being discussed. AI-driven content understanding component 1014 provides a deeper analysis, understanding the context and relationships between different elements in the video. Based on this analysis, encryption subsystem 1020 determines which portions of the content require encryption. For example, scenes containing sensitive information might be encrypted using a more robust algorithm from encryption algorithm library 1021, while less sensitive portions use a lighter encryption method to optimize performance.

As users attempt to access the content, user management subsystem 1030 authenticates their credentials through user authentication component 1031. Access control component 1032 then determines which parts of the content each user can view based on their access level and age. When a user starts streaming the video, performance optimization subsystem 1040 ensures smooth playback. Parallel processing component 1041 handles multiple user requests simultaneously, while adaptive bitrate component 1043 adjusts the stream quality based on the user's network conditions.

Throughout this process, logging and auditing subsystem 1050 maintains records of all actions, including content analysis results, encryption decisions, and user access patterns. These logs can be used for compliance checks or to improve the system's performance over time. Control subsystem 1070 oversees the entire operation, coordinating between subsystems to ensure the content is properly processed, encrypted, and delivered to users according to their access rights. This use case demonstrates how engine 1000 provides secure, personalized content delivery while efficiently managing resources and maintaining detailed records for auditing purposes.

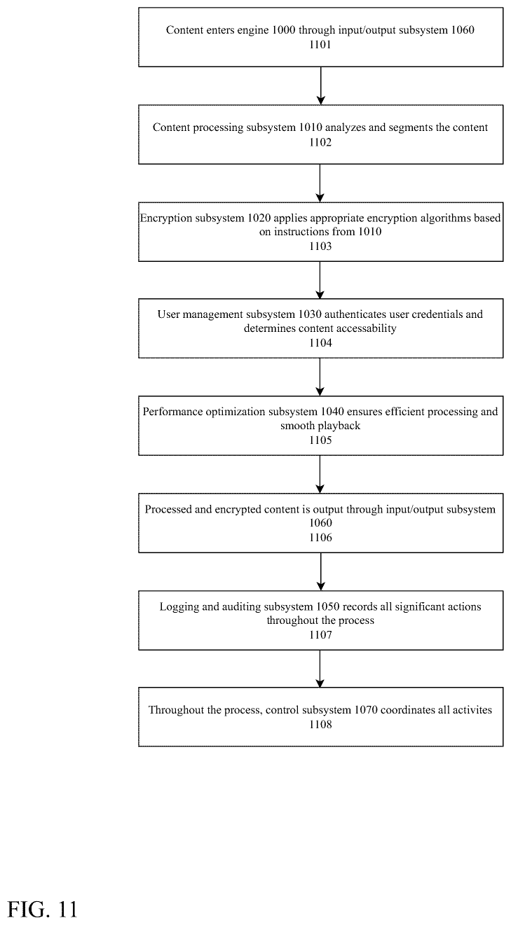

FIG. 11 is a method diagram illustrating the use of dynamic content encryption and filtering engine 1000. The process begins as content enters engine 1000 through the input interface 1061 of the input/output subsystem 1060 1101. Once received, the content processing subsystem 1010 analyzes and segments the incoming data, determining which portions require encryption or filtering based on its characteristics and sensitivity 1102. Following this analysis, the encryption subsystem 1020 applies appropriate encryption algorithms to the designated content sections, guided by the instructions from the content processing subsystem 1010 1103. Concurrently, the user management subsystem 1030 authenticates user credentials and determines content accessibility, ensuring that users only access content appropriate to their authorization level 1104. To maintain optimal performance, performance optimization subsystem 1040 works to ensure efficient processing and smooth playback, adjusting parameters as needed based on system load and network conditions 1105. Once processed and encrypted, the content is output through the output interface 1062, ready for secure delivery to the end-user 1106. Throughout this entire process, the logging and auditing subsystem 1050 diligently records all significant actions, maintaining a comprehensive audit trail for security and compliance purposes 1107. Overseeing all these operations, control subsystem 1070 coordinates the activities of all other subsystems, ensuring the smooth and efficient operation of engine 1000 from input to output 1108.

The dynamic content encryption and filtering engine 1000 interacts with several other key components of adaptive intelligent multi-modal media processing and delivery system to ensure secure and personalized content delivery. It works in conjunction with the intelligent adaptive compression system 200 to apply encryption and filtering to the compressed content, ensuring that the optimized data remains secure throughout the delivery process. System 1000 interfaces with the streaming platform integration system 400 to implement content protection and filtering within existing streaming architectures, enabling features such as age-appropriate content delivery and region-specific restrictions. It also cooperates with the device-specific adaptive content optimizer 800 to ensure that encryption and filtering are optimized for various device capabilities and network conditions. The continuous learning AI analysis engine 2000 provides feedback to system 1000, allowing it to refine its encryption and filtering strategies based on evolving content patterns and user behaviors. Additionally, system 1000 works alongside the adaptive content monetization system 2200 to enable granular access control that aligns with different subscription tiers and personalized content packages. Through these interactions, system 1000 enhances the overall system's ability to deliver secure, personalized, and compliant content across diverse platforms and user scenarios.

### Information Theory Enhanced Compression System

Information theory enhanced compression system is an advanced framework that leverages principles from information theory to optimize compression efficiency for multimedia data, particularly video and audio content. This system incorporates semantic compression techniques, Bayesian network modeling, and network pruning strategies to achieve high compression ratios while maintaining content quality and relevance.

At the core of information theory enhanced compression system is semantic compression subsystem, which focuses on transmitting task-relevant information while removing redundancies. This subsystem employs deep learning algorithms to analyze content and identify semantically significant elements. For video data, convolutional neural networks (CNNs) are used to detect and classify objects, scenes, and actions within frames. Recurrent neural networks (RNNs) process temporal information to understand context and relationships between frames. In audio processing, spectral analysis and speech recognition models identify important audio features and speech content.

Bayesian network (BN) model is implemented to represent joint probabilistic distribution of semantic elements identified in content. This BN is constructed dynamically for each input, with nodes representing semantic concepts and edges encoding dependencies between them. Structure learning algorithms, such as score-based or constraint-based methods, are employed to infer optimal network structure from data. Parameters of BN are estimated using maximum likelihood estimation or Bayesian inference techniques.

BN model serves dual purpose in compression process. Firstly, it helps identify information-theoretic limits on lossless and lossy compression of semantic sources. By analyzing conditional dependencies encoded in BN, information theory enhanced compression system can determine minimum number of bits required to represent semantic content without loss of critical information. Secondly, BN guides compression process by prioritizing transmission of high-probability semantic elements and their relationships.

Rate-distortion optimization subsystem is integrated to determine optimal compression rates while maintaining desired quality levels. This subsystem implements rate-distortion theory, calculating the trade-off between compression rate and distortion of reconstructed content. For video compression, rate-distortion optimization considers factors such as motion estimation accuracy, quantization parameters, and frame type selection. In audio compression, it balances factors like spectral resolution and temporal precision.

Information theory enhanced compression system incorporates Information Bottleneck (IB) theory to minimize information between layer activations and input while preserving output-relevant information. This is particularly useful in optimizing neural network architectures used for content analysis and compression. IB principle is implemented through variational approximation, where auxiliary distribution is introduced to model compressed representation of input. Optimization process involves maximizing mutual information between compressed representation and desired output while minimizing mutual information with input.

Hilbert-Schmidt Independence Criterion (HSIC) is employed to measure layer-wise importance and redundancy in neural networks used throughout compression pipeline. HSIC provides a non-parametric measure of dependence between two random variables, which is used to quantify the importance of each layer in network. Implementation involves computing HSIC between layer activations and network output, as well as between activations of different layers.

Network pruning subsystem utilizes HSIC-based strategy to optimize architecture of neural networks used in video and audio processing stages. This subsystem iteratively evaluates the importance of each layer using HSIC and removes layers or neurons that contribute least to overall performance. The pruning process is guided by predefined performance thresholds to ensure that compression efficiency is not compromised.

In video processing pipeline, information theory enhanced compression system applies these techniques at multiple stages. During initial frame analysis, semantic compression and BN modeling identify key visual elements and their relationships. Rate-distortion optimization guides selection of macroblock types, motion vectors, and quantization parameters. IB theory and HSIC-based pruning are applied to CNNs and RNNs used for feature extraction and temporal analysis, reducing computational complexity while retaining important features.

For audio compression, information theory enhanced compression system employs similar principles, adapting them to characteristics of audio signals. Semantic analysis identifies important audio events, speech content, and musical elements. BN modeling captures temporal and frequency dependencies in audio stream. Rate-distortion optimization balances factors like frequency resolution and temporal precision. IB theory and HSIC-based pruning optimize spectral analysis and feature extraction networks.

Adaptive quantization subsystem is implemented to adjust quantization parameters based on semantic importance of different content regions. This subsystem uses information from BN model and semantic analysis to allocate more bits to semantically rich areas while applying stronger compression to less important regions.

Information theory enhanced compression system also includes feedback loop that continuously evaluates compression performance and adjusts parameters of various subsystem. This adaptive mechanism ensures that compression strategy remains optimal as content characteristics change over time.

By integrating these information theory-based techniques, information theory enhanced compression system achieves highly efficient compression of multimedia content, optimizing both compression ratio and computational resources required for processing. This approach ensures that compressed content retains semantic richness and task-relevant information while minimizing data size and processing overhead.

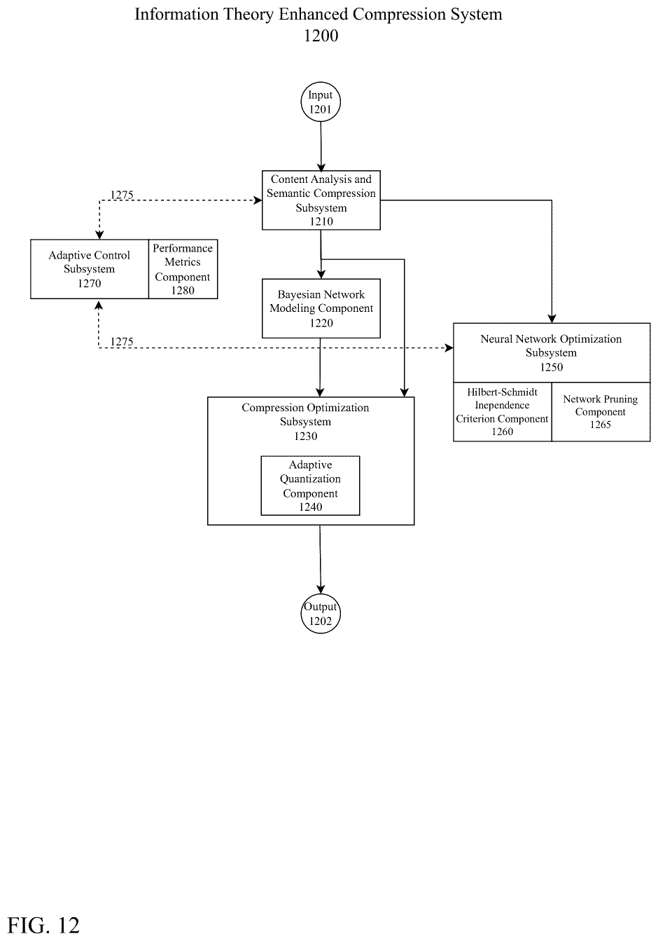

FIG. 12 is a block diagram illustrating exemplary architecture of information theory enhanced compression system 1200. System 1200 comprises several interconnected subsystems designed to optimize compression of multimedia data, particularly video and audio content. At the core of system 1200 is content analysis and semantic compression subsystem 1210. Subsystem 1210 includes semantic analysis component 1215 and Bayesian network modeling component 1220. Semantic analysis component 1215 employs deep learning algorithms, for example convolutional neural networks (CNNs) and recurrent neural networks (RNNs), to analyze input multimedia data 1201. For video data, CNNs detect and classify objects, scenes, and actions within frames, while RNNs process temporal information to understand context and relationships between frames. In audio processing, spectral analysis and speech recognition models identify important audio features and speech content. Bayesian network modeling component 1220 constructs dynamic Bayesian network (BN) model 1225 representing joint probabilistic distribution of semantic elements identified in content.

Compression optimization subsystem 1230 works in conjunction with content analysis and semantic compression subsystem 1210 to determine optimal compression parameters. Rate-distortion optimization component 1235 calculates trade-offs between compression rate and distortion of reconstructed content, considering factors such as motion estimation accuracy, quantization parameters, and frame type selection for video, or spectral resolution and temporal precision for audio. Adaptive quantization component 1240 adjusts quantization parameters based on semantic importance of different content regions, allocating more bits to semantically rich areas while applying stronger compression to less important regions.

Neural network optimization subsystem 1250 enhances efficiency of neural networks used throughout system 1200. Information bottleneck implementation component 1255 optimizes neural network architectures by minimizing information between layer activations and input while preserving output-relevant information. Hilbert-Schmidt independence criterion (HSIC) component 1260 measures layer-wise importance and redundancy in neural networks. Network pruning component 1265 utilizes HSIC-based strategy to iteratively evaluate the importance of each layer and remove layers or neurons that contribute least to overall performance.

Adaptive control subsystem 1270 maintains optimal performance of system 1200 through continuous evaluation and adjustment. Feedback loop component 1275 monitors compression performance and adjusts parameters of various subsystems in real-time. Performance metrics database 1280 stores historical performance data and thresholds used by feedback loop component 1275 to make informed adjustments.

Compressed output data 1290 is generated by system 1200, representing highly efficient compression of input multimedia data 1205. This compressed output retains semantic richness and task-relevant information while minimizing data size and processing overhead.

Data flow within system 1200 begins with input multimedia data 1205 entering content analysis and semantic compression subsystem 1210. Processed semantic information and BN model 1225 are then utilized by compression optimization subsystem 1230 to determine optimal compression strategies. Neural network optimization subsystem 1250 continuously refines neural network architectures used throughout system 1200. Adaptive control subsystem 1270 oversees the entire process, making real-time adjustments to ensure optimal performance. Finally, compressed output data 1202 is produced, ready for storage or transmission.

In a use case example of an embodiment of information theory enhanced compression system 1200, a video streaming service implements the system to optimize bandwidth usage and improve user experience. The service receives high-quality video content from content creators and needs to compress this content for efficient streaming to end-users across various devices and network conditions. As new video content is uploaded to the service, it is first processed by content analysis and semantic compression subsystem 1210. Semantic analysis component 1215 employs convolutional neural networks to identify key visual elements such as characters, objects, and scene changes. Recurrent neural networks analyze temporal relationships between frames, identifying important narrative elements and action sequences. For the audio track, spectral analysis identifies music, sound effects, and speech content.

Bayesian network modeling component 1220 then constructs a probabilistic model of the semantic elements identified in the video. This model represents relationships between characters, their actions, and the overall narrative structure of the content. Compression optimization subsystem 1230 uses this semantic information to make intelligent compression decisions. Rate-distortion optimization component 1235 determines appropriate compression levels for different parts of the video. For instance, it allocates more bits to visually complex scenes or crucial plot points, while applying stronger compression to simpler or less narratively important sections. Adaptive quantization component 1240 fine-tunes the compression parameters. It ensures that the faces of main characters remain clear and detailed, while background elements receive higher compression. Similarly, it preserves the clarity of important dialogue in the audio track.

Throughout this process, neural network optimization subsystem 1250 continually refines the neural networks used for content analysis. Information bottleneck implementation component 1255 ensures that the networks focus on extracting features most relevant to perceived video quality. Network pruning component 1265 removes redundant neurons, optimizing computational efficiency. Adaptive control subsystem 1270 monitors the entire compression process. It adjusts parameters based on feedback from quality assessments and user engagement metrics stored in performance metrics database 1280. For example, if users frequently rewind to re-watch certain scenes, the system may allocate more bits to those sections in future compressions.

The result is a compressed video stream that maintains high perceptual quality and narrative coherence while significantly reducing data size. The streaming service can now deliver this optimized content to users, providing high-quality video even on bandwidth-constrained networks. Users experience fewer buffering interruptions and clearer video, particularly for the most important parts of the content. This use case demonstrates how information theory enhanced compression system 1200 can be applied to optimize video compression for streaming, balancing quality, bandwidth usage, and computational efficiency in a way that enhances the overall user experience.

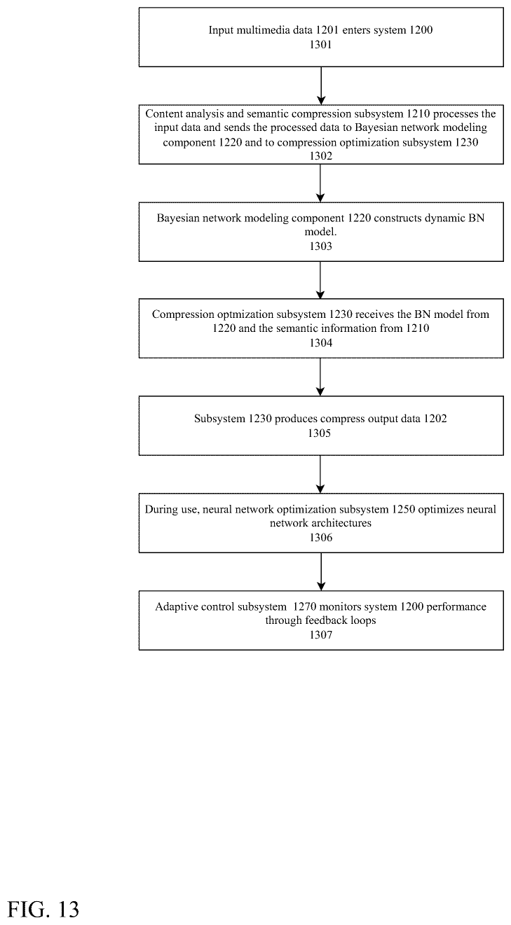

FIG. 13 is a method diagram illustrating the use of information theory enhanced compression system 1200. The process begins as input multimedia data 1201 enters system 1200 1301. Semantic analysis component 1215 then processes this input data, identifying key features and content characteristics 1302. Next, Bayesian network modeling component 1220 constructs a dynamic Bayesian network model 1225, representing probabilistic relationships between identified semantic elements 1303. Compression optimization subsystem 1230 receives both semantic information and BN model 1225, using these to inform its compression strategies 1304. Based on this information, compression optimization subsystem 1230 applies advanced compression techniques, including rate-distortion optimization and adaptive quantization, to produce compressed output data 1202 1305. Following initial compression, neural network optimization subsystem 1250 continuously works to enhance efficiency of neural networks used throughout system. This optimization process involves information bottleneck implementation component 1255 to minimize irrelevant information, Hilbert Schmidt independence criterion component 1260 to measure layer importance, and network pruning component 1265 to remove unnecessary network elements 1306. Adaptive control subsystem 1270 then monitors overall system performance, utilizing feedback loop component 1275 to analyze real-time compression results and performance metrics database 1280 to compare against historical data and predefined thresholds 1307. Finally, system 1200 enters a continuous refinement phase, where it optimizes its operations based on feedback provided by adaptive control subsystem 1270. This feedback is sent to content analysis and semantic compression subsystem 1210, compression optimization subsystem 1230, and neural network optimization subsystem 1250, allowing for ongoing improvements in compression efficiency and output quality 1308.

The information theory enhanced compression system 1200 integrates with other systems to optimize overall compression efficiency. It enhances the intelligent adaptive compression system 200 by incorporating semantic compression techniques and Bayesian network modeling. System 1200 works closely with the streaming platform integration system 400, providing advanced compression strategies that can be seamlessly integrated into existing streaming infrastructures. It supports the adaptive 3D video processing system 600 by applying information theory concepts to 3D content compression. The system also interacts with the device-specific adaptive content optimizer 800, using its network pruning strategies to optimize compression for different device capabilities. System 1200 complements the multi-dimensional mathematical compression framework 1600 by providing additional information theory-based optimization techniques. It also enhances the cross-media GenAI codec enhancement suite 1800 by offering advanced compression techniques that can be applied across various media types. The continuous learning AI analysis engine 2000 utilizes insights from system 1200 to refine compression strategies over time.

### Hierarchical Model Transmission Optimizer Architecture

Hierarchical model transmission optimizer is a system designed to reduce data transmission requirements in content streaming and AI-based compression scenarios. This system employs a model hierarchy approach, utilizing superset parent models and customized child models to efficiently represent and transmit content.

At the core of hierarchical model transmission optimizer system is model hierarchy structure. This structure consists of superset parent models that represent broad content types or families. These parent models encapsulate general characteristics and patterns common to specific genres or content categories. For example, in video streaming context, parent models might represent genres such as action movies, documentaries, or animated content. Each parent model contains neural network architectures and weights that capture high-level features and stylistic elements typical of its content category.

Model storage manager is responsible for maintaining parent models on local devices. This component organizes parent models in efficient data structures, allowing for quick access and updates. It also implements a versioning system to track model updates and ensure compatibility between parent and child models. Storage manager utilizes compression techniques to minimize storage footprint of parent models on device.

Customized child model generator creates specific models for individual content pieces. This component analyzes unique characteristics of movies or TV shows and generates a compact model that, when combined with appropriate parent model, can accurately reproduce content. Child model focuses on encoding content-specific details, such as unique characters, plot elements, or visual styles that deviate from general patterns captured by parent model.

Transmission optimization subsystem is a key component of hierarchical model transmission optimizer system. It determines which models need to be transmitted for each content request. When user requests specific content, this subsystem checks if appropriate parent model is already present on user's device. If parent model is available and up-to-date, only customized child model for requested content is transmitted. This significantly reduces the amount of data that needs to be sent, as child models are typically much smaller than full content or complete models.

Model update manager handles periodic updates to parent models. This component tracks changes in content patterns and viewer preferences over time, triggering updates to parent models when necessary. The update process is designed to be incremental, transmitting only changes or additions to existing models rather than replacing them entirely. This approach further minimizes data transmission requirements.

Content recreation engine is responsible for combining parent and child models to reproduce content on user's device. This engine implements neural network architectures capable of generating high-quality video and audio content from compact model representations. It utilizes techniques such as generative adversarial networks (GANs) or variational autoencoders (VAEs) to synthesize content that closely matches the original.

User preference integrator allows for personalized content modification based on individual preferences. This component interfaces with user profile database to retrieve and apply user-specific settings during content recreation process. It can modify generated content in real-time to accommodate preferences such as content rating restrictions, language preferences, or visual style adjustments.

Augmentation model manager handles storage and application of content modification models on client devices. These models are designed to perform specific types of content alterations, such as removing graphic content, changing visual styles, or adapting dialogue. Augmentation model manager organizes these models by content type and modification capability, allowing for efficient selection and application during content recreation process.

Latent space manipulation subsystem enables application of augmentation models within compressed representation of content. This subsystem operates on latent vectors produced by encoding the stage of content recreation process. It applies transformations defined by augmentation models to these latent representations, allowing for complex content modifications without need for full decompression and re-encoding.

Adaptive model selection algorithm optimizes choice of parent and augmentation models based on available device resources and network conditions. This algorithm considers factors such as device storage capacity, processing power, and current network bandwidth to determine the optimal set of models to store locally and which to request from server.

Quality assurance subsystem continuously evaluates quality of recreated and augmented content. It compares generated content against reference data or predefined quality metrics to ensure that model-based content recreation maintains high fidelity to original content while accommodating user preferences and augmentations.

By implementing these components, hierarchical model transmission optimizer significantly reduces data transmission requirements for content streaming and AI-based compression systems. It leverages locally stored parent models and transmits only essential, customized information for specific content, while also enabling personalized content modifications and augmentations.

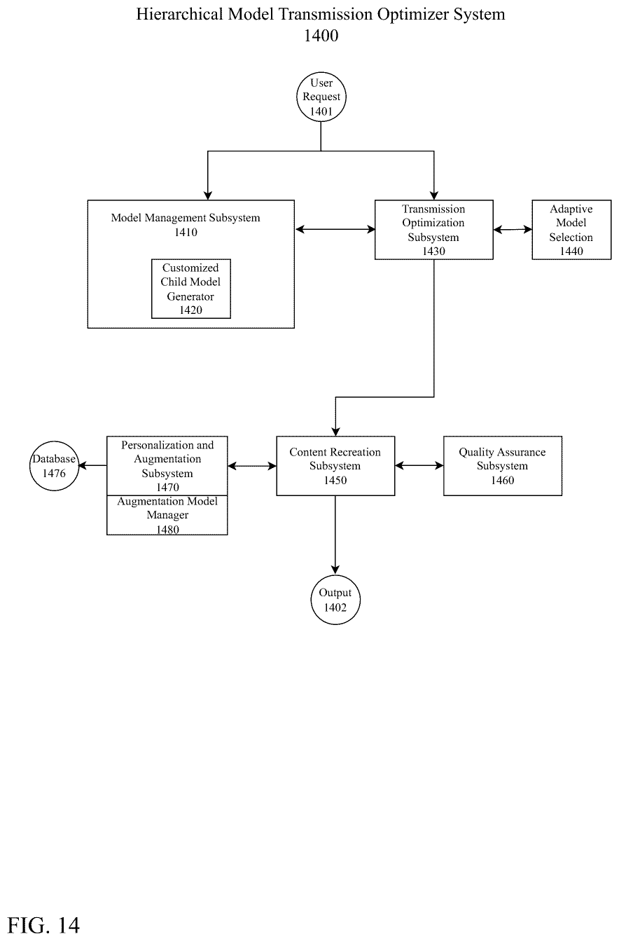

FIG. 14 is a block diagram illustrating exemplary architecture hierarchical model transmission optimizer 1400. Hierarchical model transmission optimizer 1400 comprises several interconnected subsystems designed to efficiently manage, transmit, and recreate content using a model-based approach.

At the core of hierarchical model transmission optimizer 1400 is model management subsystem 1410. Model management subsystem 1410 includes model hierarchy structure 1411, which consists of superset parent models and customized child models. Model storage manager 1415 maintains these models on local devices, implementing versioning and compression techniques to optimize storage. Customized child model generator 1420 creates specific models for individual content pieces, while model update manager 1425 handles periodic updates to parent models.

Transmission optimization subsystem 1430 works in conjunction with model management subsystem 1410 to minimize data transmission requirements. Transmission optimization component 1435 determines which models need to be transmitted for each content request, while adaptive model selection algorithm 1440 optimizes the choice of parent and augmentation models based on available device resources and network conditions.

Content recreation subsystem 1450 is responsible for reproducing content on the user's device. Content recreation engine 1455 combines parent and child models to generate high-quality video and audio content. Quality assurance subsystem 1460 continuously evaluates the quality of recreated and augmented content to ensure fidelity to the original while accommodating user preferences and augmentations.

Personalization and augmentation subsystem 1470 enables customization of content based on user preferences and applies modifications. User preference integrator 1475 interfaces with user profile database 1476 to retrieve and apply user-specific settings during the content recreation process. Augmentation model manager 1480 handles storage and application of content modification models, while latent space manipulation subsystem 1485 enables the application of augmentation models within the compressed representation of content.

Data flows through hierarchical model transmission optimizer 1400 as follows: When a user requests specific content 1401, transmission optimization subsystem 1430 checks if the appropriate parent model is available in model storage manager 1415. If present, only the customized child model for the requested content is transmitted. Model management subsystem 1410 then provides the necessary models to content recreation subsystem 1450. Content recreation engine 1455 combines these models to reproduce the content, while personalization and augmentation subsystem 1470 applies any user-specific modifications. Quality assurance subsystem 1460 ensures the final output 1402 meets predetermined quality standards before delivery to the user.

Through this architecture, hierarchical model transmission optimizer 1400 achieves efficient content streaming and AI-based compression by leveraging locally stored parent models, transmitting only essential customized information, and enabling personalized content modifications and augmentations.

In a use case example of an embodiment of hierarchical model transmission optimizer 1400, a user requests 1401 to stream a newly released action movie on their mobile device. Upon receiving this request, transmission optimization subsystem 1430 checks the user's device to determine if the appropriate parent model for action movies is already present in model storage manager 1415. Finding that the parent model is available and up-to-date, transmission optimization component 1435 initiates the transfer of only the customized child model specific to the requested movie. Customized child model generator 1420 has previously analyzed the unique characteristics of the movie, such as its specific visual effects, character designs, and plot elements, and created a compact model that encodes these distinctive features. This child model is significantly smaller than the full movie file, reducing the amount of data that needs to be transmitted to the user's device.

Once the child model is received, content recreation subsystem 1450 begins the process of reproducing the movie. Content recreation engine 1455 combines the locally stored parent model for action movies with the received child model, utilizing neural network architectures to generate high-quality video and audio content 1402 that closely matches the original movie.

During this process, personalization and augmentation subsystem 1470 comes into play. User preference integrator 1475 consults user profile database 1476 and determines that the user prefers reduced violence in their content. Augmentation model manager 1480 selects and applies an appropriate content modification model to tone down graphic scenes. Latent space manipulation subsystem 1485 enables these modifications to be applied efficiently within the compressed representation of the content. Throughout the streaming process, adaptive model selection algorithm 1440 continuously optimizes the use of models based on the device's current processing power and network conditions, ensuring smooth playback. Meanwhile, quality assurance subsystem 1460 monitors the recreated and augmented content to maintain high fidelity to the original while accommodating the user's preferences.

This use case demonstrates how hierarchical model transmission optimizer 1400 significantly reduces data transmission requirements while delivering personalized, high-quality content to the user.

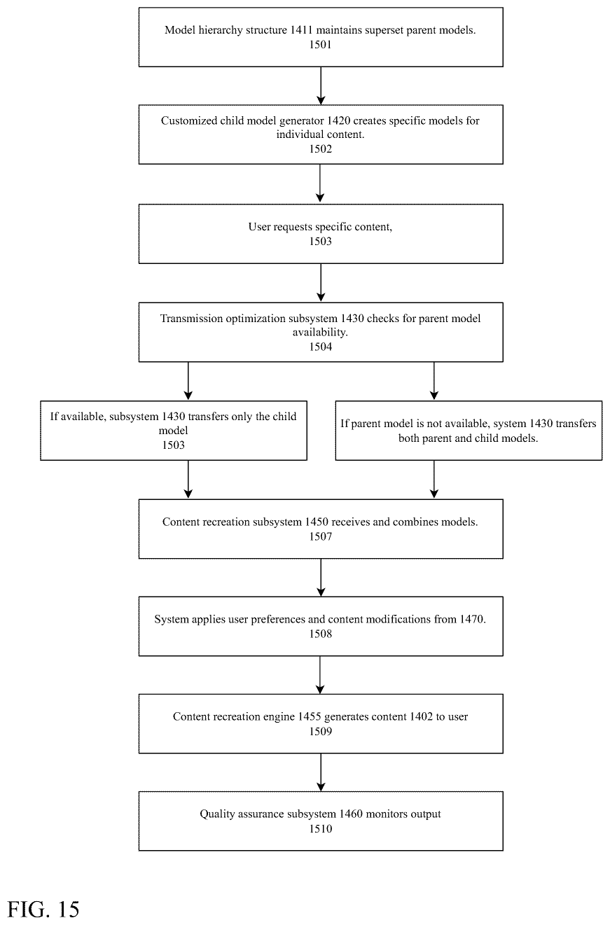

FIG. 15 is a method diagram illustrating the use of hierarchical model transmission optimization system 1400. The process begins with the model hierarchy structure 1411 maintaining superset parent models that represent broad content categories 1501.

Simultaneously, the customized child model generator 1420 creates specific models for individual content pieces, focusing on their unique characteristics 1502. When a user requests specific content 1401, the system initiates its optimization process 1503. The transmission optimization subsystem 1430 then checks for the availability of the appropriate parent model on the user's device 1504. If the parent model is already available, the system efficiently transfers only the customized child model for the requested content 1505. However, if the parent model is not present on the user's device, the system transfers both the parent and child models to ensure complete content recreation 1506. Once the necessary models are in place, the content recreation subsystem 1450 receives and combines them, integrating the broad category features with the specific content details 1507. The system then applies user preferences and content modifications, personalizing the experience based on individual user profiles and settings 1508. Finally, the content recreation engine 1455 generates the content, while the quality assurance subsystem 1460 monitors the output to ensure high fidelity and user satisfaction, after which the system delivers the final output 1402 to the user 1509.

The hierarchical model transmission optimizer 1400 interacts with several other systems to reduce data transmission requirements efficiently. It works closely with the intelligent adaptive compression system 200, providing a model hierarchy approach that complements the content-adaptive encoding process. System 1400 integrates with the streaming platform integration system 400 to optimize content delivery by transmitting only essential, customized information for specific content. It supports the device-specific adaptive content optimizer 800 by enabling efficient model storage and transmission tailored to different device capabilities. The system also interacts with the multi-dimensional mathematical compression framework 1600, leveraging its advanced analysis techniques to create more efficient parent and child models. System 1400 enhances the cross-media GenAI codec enhancement suite 1800 by providing a hierarchical approach to managing and deploying GenAI models across different media types. The continuous learning AI analysis engine 2000 uses insights from system 1400 to refine and update the model hierarchy over time, ensuring ongoing optimization of the transmission process.

### Multi-Dimensional Mathematical Compression Framework

Multi-dimensional mathematical compression framework is a comprehensive system that utilizes advanced mathematical concepts, particularly 4D symmetry analysis and diffeomorphic transformations, to achieve highly efficient compression across various media types. This framework extends traditional compression techniques by considering not only spatial and temporal dimensions but also abstract mathematical spaces to identify and exploit complex patterns and relationships within content.

The application of 4D symmetry analysis in this system is inspired by fundamental principles observed in biological intelligence and physics. This approach recognizes that certain transformations (symmetries) can affect some aspects of a system while leaving others unchanged, a concept that has proven central to modern physics and is gaining prominence in machine learning. By incorporating 4D symmetry analysis, the system aims to achieve more efficient, generalizable, and transferable processing of multi-modal content. This method draws parallels with the way biological systems efficiently acquire and apply skills across diverse situations, potentially leading to more robust and adaptable AI-driven compression techniques. The implementation of 4D symmetry analysis in this context represents a step towards creating sensory representations that can capture complex behaviors and relationships within the content, mirroring the way biological intelligence interprets and interacts with the world.

At the core of multi-dimensional mathematical compression framework is 4D symmetry analysis subsystem. This subsystem processes input data, such as video frames or audio signals, to identify symmetries and patterns across four dimensions: three spatial dimensions and time. For video content, convolutional neural networks (CNNs) are employed to detect spatial features within individual frames, while recurrent neural networks (RNNs) or transformer architectures analyze temporal evolution of these features. 4D symmetry detection algorithms, implemented on specialized hardware like TPUs, identify repeating patterns, self-similarities, and transformations that persist across both space and time.

Diffeomorphic analysis component complements 4D symmetry analysis by focusing on continuous, invertible transformations that preserve topological structure of content. This subsystem employs differential geometry techniques to model content as manifolds and identify diffeomorphisms between different content segments. Implementation involves the use of computational anatomy methods, such as Large Deformation Diffeomorphic Metric Mapping (LDDMM), adapted for media compression context. FPGAs are configured to perform real-time diffeomorphic computations, enabling adaptive compression based on content characteristics.

Content-adaptive encoding process is enhanced by integrating outputs from 4D symmetry and diffeomorphic analysis subsystems. Encoding algorithms dynamically adjust compression parameters based on identified symmetries and transformations. For example, in video compression, motion estimation and compensation techniques are extended to incorporate 4D symmetries, allowing for more efficient prediction of frame contents. Diffeomorphic mappings guide preservation of essential structural features during quantization and transform coding stages.

AI-driven optimization component of multi-dimensional mathematical compression framework is designed to recognize and leverage multi-dimensional patterns identified through symmetry and diffeomorphic analysis. This component employs deep learning models, such as graph neural networks or hyperdimensional computing architectures, to capture complex relationships in high-dimensional feature spaces. These models are trained to predict and reconstruct content based on compressed representations derived from symmetry and diffeomorphic analysis, potentially achieving higher compression ratios while maintaining perceptual quality.

Multi-dimensional mathematical compression framework includes specialized hardware utilization strategy to efficiently perform complex mathematical operations required for multi-dimensional analysis. TPUs are programmed to execute tensor operations involved in 4D symmetry detection, while FPGAs are configured for real-time diffeomorphic computations. ASICs are designed to accelerate specific algorithms, such as fast Fourier transforms or wavelet transforms, which are fundamental to many compression techniques and can be extended to higher dimensions.

For 3D video formats, such as Side-by-Side (SBS) and Frame-Sequential, framework applies 4D symmetry analysis to identify patterns in how left and right eye views evolve over time. This approach enables additional compression by exploiting similarities and differences between stereoscopic views across temporal dimensions. Diffeomorphic analysis is used to map transformations between left and right views, allowing for more efficient encoding of depth information. 2D to 3D video transformation process is enhanced within framework by leveraging 4D symmetry analysis to provide comprehensive understanding of how depth and motion interact over time. Diffeomorphic analysis aids in identifying and preserving key structural elements essential for accurate depth estimation and 3D reconstruction. This results in more efficient and accurate 3D content generation from 2D sources.

Multi-dimensional mathematical compression framework implements content-specific and genre-specific processing approaches by generating tailored compression models based on 4D symmetries and diffeomorphic patterns characteristic of different content types. For instance, sports content might exhibit specific spatiotemporal symmetries related to playing field and athlete movements, while animated content could have unique diffeomorphic properties due to its stylized nature. These content-specific models are integrated into model hierarchy, with general patterns stored in parent models on local devices and specific patterns transmitted as needed.

Integration with information theory concepts is achieved by incorporating 4D symmetry and diffeomorphic analysis into semantic compression framework. This integration allows for more efficient identification and preservation of task-relevant information across both space and time. For example, semantic features identified through content analysis are mapped to symmetry and diffeomorphic patterns, enabling preservation of meaningful content structures while aggressively compressing less important elements.

Cross-media application of framework extends its capabilities beyond video to other media types. For audio compression, temporal and frequency domain symmetries are analyzed in four-dimensional time-frequency space. Image compression exploits spatial symmetries and structural similarities identified through higher-dimensional analysis of image features. Text compression leverages semantic and syntactic patterns revealed through analysis of word and sentence embeddings in high-dimensional spaces.

Adaptive processing for emerging devices with integrated AI chips is facilitated by framework's modular design. Content-specific compression models based on 4D symmetries and diffeomorphic analysis can be dynamically selected and applied based on content type, device capabilities, and network conditions. This allows for optimal utilization of device resources while maintaining high compression efficiency.

By integrating these advanced mathematical techniques and AI-driven optimizations, multi-dimensional mathematical compression framework achieves highly efficient compression across various media types. It adapts to unique characteristics of different content types while maintaining high quality and significantly reducing data transmission requirements.

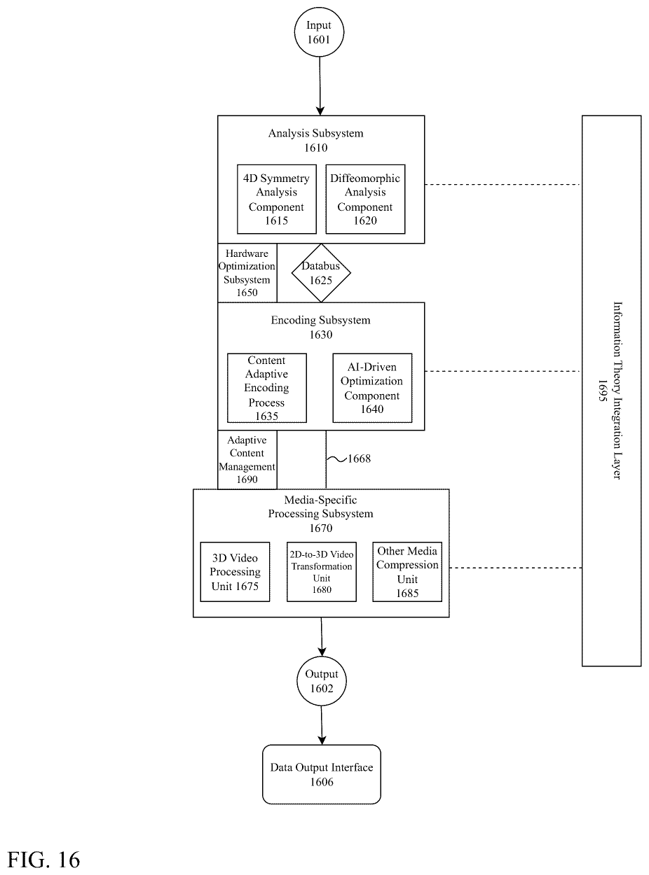

FIG. 16 is a block diagram illustrating exemplary architecture of illustrating multi-dimensional mathematical compression framework 1600. Input data 1601 enters framework 1600 through data input interface 1605. Data input interface 1605 routes input data 1601 to analysis subsystem 1610.

Analysis subsystem 1610 comprises 4D symmetry analysis component 1615 and diffeomorphic analysis component 1620. 4D symmetry analysis component 1615 includes convolutional neural networks 1616 for spatial feature detection and recurrent neural networks and/or transformers 1617 for temporal analysis. 4D symmetry detection algorithms 1618 operate on specialized hardware to identify repeating patterns, self-similarities, and transformations across space and time. CNNs 1616 are trained on large datasets of diverse media content using supervised learning. Training data includes labeled examples of spatial features in various media types. The models are fine-tuned using transfer learning from pre-trained networks on image recognition tasks, adapting them to detect symmetries and patterns specific to compression tasks. Models 1615 are trained on sequential data representing temporal aspects of media content. Training involves using teacher forcing and backpropagation through time for RNNs, and/or self-attention mechanisms for Transformers. The models learn to identify temporal symmetries and recurring patterns over time.

Diffeomorphic analysis component 1620 employs differential geometry techniques 1621 and computational anatomy methods 1622, such as Large Deformation Diffeomorphic Metric Mapping (LDDMM). Manifold modeling unit 1623 represents content as mathematical manifolds for further analysis.

Results from analysis subsystem 1610 are passed to encoding subsystem 1630 via data bus 1625. Encoding subsystem 1630 consists of content-adaptive encoding process 1635 and AI-driven optimization component 1640. Content-adaptive encoding process 1635 integrates outputs from 4D symmetry and diffeomorphic analysis through integration unit 1636. Dynamic parameter adjustment unit 1637 modifies compression parameters based on identified symmetries and transformations. AI-driven optimization component 1640 utilizes deep learning models 1641, for example graph neural networks and/or hyperdimensional computing architectures, for content prediction and reconstruction. Pattern recognition unit 1642 leverages multi-dimensional patterns identified through earlier analysis stages. Graph Neural Networks (GNNs) are trained on graph-structured data representing relationships between different elements in the media content. Training uses techniques like neighborhood sampling and aggregation to learn effective node embeddings. Hyperdimensional computing architectures are trained using holographic reduced representations and binding operations to capture complex, high-dimensional relationships in the data.

Hardware optimization subsystem 1650 interfaces with both analysis subsystem 1610 and encoding subsystem 1630, providing specialized hardware support. Hardware optimization subsystem 1650 includes tensor processing units 1655 for 4D symmetry operations, field-programmable gate arrays 1660 for real-time diffeomorphic computations, and application-specific integrated circuits 1665 for accelerating specific algorithms such as fast Fourier transforms or wavelet transforms. Hardware resource allocation unit 1666 dynamically assigns computational tasks to appropriate hardware components.

Media-specific processing subsystem 1670 receives input from encoding subsystem 1630 via data channel 1668. Media-specific processing subsystem 1670 applies tailored compression techniques for various media types, including 3D video processing unit 1675, 2D to 3D video transformation unit 1680, and other media compression unit 1685 for audio, image, and text processing. 3D video processing unit 1675 includes stereoscopic view analysis component 1676 and depth information encoding component 1677. 2D to 3D video transformation unit 1680 incorporates depth estimation module 1681 and 3D reconstruction module 1682. Depth estimation module 1681 is trained using a combination of supervised learning on datasets with ground truth depth information and self-supervised learning techniques. The latter involves training on stereo pairs or video sequences without explicit depth labels, using consistency between views as a training signal. Synthetic data generation is also employed to augment training datasets with precise depth information.

Adaptive content management subsystem 1690 interacts with both encoding subsystem 1630 and media-specific processing subsystem 1670. Content classification unit 1691 identifies specific content types and genres. Model selection unit 1692 chooses appropriate compression models based on content characteristics. Device capability assessment unit 1693 optimizes processing for different hardware environments. Models used in content classification unit 1691 are trained using a combination of supervised and unsupervised learning techniques. Supervised learning uses labeled datasets of various content types and genres. Unsupervised techniques like clustering are employed to discover latent categories in the data. Transfer learning from pre-trained models on large-scale datasets is utilized to improve classification accuracy on specific content types.

Information theory integration layer 1695 overlays framework 1600, ensuring semantic relevance is maintained throughout compression process. Semantic feature mapping unit 1696 correlates content features with symmetry and diffeomorphic patterns. Information preservation unit 1697 prioritizes retention of meaningful content structures during compression.

Compressed output data 1602 is produced as result of framework 1600 and exits through data output interface 1606. Control flow management unit 1607 coordinates operations and data exchange among all subsystems throughout framework 1600. User interface 1603 allows for system configuration, parameter adjustment, and monitoring of compression processes. Compression model database 1604 stores pre-trained models, content-specific patterns, and historical compression data for reference and optimization.

External data input/output ports 1608 facilitate integration with other systems and allow for firmware updates. Power management unit 1609 optimizes energy consumption across framework components. Error handling and logging subsystem 1611 ensures system stability and provides diagnostic information.

Framework 1600 operates as cohesive system, with each subsystem contributing to efficient, content-aware, and mathematically sophisticated compression across multiple dimensions and media types. Modular architecture of framework 1600 allows for future expansions and upgrades to accommodate emerging compression technologies and media formats.

Data flow in multi-dimensional mathematical compression framework 1600 begins as input data 1601 enters through data input interface 1605. Input data 1601 is then processed by analysis subsystem 1610, where 4D symmetry analysis component 1615 and diffeomorphic analysis component 1620 extract multi-dimensional patterns and transformations. Results from analysis subsystem 1610 flow via data bus 1625 to encoding subsystem 1630, where content-adaptive encoding process 1635 and AI-driven optimization component 1640 leverage the analyzed patterns to perform initial compression. The partially compressed data then moves to media-specific processing subsystem 1670, which applies tailored techniques based on the media type. Throughout this process, adaptive content management subsystem 1690 continuously interacts with encoding subsystem 1630 and media-specific processing subsystem 1670, adjusting compression strategies based on content classification and device capabilities. Hardware optimization subsystem 1650 facilitates efficient data processing across all stages by dynamically allocating computational tasks to specialized hardware components. Information theory integration layer 1695 oversees the entire data flow, ensuring semantic relevance is preserved. Finally, the fully compressed data exits as output data 1602 through data output interface 1606. This multi-stage, adaptive data flow enables framework 1600 to achieve high compression efficiency while maintaining content quality across various media types and dimensions.

In a use case example of an embodiment of multi-dimensional mathematical compression framework 1600, a high-resolution 3D video stream of a sporting event is processed for efficient transmission and storage. Input data 1601, consisting of the raw 3D video frames, enters framework 1600 through data input interface 1605. Analysis subsystem 1610 processes the video stream, with 4D symmetry analysis component 1615 identifying recurring patterns in both spatial and temporal dimensions, such as the repeating structure of the stadium and cyclical movements of athletes. Simultaneously, diffeomorphic analysis component 1620 maps continuous transformations in the video, like the motion of a ball through the air.

Encoding subsystem 1630 then leverages these identified patterns and transformations. Content-adaptive encoding process 1635 adjusts compression parameters dynamically based on the game's pace, focusing on areas of high activity. AI-driven optimization component 1640 predicts and reconstructs less critical background elements, allowing for higher compression of these areas.

Media-specific processing subsystem 1670 applies specialized 3D video processing techniques through unit 1675, optimizing the compression of stereoscopic views while preserving depth information. Adaptive content management subsystem 1690 recognizes the content as a sporting event and selects appropriate compression models that prioritize smooth motion and clear player identification.

Throughout the process, hardware optimization subsystem 1650 ensures efficient utilization of computational resources, with tensor processing units 1655 handling the complex 4D symmetry calculations and field-programmable gate arrays 1660 managing real-time diffeomorphic computations.

Information theory integration layer 1695 oversees the compression, ensuring that semantically important elements like player positions, ball movement, and scoreboard information are preserved with high fidelity. The resulting compressed output data 1602, now significantly reduced in size while maintaining visual quality and important game details, is transmitted through data output interface 1606 for efficient distribution to viewers.

This use case demonstrates how framework 1600 leverages multi-dimensional analysis and content-aware processing to achieve high compression ratios for complex 3D video content while preserving the viewing experience quality.

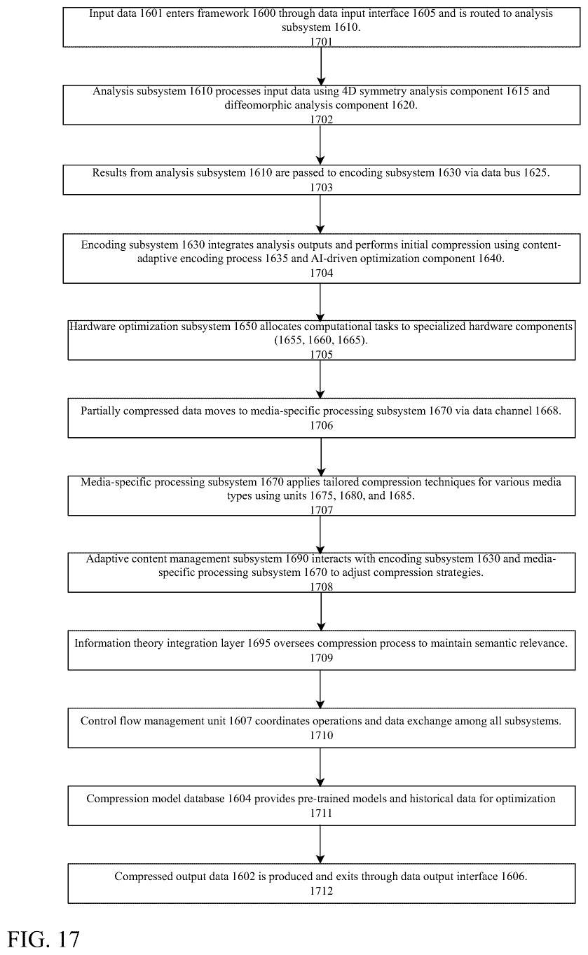

FIG. 17 is a method diagram illustrating the use of multi-dimensional mathematical compression framework 1600. The process begins as input data 1601 enters framework 1600 through data input interface 1605 and is routed to analysis subsystem 1610 1701. Analysis subsystem 1610 then processes the input data using 4D symmetry analysis component 1615 and diffeomorphic analysis component 1620, identifying spatial and temporal patterns as well as applying differential geometry techniques 1702. The results from this analysis are then passed to encoding subsystem 1630 via data bus 1625 1703. Encoding subsystem 1630 integrates the analysis outputs and performs initial compression using content-adaptive encoding process 1635 and AI-driven optimization component 1640, leveraging deep learning models for content prediction and reconstruction 1704. Throughout this process, hardware optimization subsystem 1650 allocates computational tasks to specialized hardware components including tensor processing units 1655, field-programmable gate arrays 1660, and application-specific integrated circuits 1665 1705. The partially compressed data then moves to media-specific processing subsystem 1670 via data channel 1668 1706. Here, tailored compression techniques are applied for various media types using specialized units for 3D video, 2D to 3D transformation, and other media compression 1707. Adaptive content management subsystem 1690 continuously interacts with encoding subsystem 1630 and media-specific processing subsystem 1670 to adjust compression strategies based on content classification and device capabilities 1708. Information theory integration layer 1695 oversees the entire compression process to maintain semantic relevance, correlating content features with symmetry and diffeomorphic patterns 1709. Control flow management unit 1607 coordinates operations and data exchange among all subsystems, ensuring efficient processing 1710. Throughout the process, compression model database 1604 provides pre-trained models and historical data for optimization and reference 1711. Finally, the fully compressed output data 1602 is produced and exits through data output interface 1606, ready for transmission or storage 1712.

Framework 1600 is designed to integrate seamlessly with other systems described in the patent, enhancing the overall adaptive intelligent multi-modal media processing and delivery system. It interacts closely with the intelligent adaptive compression system 200, providing advanced mathematical techniques to further optimize the compression process. The streaming platform integration system 400 leverages framework 1600's capabilities to enhance content delivery across various platforms. Framework 1600 also supports the adaptive 3D video processing system 600 by providing sophisticated 4D symmetry analysis and diffeomorphic transformations for 3D content. It works in tandem with the device-specific adaptive content optimizer 800, using its hardware optimization subsystem 1650 to tailor processing for different device capabilities. The dynamic content encryption and filtering engine 1000 can utilize framework 1600's information theory integration layer 1695 to maintain semantic relevance during encryption processes. Framework 1600 enhances the capabilities of the hierarchical model transmission optimizer 1400 by providing more efficient content representation techniques. It also supports the cross-media GenAI codec enhancement suite 1800 with its media-specific processing subsystem 1670. Finally, framework 1600 provides valuable input to the continuous learning AI analysis engine 2000, allowing for ongoing refinement of compression strategies based on multi-dimensional mathematical analysis.

### Cross-Media GenAI Codec Enhancement Suite

Cross-media GenAI codec enhancement suite is a comprehensive system designed to optimize compression and processing across various media types using advanced generative AI techniques. This suite extends traditional codec functionalities by incorporating content-specific, adaptive, and cross-modal compression strategies.

At core of cross-media GenAI codec enhancement suite is a set of generative AI models trained on diverse media types, including video, audio, images, and text. These models are based on architectures such as variational autoencoders (VAEs) or generative adversarial networks (GANs), adapted to handle multi-modal inputs and outputs. Training process involves exposure to large datasets of mixed-media content, enabling models to learn complex patterns and relationships across different modalities.

Content-adaptive encoding subsystem within cross-media GenAI codec enhancement suite analyzes input media to identify key characteristics and select appropriate compression strategies. For video content, this involves scene analysis, motion detection, and content classification. Audio processing includes spectral analysis and speech recognition. Image analysis focuses on object detection, texture classification, and color distribution. Text processing involves semantic analysis and context understanding.

Cross-media GenAI codec enhancement suite implements a model hierarchy approach to efficiently manage and deploy compression models. Parent models, representing broad content categories or media types, are stored locally on user devices. These parent models encapsulate general features and compression strategies applicable to a wide range of content within their domain. Child models, which are more specialized and content-specific, are generated on-demand and transmitted to user devices as needed.

Loadable GenAI codec enhancers form a key component of cross-media GenAI codec enhancement suite. These enhancers are lightweight, content-specific models that augment parent models to achieve highly efficient compression for content pieces. Enhancers are generated using transfer learning techniques, adapting pre-trained parent models to specific content characteristics. This approach allows for rapid adaptation to new content while minimizing data transmission requirements.

Cross-media compression optimization is achieved through a unified framework that leverages 4D symmetries and diffeomorphic transformations. This framework identifies patterns and structures that persist across different media types and temporal dimensions. For instance, it can recognize how visual elements in a video correspond to audio cues or how textual descriptions relate to image content. This cross-modal understanding enables more efficient compression by exploiting redundancies and relationships across different media components.

Specialized hardware utilization is integral to cross-media GenAI codec enhancement suite's real-time performance. The system can utilize a wide range of processing units, depending on the specific implementation and available resources. For example, Tensor Processing Units (TPUs) are employed for rapid inference and adaptation of AI models. Field-Programmable Gate Arrays (FPGAs) are configured to perform complex mathematical operations required for 4D symmetry analysis and diffeomorphic transformations. Application-Specific Integrated Circuits (ASICs) are designed to accelerate specific compression algorithms optimized for different media types.

Streaming efficiency is significantly improved through cross-media GenAI codec enhancement suite's adaptive approach. For services like video streaming platforms, only content-specific enhancers need to be transmitted along with compressed content, dramatically reducing data transmission requirements. Suite's ability to process and compress mixed-media content as a unified stream further optimizes delivery of complex, multi-modal content.

User preference integration is achieved through a personalization subsystem that analyzes viewing history, device usage patterns, and explicit user settings. This information is used to fine-tune compression strategies, prioritizing quality for content elements that are most important to individual users. For example, a user who primarily watches action movies might have enhancers optimized for high motion scenes and dynamic audio.

Adaptive processing for emerging devices with integrated AI chips is facilitated by cross-media GenAI codec enhancement suite's modular design. Compression models and enhancers can be dynamically selected and applied based on device capabilities, network conditions, and content type. This ensures optimal performance across a wide range of devices, from high-end smartphones to smart TVs and streaming boxes.

Multi-modal content creation capabilities are enhanced by cross-media GenAI codec enhancement suite's unified approach to media processing. By understanding relationships between different media types, suite can assist in generating coherent multi-modal content, ensuring that generated or compressed elements across different modalities remain consistent and complementary.

Integration with information theory concepts is achieved by incorporating semantic compression techniques into cross-media analysis. This allows cross-media GenAI codec enhancement suite to identify and preserve task-relevant information across different media types and content categories, optimizing compression ratios while maintaining perceptual quality and semantic meaning.

Through this comprehensive approach, cross-media GenAI codec enhancement suite provides a powerful framework for efficient, adaptive, and high-quality compression across diverse media types. It enables significant reductions in data transmission and storage requirements while maintaining or improving content quality, adapting to specific content characteristics, user preferences, and device capabilities.

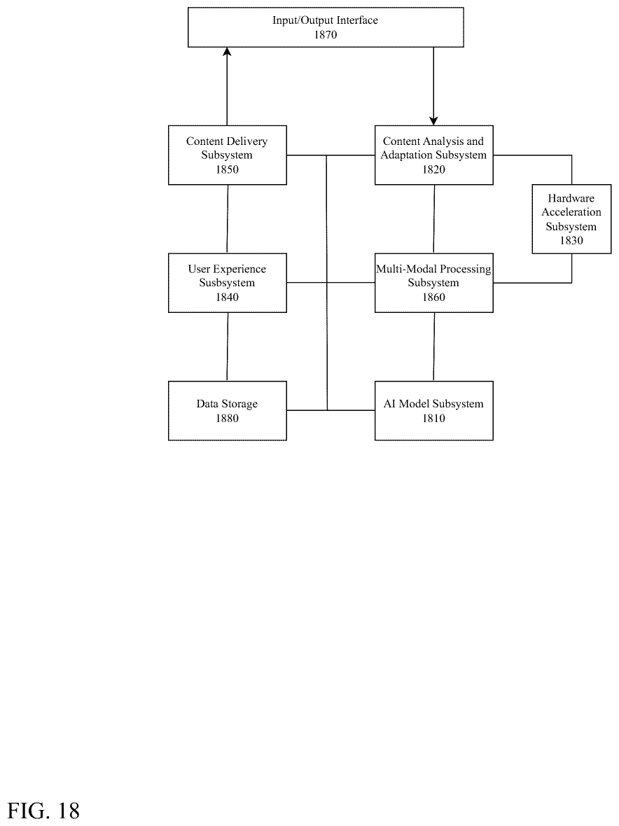

FIG. 18 is a block diagram illustrating exemplary architecture of cross-media genAI codec enhancement suite 1800. Cross-media genAI codec enhancement suite 1800 comprises several interconnected subsystems that work together to provide efficient, adaptive, and high-quality compression across diverse media types.

At core of suite 1800 is AI model subsystem 1810, which houses core generative AI models 1811 based on architectures such as variational autoencoders (VAEs) or generative adversarial networks (GANs). These models are adapted to handle multi-modal inputs and outputs. AI model subsystem 1810 also includes model hierarchy 1815, consisting of parent models representing broad content categories and child models for more specialized content. Loadable genAI codec enhancers 1819 are lightweight, content-specific models that augment parent models for highly efficient compression. These enhancers are generated dynamically based on the specific characteristics of the content being processed. When new content is analyzed, core generative AI models 1811 use transfer learning techniques to adapt pre-trained parent models to the unique features of the input media. This results in a small, specialized model (the enhancer) that captures the essence of how to best compress the specific content. These enhancers are then packaged with the compressed content for transmission. On the receiving end, the enhancers are loaded alongside the appropriate parent models to achieve optimal decompression. This approach allows for highly adaptive compression without the need to transmit entire large models for each piece of content, significantly reducing data transmission requirements while maintaining high compression quality.

Content analysis and adaptation subsystem 1820 works in conjunction with AI model subsystem 1810. Content-adaptive encoding subsystem 1825 analyzes input media to identify key characteristics and select appropriate compression strategies Cross-media compression optimization subsystem 1829 leverages 4D symmetries and diffeomorphic transformations to identify patterns and structures across different media types and temporal dimensions. 4D symmetries refer to patterns that persist across three spatial dimensions and one temporal dimension, allowing the system to recognize and compress redundant information in video and animated content. For example, it might identify a recurring visual element that moves predictably across frames. Diffeomorphic transformations, which are smooth and invertible mappings between spaces, are used to model complex relationships between different media types. For instance, they can map how changes in an audio track correspond to changes in video content, enabling more efficient cross-modal compression. These techniques allow subsystem 1829 to identify and exploit deep structural similarities across diverse media types, significantly enhancing compression efficiency while preserving content integrity.

Hardware acceleration subsystem 1830 ensures computationally intensive tasks are executed efficiently. It includes tensor processing units (TPUs) 1831 for rapid inference and model adaptation, field-programmable gate arrays (FPGAs) 1835 for complex mathematical operations, and application-specific integrated circuits (ASICs) 1839 for accelerating specific compression algorithms.

User experience subsystem 1840 focuses on tailoring compression and delivery of content to individual users and their devices. User preference integration subsystem 1845 analyzes viewing history, device usage patterns, and user settings to fine-tune compression strategies. Adaptive processing subsystem 1849 optimizes performance across a wide range of devices with varying capabilities.

Content delivery subsystem 1850 optimizes streaming and delivery of compressed content. Streaming efficiency subsystem 1855 transmits only content-specific enhancers along with compressed content and processes mixed-media content as a unified stream.

Multi-modal processing subsystem 1860 handles integration of different media types and ensures consistency across modalities. Multi-modal content creation subsystem 1865 assists in generating coherent multi-modal content. Information theory integration subsystem 1869 incorporates semantic compression techniques into cross-media analysis.

Input/output interface 1870 manages data flow into and out of suite 1800, handling various media types including video, audio, images, and text. Data storage 1880 provides necessary storage capabilities for models, content, and user data.

In operation, input media enters suite 1800 through input/output interface 1870. Content analysis and adaptation subsystem 1820 analyzes input and determines optimal compression strategies. AI model subsystem 1810 applies appropriate models and enhancers, with computations accelerated by hardware acceleration subsystem 1830. User experience subsystem 1840 fine-tunes processing based on user preferences and device capabilities. Multi-modal processing subsystem 1860 ensures consistency across different media types. Finally, compressed and optimized content is delivered through content delivery subsystem 1850 and output via input/output interface 1870.

This architecture enables cross-media genAI codec enhancement suite 1800 to provide efficient, adaptive, and high-quality compression across diverse media types, significantly reducing data transmission and storage requirements while maintaining or improving content quality.

In a use case example of an embodiment of cross-media genAI codec enhancement suite 1800, a user is streaming a mixed-media presentation on their smartphone. This presentation includes high-definition video, audio narration, embedded images, and synchronized text captions. As content enters suite 1800 through input/output interface 1870, content analysis and adaptation subsystem 1820 immediately begins analyzing each media type. Content-adaptive encoding subsystem 1825 identifies key characteristics of video scenes, audio spectral patterns, image textures, and text semantics. Cross-media compression optimization subsystem 1829 recognizes relationships between visual elements, audio cues, and textual descriptions. Based on this analysis, AI model subsystem 1810 selects appropriate parent models from model hierarchy 1815 for each media type. Core generative AI models 1811 then generate content-specific child models and loadable genAI codec enhancers 1819 tailored to presentation's unique characteristics. Hardware acceleration subsystem 1830 facilitates rapid processing, with TPUs 1831 handling model inference, FPGAs 1835 performing 4D symmetry analysis, and ASICs 1839 accelerating specific compression algorithms for each media type.

User experience subsystem 1840 comes into play as user preference integration subsystem 1845 considers user's viewing history and device settings. It notes the user's preference for high-quality audio and adjusts compression priorities accordingly. Adaptive processing subsystem 1849 optimizes output for smartphone's specific display capabilities and current network conditions. Multi-modal processing subsystem 1860 ensures consistency across different media types. Multi-modal content creation subsystem 1865 maintains synchronization between video, audio, and captions. Information theory integration subsystem 1869 applies semantic compression to preserve essential information while reducing data size.

Content delivery subsystem 1850 then prepares optimized content for streaming. Streaming efficiency subsystem 1855 packages compressed content with necessary codec enhancers, transmitting them as a unified stream. As a result, user receives high-quality, bandwidth-efficient stream tailored to their preferences and device capabilities. Video maintains clarity in important scenes, audio narration remains crisp, images are clear, and text captions are legible and well-synchronized. All this is achieved with significantly reduced data usage compared to traditional compression methods. Throughout presentation, suite 1800 continues to adapt in real-time. If network conditions change or user switches to a different device, system quickly adjusts its compression and delivery strategies to maintain optimal viewing experience.

This use case demonstrates how cross-media genAI codec enhancement suite 1800 can provide an efficient, adaptive, and high-quality media experience across diverse content types and viewing conditions.

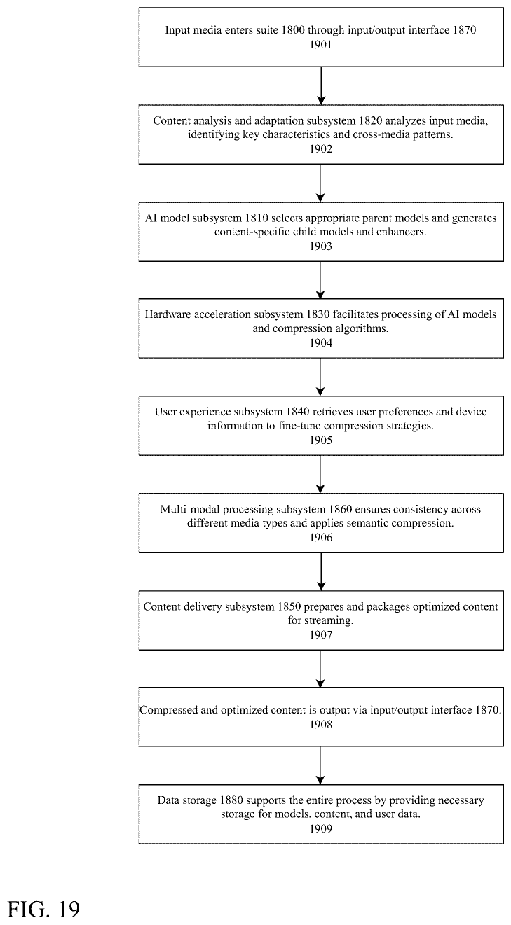

FIG. 19 is a method diagram illustrating the use of cross-media genAI codec enhancement suite 1800. The cross-media genAI codec enhancement suite 1800 processes input media through its input/output interface 1870 1901. The content analysis and adaptation subsystem 1820 then analyzes the media, identifying key characteristics and cross-media patterns to determine optimal compression strategies 1902. Based on this analysis, the AI model subsystem 1810 selects appropriate parent models from its hierarchy and generates content-specific child models and enhancers, adapting pre-trained models to the unique features of the input media 1903. To ensure efficient processing, the hardware acceleration subsystem 1830 utilizes specialized components like TPUs, FPGAs, and ASICs to facilitate rapid inference and complex mathematical operations 1904. The user experience subsystem 1840 considers individual preferences and device capabilities, fine-tuning compression strategies to prioritize quality for content elements most important to the user 1905. Consistency across different media types is maintained by the multi-modal processing subsystem 1860, which also applies semantic compression techniques to preserve essential information while reducing data size 1906. The content delivery subsystem 1850 then prepares and packages the optimized content for streaming, combining compressed content with necessary codec enhancers 1907. Finally, the compressed and optimized content is output through the input/output interface 1870, ready for efficient transmission 1908. Throughout this process, the data storage 1880 provides crucial support by storing and managing models, content, and user data 1910.

The cross-media genAI codec enhancement suite 1800 integrates with other systems to optimize overall compression efficiency. It enhances the intelligent adaptive compression system 200 by incorporating semantic compression techniques and Bayesian network modeling. System 1800 works closely with the streaming platform integration system 400, providing advanced compression strategies that can be seamlessly integrated into existing streaming infrastructures. It supports the adaptive 3D video processing system 600 by applying information theory concepts to 3D content compression. The system also interacts with the device-specific adaptive content optimizer 800, using its hardware optimization subsystem 1650 to tailor processing for different device capabilities. System 1800 complements the multi-dimensional mathematical compression framework 1600 by providing additional information theory-based optimization techniques. It also enhances the cross-media GenAI codec enhancement suite 1800 by offering advanced compression techniques that can be applied across various media types. The continuous learning AI analysis engine 2000 utilizes insights from system 1800 to refine compression strategies over time.

### Continuous Learning AI Analysis Engine Architecture

Continuous learning AI analysis engine is a sophisticated system designed to constantly refine and improve content processing, compression, and delivery strategies based on ongoing analysis of new content, user interactions, and feedback. This engine integrates seamlessly with existing content-adaptive encoding processes and AI-driven optimizations, enhancing overall system performance over time.

At the core of continuous learning AI analysis engine is a set of neural network models initially trained on diverse datasets of media content. These models employ architectures such as convolutional neural networks for spatial analysis, recurrent neural networks for temporal patterns, and transformer models for long-range dependencies. Models are structured to recognize and prioritize essential elements in various content types, including video frames, audio sequences, and text.

Continuous learning AI analysis engine implements an online learning approach, allowing models to update in real-time as new data becomes available. This is achieved through techniques such as stochastic gradient descent with mini-batch updates, enabling incremental learning without requiring full retraining of models. To manage computational resources efficiently, engine employs a selective update mechanism, prioritizing updates for model components that show significant drift from current data distributions.

Federated learning techniques are incorporated to leverage user feedback and usage patterns while maintaining privacy. Local model updates are computed on user devices, with only aggregated updates transmitted to central servers. This approach allows engine to benefit from diverse user experiences without compromising individual user data.

To handle concept drift and evolving content trends, continuous learning AI analysis engine incorporates adaptive learning rate algorithms (for example, AdaGrad and/or Adam). These algorithms automatically adjust learning rates for different model parameters based on observed gradients, ensuring stable and efficient learning even as data distributions change over time.

Continuous learning AI analysis engine integrates with specialized hardware components to facilitate real-time learning and inference. Tensor Processing Units (TPUs) are utilized for rapid model updates and inference, while Field-Programmable Gate Arrays (FPGAs) are programmed to perform specific, computationally intensive tasks such as feature extraction or data preprocessing. Application-Specific Integrated Circuits (ASICs) are designed to accelerate recurring patterns in model architecture, further enhancing processing speed. These examples illustrate potential hardware configurations that could optimize performance in processing complex video data and enhance the overall compression process. However, it is important to note that the system is not limited to or dependent on these specific hardware components. The invention is designed to be flexible and can adapt to a wide range of hardware environments, from general-purpose processors to various types of specialized computing units, based on availability and specific deployment requirements.

A crucial component of continuous learning AI analysis engine is anomaly detection subsystem, which identifies significant deviations in content characteristics or user behavior. This subsystem employs statistical methods and unsupervised learning techniques to flag unusual patterns, triggering more focused analysis and potential model adjustments.

To manage evolving user preferences, continuous learning AI analysis engine implements a multi-armed bandit approach for exploration-exploitation trade-off. This allows the system to continuously test slight variations in processing and compression strategies, optimizing for user satisfaction while also exploring potential improvements. Model versioning and rollback mechanisms are implemented to ensure system stability. Each model update is versioned, with performance metrics tracked over time. If a model update leads to degraded performance, the system can automatically roll back to a previous, stable version while analyzing causes of degradation.

Continuous learning AI analysis engine extends model hierarchy approach by implementing a dynamic hierarchy. Parent models, representing broad content categories, are periodically updated based on aggregated insights from more specific child models. This allows system to capture and propagate general improvements across content types while maintaining specialization for specific content.

For emerging devices with integrated AI chips, continuous learning AI analysis engine provides a lightweight client-side learning subsystem. This subsystem performs initial processing and compression optimizations on device, adapting to individual usage patterns and device-specific constraints. Periodic synchronization with central models ensures consistency while allowing for personalized optimizations.

In context of streaming services, continuous learning AI analysis engine implements a feedback loop that analyzes viewing patterns, engagement metrics, and explicit user feedback across large user base. This aggregated data informs both global model updates and personalization strategies for individual users or user segments.

To enhance user experience, continuous learning AI analysis engine incorporates reinforcement learning techniques. Actions such as adjusting compression parameters or content delivery strategies are treated as actions in a reinforcement learning framework, with user engagement and quality of experience serving as reward signals. This allows continuous learning AI analysis engine to learn optimal strategies for maximizing user satisfaction over time.

Continuous learning AI analysis engine also includes a content trend analysis subsystem that identifies emerging patterns in content consumption and creation. This subsystem employs time series analysis and trend forecasting techniques to anticipate future content characteristics, allowing continuous learning AI analysis engine to proactively adapt compression and delivery strategies.

Through continuous refinement and adaptation, this AI analysis engine enables increasingly efficient and personalized content processing, compression, and delivery. It adapts to new content types, evolving user preferences, and technological advancements, ensuring optimal performance and user satisfaction in dynamic media consumption landscape.

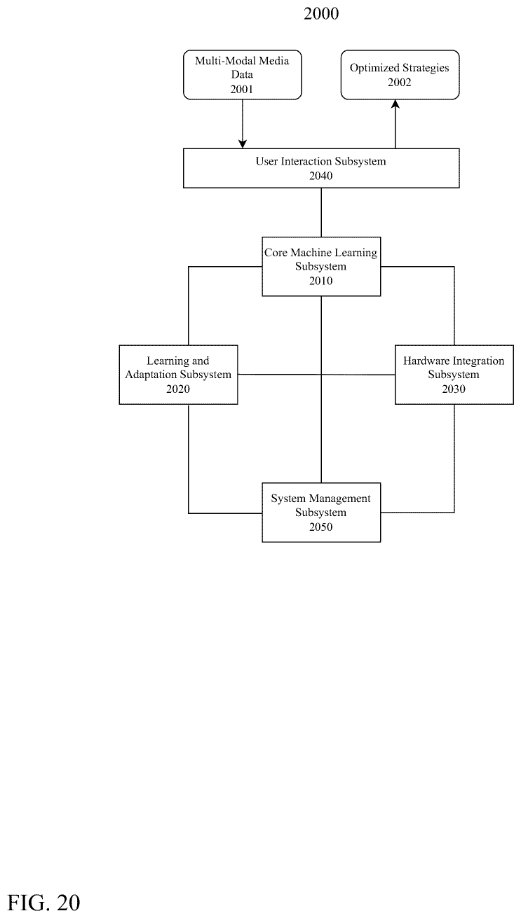

FIG. 20 is a block diagram illustrating exemplary architecture of continuous learning AI analysis engine 2000. Continuous learning AI analysis engine 2000 comprises several interconnected subsystems that work together to process, analyze, and optimize content delivery. At the core of engine 2000 is core machine learning subsystem 2010, which includes neural network models 2011, online learning subsystem 2012, and federated learning subsystem 2013. Neural network models 2011 consist of various architectures such as convolutional neural networks, recurrent neural networks, and transformer models, each specialized for different aspects of content analysis.

Neural network models 2011 are initially trained on diverse datasets of media content, including video frames, audio sequences, and text. Convolutional neural networks are trained on image and video data to recognize spatial patterns and features. Recurrent neural networks are trained on sequential data such as audio and time-series information to capture temporal dependencies. Transformer models are trained on large-scale text and multimodal datasets to understand long-range dependencies and context in various content types. Training data for these models includes professionally produced content, user-generated content, and metadata associated with media items. Online learning subsystem 2012 enables real-time model updates as new data becomes available. It uses techniques like stochastic gradient descent with mini-batch updates to incrementally refine models based on incoming content and user interaction data. This subsystem allows models to adapt to changing content trends and user preferences without requiring full retraining. Federated learning subsystem 2013 facilitates privacy-preserving learning from user interactions. It trains models on user devices using local data, then aggregates model updates across multiple users without sharing raw data. This approach allows engine 2000 to learn from diverse user experiences while maintaining data privacy.

Connected to core machine learning subsystem 2010 is learning and adaptation subsystem 2020. This subsystem includes adaptive learning rate subsystem 2021, which implements algorithms such as, for example, AdaGrad or Adam to handle concept drift. These algorithms are trained on historical model performance data to automatically adjust learning rates for different model parameters. Anomaly detection subsystem 2022 identifies significant deviations in content characteristics or user behavior. It is trained on historical data of normal content patterns and user interactions, learning to recognize unusual or outlier events. Multi-armed bandit subsystem 2023 manages the exploration-exploitation trade-off for optimization strategies. It is trained through ongoing interactions with users, learning optimal strategies for content delivery and compression over time. Reinforcement learning subsystem 2024 treats content delivery actions as part of a learning framework to maximize user satisfaction. It is trained using reward signals derived from user engagement metrics, quality of experience indicators, and explicit feedback. Content trend analysis subsystem 2025 identifies emerging patterns in content consumption and creation. It is trained on historical content popularity data, user engagement statistics, and content metadata to predict future trends.

Hardware integration subsystem 2030 interfaces with specialized hardware components to enhance processing capabilities. In an embodiment, it includes TPU integration subsystem 2031 for rapid model updates and inference, FPGA integration subsystem 2032 for specific computational tasks, and ASIC integration subsystem 2033 for accelerating recurring patterns in model architecture.

User interaction subsystem 2040 manages the interface between engine 2000 and end-users. It comprises client-side learning subsystem 2041, which performs on-device processing and optimization, and user feedback processing subsystem 2042, which collects and integrates user input for system improvement. Client-side learning subsystem 2041 is trained on device-specific usage patterns and constraints to provide personalized optimizations.

System management subsystem 2050 oversees the overall operation and stability of engine 2000. It includes model versioning subsystem 2051, rollback mechanism subsystem 2052, and dynamic model hierarchy subsystem 2053. These components work together to maintain system integrity, manage model versions, and organize the hierarchical structure of content processing models.

The continuous learning AI analysis engine 2000 receives multi-modal media data 2001 as input from other systems, such as the intelligent adaptive compression system 200, streaming platform integration system 400, and device-specific adaptive content optimizer 800. This data 2001 includes various types of media content (e.g., video, audio, text), compression parameters, streaming metrics, and device-specific information. Engine 2000 processes this data through its various subsystems, continuously learning and adapting its models. The output of this process is optimized content processing, compression, and delivery strategies 2002, which are then implemented through the user interaction subsystem 2040. These optimized strategies 2002 are fed back into the other systems of the patent, creating a feedback loop that constantly improves the overall performance of the adaptive intelligent multi-modal media processing and delivery system.

Data flows through engine 2000 as follows: incoming content and user interaction data enter through user interaction subsystem 2040. This data is then processed by core machine learning subsystem 2010, which applies appropriate neural network models for initial analysis. Learning and adaptation subsystem 2020 continuously refines these models based on observed patterns and anomalies. Hardware integration subsystem 2030 accelerates these processes as needed. System management subsystem 2050 monitors the entire process, managing model versions and maintaining system stability. The output of this process is optimized content processing, compression, and delivery strategies, which are then implemented through user interaction subsystem 2040.

Throughout this process, continuous learning AI analysis engine 2000 adapts to new content types, evolving user preferences, and technological advancements, ensuring optimal performance in dynamic media consumption landscapes.

In a use case example of an embodiment of continuous learning AI analysis engine 2000, a global streaming platform implements the system to optimize its content delivery and user experience across millions of users. As new content is added to the platform and users interact with it, engine 2000 continuously analyzes and adapts its strategies. When a new TV series is released on the platform, multi-modal media data 2001 related to this content enters the system through user interaction subsystem 2040. This data includes video and audio characteristics of the series, initial compression parameters, and early user engagement metrics.

Core machine learning subsystem 2010 begins processing this data. Neural network models 2011 analyze the visual and auditory features of the series, identifying unique characteristics such as fast-paced action scenes or dialogue-heavy episodes. Online learning subsystem 2012 starts updating the models in real-time as users begin watching the series, adjusting predictions about popular episodes or scenes that require higher quality streaming.

As millions of users interact with the new series, federated learning subsystem 2013 collects anonymized data about viewing patterns and quality preferences directly from user devices. This data is aggregated to improve the overall model without compromising individual user privacy. Learning and adaptation subsystem 2020 then comes into play. Adaptive learning rate subsystem 2021 adjusts the learning rates for different aspects of the model, focusing more on learning about the new series' unique features. Anomaly detection subsystem 2022 identifies unusual viewing patterns, such as a sudden spike in viewership for a particular episode, triggering more focused analysis.

Multi-armed bandit subsystem 2023 experiments with slightly different compression strategies for the series across different user segments, aiming to optimize the balance between video quality and bandwidth usage. Reinforcement learning subsystem 2024 treats these compression choices as actions, using metrics like user engagement time and reduction in buffering events as reward signals to learn the most effective strategies. Throughout this process, hardware integration subsystem 2030 leverages specialized components to handle the computational load. TPU integration subsystem 2031 performs rapid updates to the neural network models, while FPGA integration subsystem 2032 handles complex feature extraction from the video content.

As users continue to watch the series, client-side learning subsystem 2041 performs on-device optimizations, adjusting playback parameters based on individual device capabilities and network conditions. User feedback processing subsystem 2042 collects and integrates explicit feedback, such as quality ratings or problem reports, to further refine the models. System management subsystem 2050 ensures stability throughout this learning process. Model versioning subsystem 2051 keeps track of changes, while rollback mechanism subsystem 2052 stands ready to revert to a previous model version if performance degrades unexpectedly. Content trend analysis subsystem 2025 identifies emerging patterns in how users are consuming the new series, such as binge-watching behavior or preference for mobile viewing, allowing the system to proactively adapt its delivery strategies.

As a result of this continuous learning and adaptation, engine 2000 outputs optimized content processing, compression, and delivery strategies 2002. These strategies might include tailored bitrate ladders for different episodes based on their visual complexity, personalized content encoding settings for various device types, and optimized content caching strategies for different regions based on predicted demand. This use case demonstrates how continuous learning AI analysis engine 2000 can adapt in real-time to new content, evolving user preferences, and varying device and network conditions, ultimately enhancing the user experience while optimizing resource usage for the streaming platform.

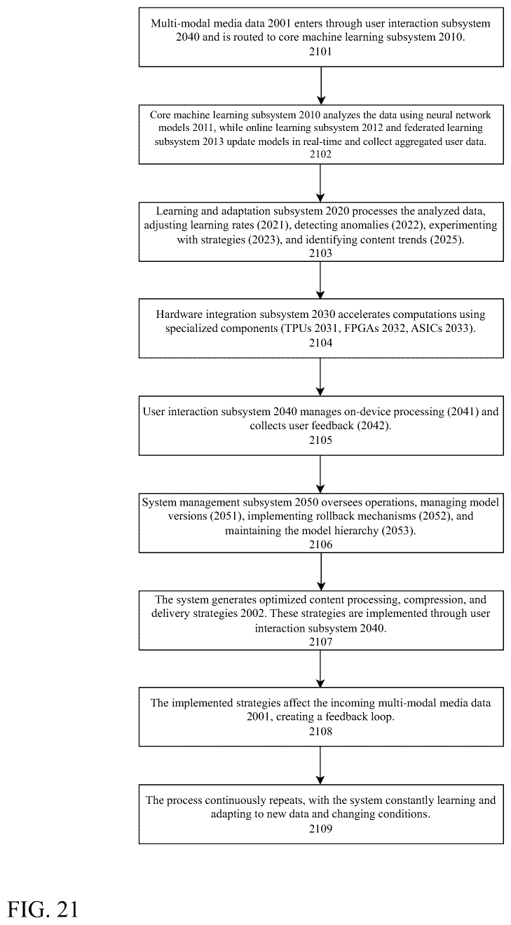

FIG. 21 is a method diagram illustrating the use of continuous learning AI analysis engine 2000. The process begins as multi-modal media data 2001 enters through user interaction subsystem 2040 and is routed to core machine learning subsystem 2010 2101. Core machine learning subsystem 2010 then analyzes the data using neural network models 2011, while simultaneously, online learning subsystem 2012 updates models in real-time and federated learning subsystem 2013 collects and aggregates anonymized user data to improve overall models without compromising individual privacy 2102. Next, learning and adaptation subsystem 2020 processes the analyzed data, employing various techniques such as adjusting learning rates with subsystem 2021, detecting anomalies with subsystem 2022, experimenting with different optimization strategies using multi-armed bandit subsystem 2023, and identifying emerging content trends with subsystem 2025 2103. To handle computationally intensive tasks, hardware integration subsystem 2030 utilizes specialized components including TPUs 2031 for rapid model updates, FPGAs 2032 for specific computational tasks, and ASICs 2033 for accelerating recurring patterns in model architecture 2104. User interaction subsystem 2040 then manages on-device processing and optimization through client-side learning subsystem 2041 and collects explicit user feedback via subsystem 2042 for further system improvement 2105. Throughout this process, system management subsystem 2050 oversees operations, managing model versions with subsystem 2051, implementing rollback mechanisms with subsystem 2052 if needed, and maintaining the dynamic model hierarchy with subsystem 2053 2106. Based on all the analyzed and learned data, the system generates optimized content processing, compression, and delivery strategies 2002, which are then implemented through user interaction subsystem 2040 2107. These implemented strategies influence the incoming multi-modal media data 2001, creating a feedback loop 2109. The entire process continuously repeats, allowing the system to constantly learn and adapt to new data and changing conditions in the dynamic media consumption landscape 2110.

### Adaptive Content Monetization System

Adaptive content monetization system is an AI-driven framework designed to create dynamic, granular subscription models based on content quality, user preferences, and viewing habits. This system integrates with existing content delivery infrastructures to provide flexible, personalized monetization strategies for digital media content.

At core of adaptive content monetization system is a machine learning model trained on vast datasets of user behavior, content consumption patterns, and historical pricing data. This model employs a combination of supervised learning for predicting user preferences and reinforcement learning for optimizing pricing strategies. Neural network architecture includes deep layers for feature extraction from user data and content metadata, as well as recurrent layers to capture temporal patterns in viewing habits.

Dynamic pricing subsystem within adaptive content monetization system utilizes real-time data processing to adjust prices for different quality levels of content (e.g., SD, HD, UHD). This subsystem implements a multi-armed bandit algorithm to continuously explore and exploit optimal pricing strategies. Each quality level and content type are treated as an arm in bandit problem, with revenue and user satisfaction metrics serving as reward signals. Exploration-exploitation trade-off is managed through techniques such as Thompson sampling or upper confidence bound algorithms.

AI-optimized pricing strategy component employs a combination of predictive analytics and optimization algorithms. Predictive models, based on gradient boosting machines or neural networks, forecast user demand and willingness to pay for specific content types and quality levels. These predictions feed into an optimization algorithm, such as linear programming or genetic algorithms, to determine pricing that maximizes both revenue and user satisfaction.

Personalization engine within adaptive content monetization system creates tailored content packages based on individual user behavior and preferences. This engine utilizes collaborative filtering techniques, such as matrix factorization or deep learning-based recommendation systems, to identify content likely to appeal to each user. Clustering algorithms are applied to group users with similar preferences, allowing for efficient creation of targeted content bundles.

Integration with compression and delivery systems is achieved through an API layer that allows real-time communication between adaptive content monetization system and underlying content infrastructure. This integration enables quality-based pricing by dynamically adjusting compression levels and delivery bitrates based on user subscription tier and network conditions. Adaptive content monetization system employs adaptive bitrate streaming techniques, with pricing tiers mapped to specific quality thresholds.

Predictive models for content value and user willingness to pay are implemented using ensemble methods combining multiple machine learning algorithms. These models incorporate features such as content genre, release date, critical reception, and historical viewing patterns. Time series analysis techniques, including ARIMA or Prophet models, are used to forecast trends in content value over time.

Real-time adjustment of offerings based on network conditions and device capabilities is managed by a decision engine that processes data from content delivery network (CDN) and user devices. This engine employs rule-based systems for rapid decision-making, with rules dynamically updated by machine learning models that identify optimal strategies for different network and device scenarios.

Content modification subsystem within adaptive content monetization system handles age-appropriate filtering and content customization. This subsystem utilizes computer vision and natural language processing techniques to identify and modify potentially inappropriate content in real-time. For video content, object detection and scene classification algorithms identify sensitive visual elements, while speech recognition and text analysis algorithms process audio for inappropriate language. Content is then modified through techniques such as visual blurring, audio bleeping, or intelligent dubbing.

Age detection component employs computer vision algorithms, possibly running on smart TV hardware, to estimate ages of viewers in room. This information is used to automatically adjust content filtering settings and pricing tiers. Privacy concerns are addressed by processing age detection locally on device, with only aggregated, anonymized data sent to central systems. Flexible subscription management system allows for creation of highly granular subscription tiers. This system employs a graph database to model complex relationships between content types, quality levels, and user preferences. Dynamic package creation algorithm traverses this graph to generate personalized subscription options for each user.

Analytics dashboard provides content providers with real-time insights into monetization performance. This dashboard utilizes interactive data visualization techniques and incorporates predictive analytics to forecast future trends and suggest optimization strategies. A/B testing framework is integrated into adaptive content monetization system to continuously evaluate and refine monetization strategies. This framework automates the process of designing, deploying, and analyzing experiments on subsets of user base to identify most effective pricing and packaging approaches.

By leveraging advanced AI and analytics capabilities, adaptive content monetization system creates a flexible and personalized approach to content monetization. It moves beyond traditional tiered pricing models to offer a dynamic, user-centric system that optimizes both revenue generation and user satisfaction in the digital content marketplace.

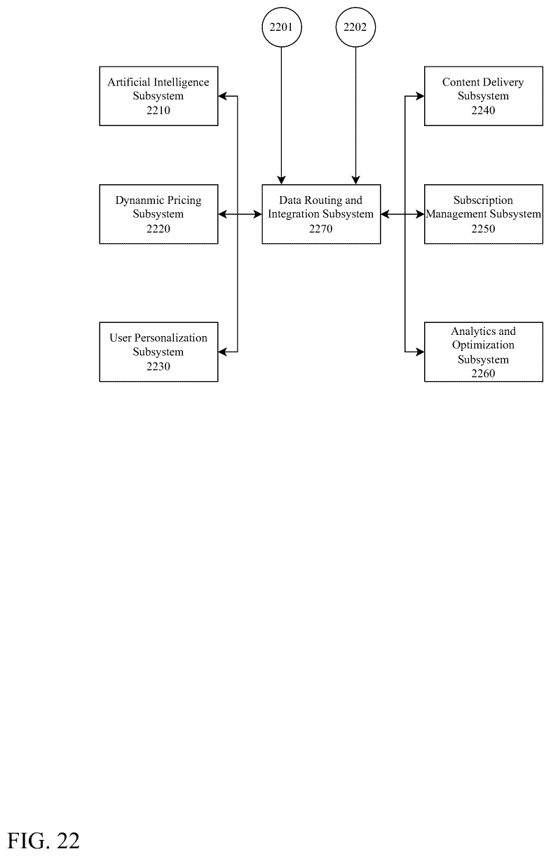

FIG. 22 is a block diagram illustrating exemplary architecture of adaptive content monetization system 2200. System 2200 comprises several interconnected subsystems that work together to provide dynamic, personalized content monetization.

At the core of system 2200 is artificial intelligence subsystem 2210, which includes machine learning model 2211 and predictive analytics engine 2212. Machine learning model 2211 is a hybrid architecture that combines multiple AI techniques to process and learn from diverse data types. Model 2211 incorporates convolutional neural networks (CNN) for processing visual content features, recurrent neural networks (RNN) such as LSTM and/or GRU for analyzing temporal patterns in user behavior, and transformer-based models for processing textual content descriptions and user feedback. These components are integrated through an ensemble method, for example stacking and/or boosting, to produce a unified output. Model 2211 is trained on historical user behavior data, content consumption patterns, and pricing information using a combination of supervised learning for predicting user preferences and reinforcement learning for optimizing pricing strategies. Predictive analytics engine 2212 uses this model to forecast user preferences and content value. For example, predictive analytics engine 2212 may employ algorithms such as gradient boosting or long short-term memory (LSTM) networks to generate these forecasts.

Dynamic pricing subsystem 2220 interfaces directly with artificial intelligence subsystem 2210. Subsystem 2220 includes pricing optimization algorithm 2221 and real-time price adjustment mechanism 2222. Pricing optimization algorithm 2221 utilizes multi-armed bandit techniques to explore and exploit optimal pricing strategies. For instance, algorithm 2221 implements, for example, Thompson sampling and/or upper confidence bound (UCB) algorithms to balance exploration and exploitation. Real-time price adjustment mechanism 2222 implements these strategies based on current market conditions and user behavior.

User personalization subsystem 2230 works in tandem with artificial intelligence subsystem 2210 and dynamic pricing subsystem 2220. Subsystem 2230 comprises recommendation engine 2231 and user profiling component 2232. Recommendation engine 2231 employs a collaborative filtering neural network trained on user-content interaction data to suggest content. This engine may, for example, use matrix factorization techniques or deep learning approaches such as neural collaborative filtering. User profiling component 2232 maintains detailed user preference data.

Content delivery subsystem 2240 manages integration with existing content infrastructure. Subsystem 2240 includes adaptive bitrate streaming component 2241 and content modification engine 2242. Adaptive bitrate streaming component 2241 adjusts content quality based on network conditions and subscription tier, potentially using algorithms such as, for example, DASH (Dynamic Adaptive Streaming over HTTP) or HLS (HTTP Live Streaming).

Content modification engine 2242 handles age-appropriate filtering and customization, possibly employing computer vision algorithms such as, for example, YOLO (You Only Look Once) for object detection in video content.

Subscription management subsystem 2250 oversees the creation and maintenance of user subscriptions. Subsystem 2250 includes package creation algorithm 2251 and subscription database 2252. Package creation algorithm 2251 generates personalized subscription options, which are stored and managed in subscription database 2252. Algorithm 2251 utilizes decision tree models and/or association rule learning techniques, for example the Apriori algorithm, to identify optimal subscription packages.

Analytics and optimization subsystem 2260 provides tools for monitoring and improving system performance. Subsystem 2260 comprises performance dashboard 2261 and A/B testing framework 2262. Performance dashboard 2261 offers real-time insights into monetization metrics, while A/B testing framework 2262 facilitates ongoing optimization experiments. Framework 2262 may employ Bayesian optimization techniques, such as Gaussian process regression, to efficiently design and evaluate experiments.

Data routing and integration subsystem 2270 serves as the central nervous system of the adaptive content monetization system, orchestrating data flow between all other subsystems and managing external interfaces. This subsystem employs a high-performance message broker architecture to efficiently route data streams, ensuring real-time communication between components while maintaining data consistency and system responsiveness. It implements advanced caching mechanisms and load balancing techniques to optimize performance under varying workloads. The subsystem handles input 2201/output 2202 operations with external systems, facilitating seamless integration with the broader adaptive intelligent multi-modal media processing and delivery framework. It utilizes a publish-subscribe model for asynchronous operations, allowing subsystems to receive only the data relevant to their functions. Additionally, it provides a centralized logging and monitoring interface, enabling comprehensive system-wide data flow management and performance analysis. By serving as a unified data hub, data routing and integration subsystem 2270 enhances the scalability, reliability, and interoperability of the entire adaptive content monetization system.

Data flows through system 2200 as follows: User interaction data is collected and routed 2201 by data routing and integration subsystem 2270 to artificial intelligence subsystem 2210 for processing. Subsystem 2270 then directs the processed information to dynamic pricing subsystem 2220 and user personalization subsystem 2230. These subsystems' outputs are routed through subsystem 2270 to subscription management subsystem 2250 and content delivery subsystem 2240, which directly interact with users. Analytics and optimization subsystem 2260 receives system-wide performance data via subsystem 2270 and feeds insights back to artificial intelligence subsystem 2210 for continuous improvement. Throughout this process, data routing and integration subsystem 2270 ensures efficient, real-time data flow between all subsystems, manages external interfaces 2202, and maintains system-wide data consistency.

In operation, when a user interacts with system 2200, their behavior data is routed by data routing and integration subsystem 2270 to artificial intelligence subsystem 2210 for analysis. User personalization subsystem 2230 then generates tailored content recommendations, which are transmitted via subsystem 2270. Dynamic pricing subsystem 2220 determines optimal pricing for this content based on current market conditions and user willingness to pay, with data flows managed by subsystem 2270. Subscription management subsystem 2250 receives this information through subsystem 2270 and presents personalized subscription options to the user. Once a subscription is chosen, content delivery subsystem 2240 manages the delivery of content at appropriate quality levels, with delivery parameters routed through subsystem 2270. Throughout this process, analytics and optimization subsystem 2260 monitors performance data collected via subsystem 2270 and suggests improvements to enhance user satisfaction and revenue generation, with these insights distributed to relevant subsystems through data routing and integration subsystem 2270.

In a use case example of an embodiment of adaptive content monetization system 2200, a digital content provider implements the system to optimize its offerings and content delivery. A user accesses the platform on their mobile device. As they browse the content library, their interactions are collected and routed by data routing and integration subsystem 2270 to artificial intelligence subsystem 2210. Subsystem 2210 analyzes the user's content consumption history, noting their preferences for specific genres and topics. User personalization subsystem 2230 generates tailored content recommendations based on this analysis, highlighting new content that aligns with the user's interests. Dynamic pricing subsystem 2220 assesses current market conditions and the user's historical engagement, determining an optimal pricing strategy for a personalized content package. This information is routed through subsystem 2270 to subscription management subsystem 2250, which crafts a unique offer. The offer includes new content, a curated collection of relevant items, and early access to upcoming releases, all at a price point that aligns with the user's perceived value of the content.

When the user selects this tailored package, data routing and integration subsystem 2270 communicates their choice to content delivery subsystem 2240. As the user begins consuming the new content, adaptive bitrate streaming component 2241 adjusts the quality based on the device's capabilities and current network conditions. Content modification engine 2242 ensures that any sensitive content is appropriately filtered based on the user's preferences. Throughout the user's session, analytics and optimization subsystem 2260 monitors their engagement, collecting data on consumption patterns, duration, and interaction points. This data is continuously fed back through subsystem 2270 to artificial intelligence subsystem 2210, refining its understanding of the user's preferences.

On subsequent platform access, the system has already adjusted its recommendations and pricing strategies based on recent usage patterns. It offers the user a specialized rate on related content they're likely to enjoy, demonstrating the system's ability to continuously adapt and optimize the user experience while maximizing revenue opportunities. This use case showcases how adaptive content monetization system 2200 provides a highly personalized, dynamically priced content experience, continuously learning and adapting to user behavior to enhance both user satisfaction and service profitability.

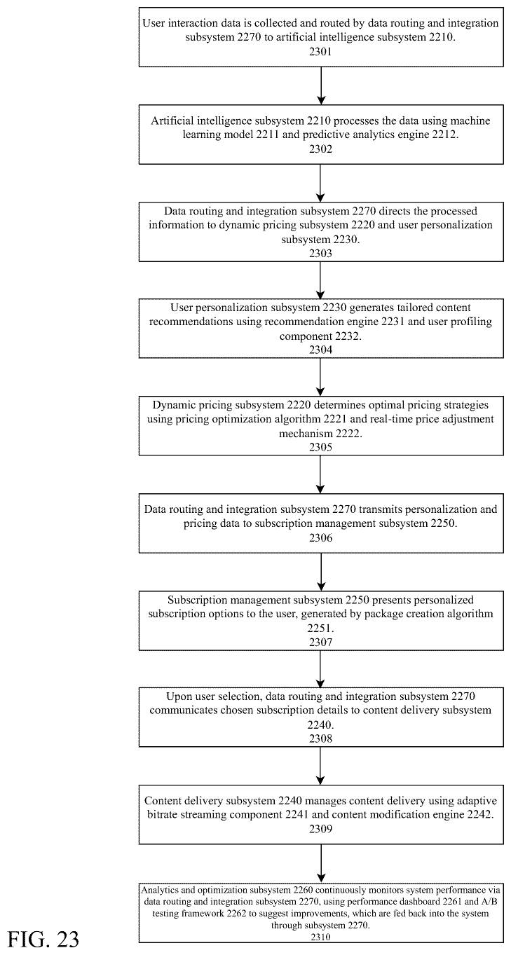

FIG. 23 is a method diagram illustrating the use of adaptive content monetization system 2200. The process begins as user interaction data is collected and routed by data routing and integration subsystem 2270 to artificial intelligence subsystem 2210 2301. Artificial intelligence subsystem 2210 then processes this data using machine learning model 2211 and predictive analytics engine 2212 to gain insights into user behavior and preferences 2302. The processed information is then directed by data routing and integration subsystem 2270 to dynamic pricing subsystem 2220 and user personalization subsystem 2230 2303. User personalization subsystem 2230 leverages this data to generate tailored content recommendations using recommendation engine 2231 and user profiling component 2232, ensuring a personalized experience for each user 2304. Simultaneously, dynamic pricing subsystem 2220 determines optimal pricing strategies using pricing optimization algorithm 2221 and real-time price adjustment mechanism 2222, balancing user value and revenue generation 2305. Data routing and integration subsystem 2270 then transmits the personalization and pricing data to subscription management subsystem 2250 2306. Based on this information, subscription management subsystem 2250 presents personalized subscription options to the user, generated by package creation algorithm 2251 2307. Once the user selects a subscription, data routing and integration subsystem 2270 communicates the chosen subscription details to content delivery subsystem 2240 2308. Content delivery subsystem 2240 then manages the delivery of content using adaptive bitrate streaming component 2241 and content modification engine 2242, ensuring optimal quality and appropriate content based on the user's subscription and device capabilities 2309. Throughout this entire process, analytics and optimization subsystem 2260 continuously monitors system performance via data routing and integration subsystem 2270, using performance dashboard 2261 and A/B testing framework 2262 to suggest improvements, which are fed back into the system through subsystem 2270, ensuring ongoing optimization of the monetization strategy 2310.

The adaptive content monetization system 2200 interacts with other components of adaptive intelligent multi-modal media processing and delivery system to provide personalized and optimized content monetization. It works closely with intelligent adaptive compression system 200 to apply pricing strategies based on the compression efficiency and quality levels achieved. System 2200 integrates with streaming platform integration system 400 to implement dynamic pricing and subscription models within existing streaming architectures. It leverages insights from device-specific adaptive content optimizer 800 to tailor pricing and content offerings based on device capabilities and network conditions. System 2200 also interacts with dynamic content encryption and filtering engine 1000 to enable content access control aligned with different subscription tiers. Additionally, system 2200 utilizes data from continuous learning AI analysis engine 2000 to refine its pricing strategies and content recommendations based on evolving user behaviors and content trends. Through these interactions, adaptive content monetization system 2200 enhances the overall system's ability to deliver personalized, efficiently priced content across diverse platforms and user scenarios.

### Exemplary Computing Environment

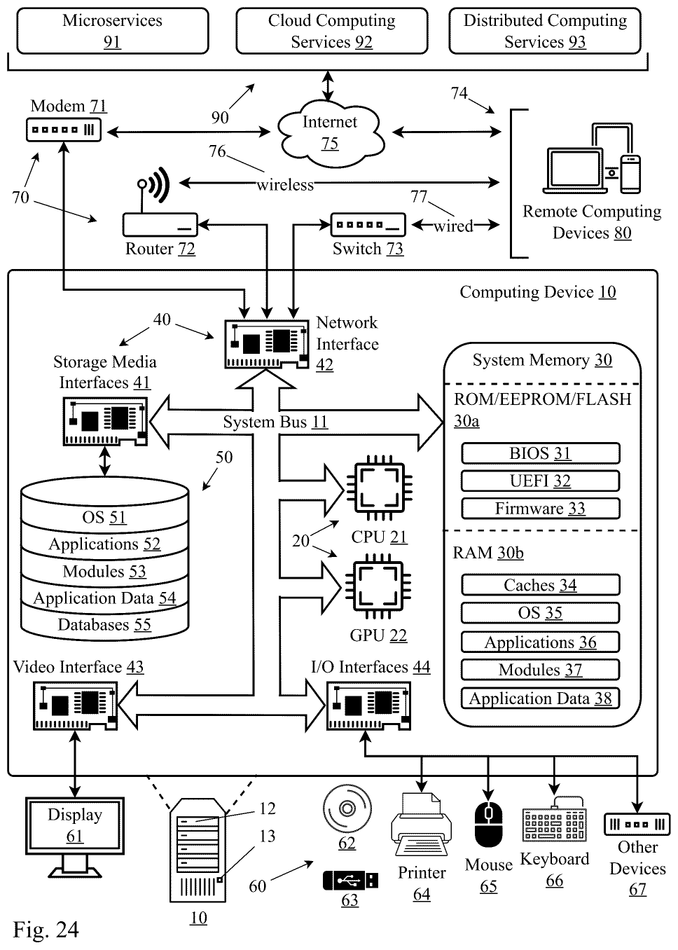

FIG. 24 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for adaptive multi-modal media processing and delivery, comprising:
a content analysis subsystem configured to analyze characteristics of input media content;
an adaptive processing subsystem configured to dynamically adjust processing parameters;
a hardware acceleration component;
a network interface; and
a processor configured to:
select encoding parameters based on content characteristics, user preferences, and network conditions;
apply adaptive processing techniques to the media content; and
output the compressed media content for delivery.

2. The system of claim 1, further comprising a model management subsystem configured to manage hierarchical models for content processing.

3. The system of claim 1, wherein the hardware acceleration component includes at least one specialized processing unit.

4. The system of claim 1, further comprising a multi-dimensional video processing subsystem.

5. The system of claim 1, further comprising a content security subsystem.

6. The system of claim 1, wherein the adaptive processing techniques include AI-driven compression.

7. The system of claim 1, further comprising a continuous learning subsystem configured to refine the adaptive processing techniques based on historical data and user feedback.

8. The system of claim 1, wherein the adaptive processing subsystem is configured to perform cross-media optimization across multiple content types.

9. A method for adaptive multi-modal media processing and delivery, comprising:
receiving media content and user preference data;
analyzing content characteristics of the media content;
determining processing conditions;
selecting processing parameters based on the analyzed characteristics, user preferences, processing conditions;
applying adaptive processing techniques to the media content using hardware acceleration;
dynamically adjusting the processing based on feedback; and
outputting the processed media content for delivery.

10. The method of claim 9, further comprising managing hierarchical models for content processing using a model management subsystem.

11. The method of claim 9, wherein the hardware acceleration component includes at least one specialized processing unit.

12. The method of claim 9, further comprising processing multi-dimensional video using a multi-dimensional video processing subsystem.

13. The method of claim 9, further comprising securing content using a content security subsystem.

14. The method of claim 9, wherein the adaptive processing techniques include AI-driven compression.

15. The method of claim 9, further comprising refining the adaptive processing techniques based on historical data and user feedback using a continuous learning subsystem.

16. The method of claim 9, wherein applying adaptive processing techniques includes performing cross-media optimization across multiple content types.
